(19) United States
(12) Patent Application Publication
(10) Pub. No.: US 2023/0199588 A1
(43) Pub. Date: Jun. 22, 2023

(54) METHOD AND APPARATUS FOR SERVING CELL CHANGE IN A WIRELESS COMMUNICATION SYSTEM

(71) Applicant: ASUSTek Computer Inc., Taipei City (TW)

(72) Inventors: Yi-Hsuan Kung, Taipei City (TW); Yu-Hsuan Guo, Taipei City (TW)

(21) Appl. No.: 18/075,474

(22) Filed: Dec. 6, 2022

Related U.S. Application Data
(60) Provisional application No. 63/288,258, filed on Dec. 10, 2021.
(60) Provisional application No. 63/294,468, filed on Dec. 29, 2021.
(60) Provisional application No. 63/297,351, filed on Jan. 7, 2022.

(51) Int. Cl. H04W 36/00; H04W 76/30

(52) U.S. Cl. CPC H04W 36/00835; H04W 36/0061; H04W 76/30

(57) ABSTRACT

A method and apparatus are disclosed. In an example from the perspective of a User Equipment (UE), the UE receives a first signaling configuring one or more sets of cells including a first set of cells. The first set of cells includes a first Special Cell (SpCell) and one or more Secondary Cells (SCells). The UE receives receiving a second signaling indicative of a change of Serving Cells of the UE to the first set of cells. In response to the second signaling, the UE adds and/or activates the first SpCell and the one or more SCells.

### CROSS-REFERENCE TO RELATED APPLICATIONS

The present Application claims the benefit of U.S. Provisional Pat. Application Serial No. 63/288,258 filed on Dec. 10, 2021, the entire disclosure of which is incorporated herein in its entirety by reference. The present Application also claims the benefit of U.S. Provisional Pat. Application Serial No. 63/294,468 filed on Dec. 29, 2021, the entire disclosure of which is incorporated herein in its entirety by reference. The present Application also claims the benefit of U.S. Provisional Pat. Application Serial No. 63/297,351 filed on Jan. 7, 2022, the entire disclosure of which is incorporated herein in its entirety by reference.

### FIELD

This disclosure generally relates to wireless communication networks, and more particularly, to a method and apparatus for Serving Cell change in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a User Equipment (UE), the UE receives a first signaling configuring one or more sets of cells comprising a first set of cells. The first set of cells comprises a first Special Cell (SpCell) and one or more Secondary Cells (SCells). The UE receives receiving a second signaling indicative of a change of Serving Cells of the UE to the first set of cells. In response to the second signaling, the UE adds and/or activates the first SpCell and the one or more SCells.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 is a diagram illustrating an exemplary scenario associated with a UE, a first cell, and a second cell according to one exemplary embodiment.

FIG. 6 is a diagram illustrating an exemplary scenario associated with a UE and a network according to one exemplary embodiment.

FIG. 7 is a diagram illustrating an exemplary scenario associated with a UE and a network according to one exemplary embodiment.

FIG. 8 is a diagram illustrating an exemplary scenario associated with a UE receiving a first information and/or a second information according to one exemplary embodiment.

FIG. 9 is a diagram illustrating an exemplary scenario associated with a UE receiving a first information and/or a second information according to one exemplary embodiment.

FIG. 10 is a diagram illustrating an exemplary scenario associated with a UE receiving a first information and/or a second information according to one exemplary embodiment.

FIG. 11 is a diagram illustrating an exemplary scenario associated with a UE receiving a first information and/or a second information according to one exemplary embodiment.

FIG. 12 is a diagram illustrating an exemplary scenario associated with a UE receiving a first information and/or a second information according to one exemplary embodiment.

FIG. 13 is a diagram illustrating an exemplary scenario associated with a UE receiving a first information and/or a second information according to one exemplary embodiment.

FIG. 14 is a diagram illustrating an exemplary scenario associated with a UE receiving a first information and/or a second information according to one exemplary embodiment.

FIG. 15 is a diagram illustrating an exemplary scenario associated with a UE receiving a first information and/or a second information according to one exemplary embodiment.

FIG. 16 is a diagram illustrating an exemplary scenario associated with a UE receiving a first information and/or a second information according to one exemplary embodiment.

FIG. 17 is a flow chart according to one exemplary embodiment.

FIG. 18 is a flow chart according to one exemplary embodiment.

FIG. 19 is a flow chart according to one exemplary embodiment.

FIG. 20 is a flow chart according to one exemplary embodiment.

FIG. 21 is a flow chart according to one exemplary embodiment.

FIG. 22 is a flow chart according to one exemplary embodiment.

FIG. 23 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3^{rd} Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems devices described below may be designed to support one or more standards such as the standard offered by a consortium named “3rd Generation Partnership Project” referred to herein as 3GPP, including: RP-212710 NR further mobility enhancements; 3GPP specification 38.331 v16.6.0; 3GPP specification 38.321 v16.6.0. The standards and documents listed above are hereby expressly incorporated by reference in their entirety.

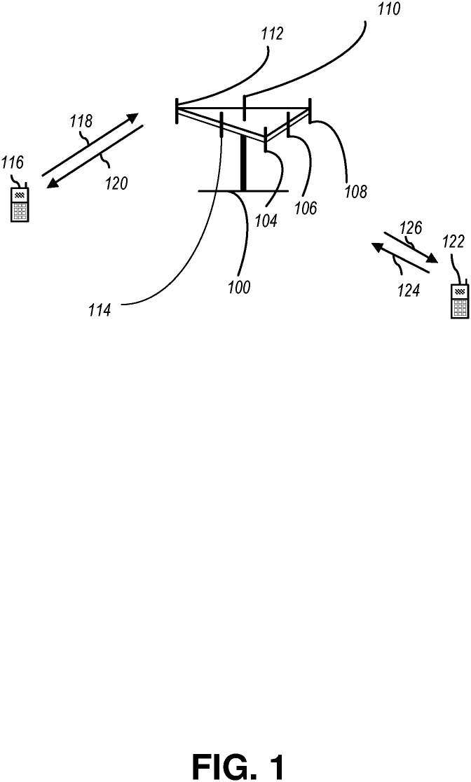

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

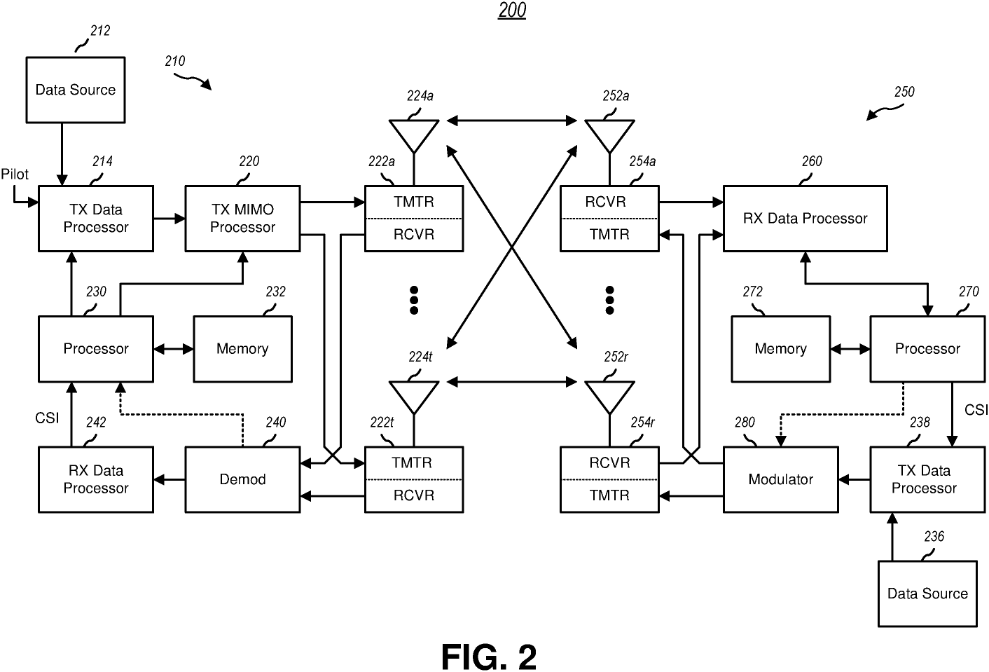

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based on a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by N_{R} antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the N_{R} received symbol streams from N_{R} receivers 254 based on a particular receiver processing technique to provide N_{T} “detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

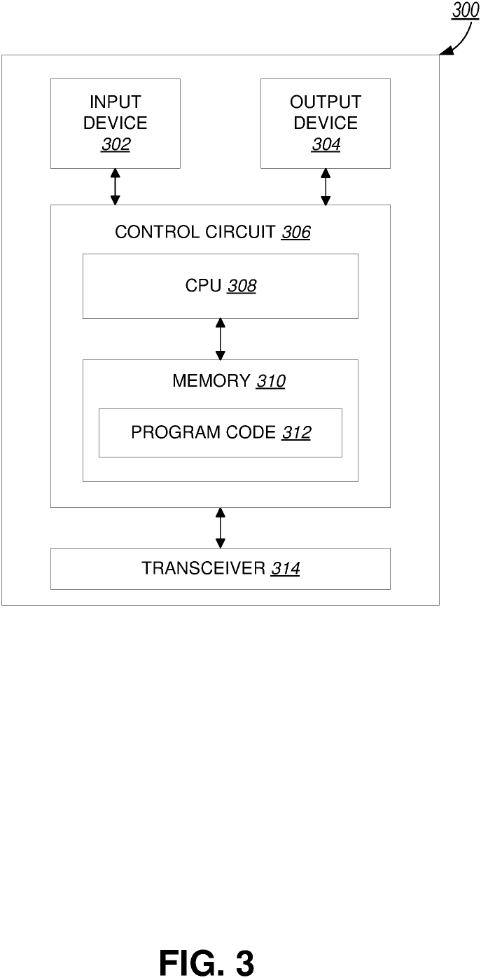

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

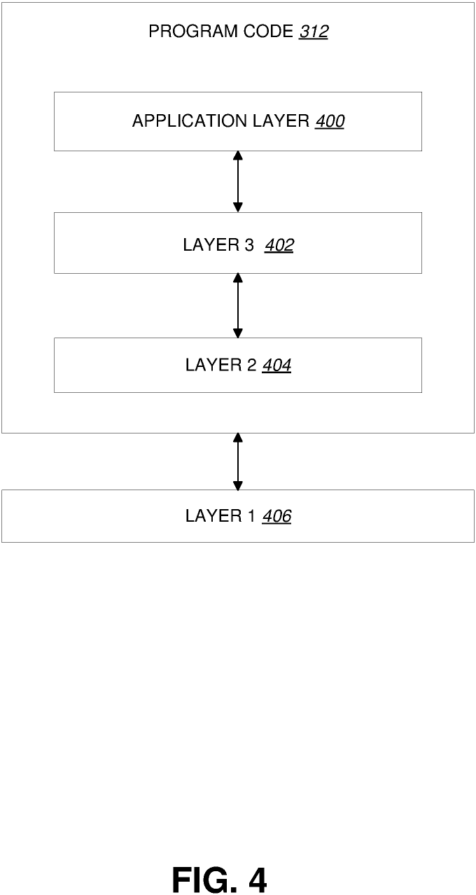

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1 portion 406. The Layer 3 portion 402 may perform radio resource control. The Layer 2 portion 404 may perform link control. The Layer 1 portion 406 may perform and/or implement physical connections.

In New Work Item Description (WID) on NR further mobility enhancements provided in RP-212710, one or more objectives for enhancement on mobility for NR are discussed. One or more parts of RP-212710 are quoted below:

### 3 Justification

When the UE passes from the coverage area of one cell to another cell, at some point a serving cell change need to be performed. Currently serving cell change is triggered by L3 measurements and is done by RRC signalling triggered Reconfiguration with Synch for change of PCell and PSCell, as well as release add for SCells when applicable, all cases with complete L2 (and L1) resets, and involving more latency, more overhead and more interruption time than beam switch mobility. The goal of L1/L2 mobility enhancements is to be able to do serving cell change via L1/L2 signalling with such low latency, low overhead and low interruption time.

### 4 Objective

### 4.1 Objective of Core Part WI

The detailed objective of this work item are:

1. To specify mechanism and procedures of L1/L2 based inter-cell mobility for mobility latency reduction:
Configuration and maintenance for multiple candidate cells to allow fast application of configurations for candidate cells [RAN2, RAN3]
Dynamic switch mechanism among candidate serving cells (including SpCell and SCell) for the potential applicable scenarios based on L1/L2 signalling [RAN2, RAN1]
L1 enhancements, including inter-cell beam management, L1 measurement and reporting, beam indication, and for non-synchronized scenario to handle TA management [RAN1, RAN2]
CU-DU interface signaling to support L1/L2 mobility, if needed [RAN3]

Note 1: FR2 specific enhancements are not precluded, if any.

Note 2: The procedure of L1/L2 based inter-cell mobility are applicable to the following scenarios:
Standalone, CA and NR-DC case with serving cell change within one CG
Intra-CU case and intra-CU inter-DU case (applicable for Standalone and CA)
Both intra-frequency and inter-frequency
Both FR1 and FR2

Reconfiguration with sync (e.g., handover) and Secondary Cell (SCell) addition is introduced in 3GPP specification 38.331 v16.6.0, one or more parts of which are quoted below:

### 3.1 Definitions

Primary Cell: The MCG cell, operating on the primary frequency, in which the UE either performs the initial connection establishment procedure or initiates the connection re-establishment procedure.

Primary SCG Cell: For dual connectivity operation, the SCG cell in which the UE performs random access when performing the Reconfiguration with Sync procedure.

Secondary Cell: For a UE configured with CA, a cell providing additional radio resources on top of Special Cell.

Secondary Cell Group: For a UE configured with dual connectivity, the subset of serving cells comprising of the PSCell and zero or more secondary cells.

Serving Cell: For a UE in RRC_CONNECTED not configured with CA/DC there is only one serving cell comprising of the primary cell. For a UE in RRC_CONNECTED configured with CA/DC the term ‘serving cells’ is used to denote the set of cells comprising of the Special Cell(s) and all secondary cells.

Special Cell: For Dual Connectivity operation the term Special Cell refers to the PCell of the MCG or the PSCell of the SCG, otherwise the term Special Cell refers to the PCell.

### 5.3.5.5 Cell Group Configuration

### 5.3.5.5.1 General

The network configures the UE with Master Cell Group (MCG), and zero or one Secondary Cell Group (SCG). In (NG)EN-DC, the MCG is configured as specified in TS 36.331 [10], and for NE-DC, the SCG is configured as specified in TS 36.331 [10]. The network provides the configuration parameters for a cell group in the CellGroupConfig IE.

The UE performs the following actions based on a received CellGroupConfig IE:
1> if the CellGroupConfig contains the spCellConfig with reconfigurationWithSync:
   2> perform Reconfiguration with sync according to 5.3.5.5.2;
   2> resume all suspended radio bearers except the SRBs for the source cell group, and resume SCG transmission for all radio bearers, and resume BH RLC channels and resume SCG transmission for BH RLC channels for IAB-MT, if suspended;
1> if the CellGroupConfig contains the rlc-BearerToReleaseList:
   2> perform RLC bearer release as specified in 5.3.5.5.3;
1> if the CellGroupConfig contains the rlc-BearerToAddModList:
   2> perform the RLC bearer addition/modification as specified in 5.3.5.5.4;
1> if the CellGroupConfig contains the mac-CellGroupConfig:
   2> configure the MAC entity of this cell group as specified in 5.3.5.5.5;
1> if the CellGroupConfig contains the sCellToReleaseList:
   2> perform SCell release as specified in 5.3.5.5.8;
1> if the CellGroupConfig contains the spCellConfig:
   2> configure the SpCell as specified in 5.3.5.5.7;
1> if the CellGroupConfig contains the sCellToAddModList:
   2> perform SCell addition/modification as specified in 5.3.5.5.9;

### 5.3.5.5.2 Reconfiguration With Sync

The UE shall perform the following actions to execute a reconfiguration with sync.
1> if the AS security is not activated, perform the actions upon going to RRC_IDLE as specified in 5.3.11 with the release cause ‘other’ upon which the procedure ends;
1> if no DAPS bearer is configured:
   2> stop timer T310 for the corresponding SpCell, if running;
1> if this procedure is executed for the MCG:
   2> if timer T316 is running;
      3> stop timer T316;
      3> clear the information included in VarRLF-Report, if any;
   2> resume MCG transmission, if suspended.
1> stop timer T312 for the corresponding SpCell, if running;
1> start timer T304 for the corresponding SpCell with the timer value set to t304, as included in the reconfigurationWithSync;
1> if the frequencylnfoDL is included:
   2> consider the target SpCell to be one on the SSB frequency indicated by the frequencylnfoDL with a physical cell identity indicated by the physCellId;
1> else:
   2> consider the target SpCell to be one on the SSB frequency of the source SpCell with a physical cell identity indicated by the physCellId;
1> start synchronising to the DL of the target SpCell;
1> apply the specified BCCH configuration defined in 9.1.1.1 for the target SpCell;
1> acquire the MIB of the target SpCell, which is scheduled as specified in TS 38.213 [13]; [...]
   2> reset the MAC entity of this cell group;
   2> consider the SCell(s) of this cell group, if configured, that are not included in the SCellToAddModList in the RRCReconfiguration message, to be in deactivated state;
   2> apply the value of the newUE-Identity as the C-RNTI for this cell group;
   2> configure lower layers in accordance with the received spCellConfigCommon;
   2> configure lower layers in accordance with any additional fields, not covered in the previous, if included in the received reconfigurationWithSync.

### 5.3.5.5.8 SCell Release

The UE shall:
1> if the release is triggered by reception of the sCellToReleaseList:
   2> for each sCellIndex value included in the sCellToReleaseList:
      3> if the current UE configuration includes an SCell with value sCellIndex:
         4> release the SCell.

### 5.3.5.5.9 SCell Addition/Modification

The UE shall:
1> for each sCellIndex value included in the sCellToAddModList that is not part of the current UE configuration (SCell addition):
   2> add the SCell, corresponding to the sCellIndex, in accordance with the sCellConfigCommon and sCellConfigDedicated;
   2> if the sCellState is included:
      3> configure lower layers to consider the SCell to be in activated state;
   2> else:
      3> configure lower layers to consider the SCell to be in deactivated state;
   2> for each measld included in the measIdList within VarMeasConfig:
      3> if SCells are not applicable for the associated measurement; and
      3> if the concerned SCell is included in cellsTriggeredList defined within the VarMeasReportList for this measId:
         4> remove the concerned SCell from cellsTriggeredList defined within the VarMeasReportList for this measld;
1> for each sCellIndex value included in the sCellToAddModList that is part of the current UE configuration (SCell modification):
   2> modify the SCell configuration in accordance with the sCellConfigDedicated;
   2> if the sCellToAddModList was received in an RRCReconfiguration message including reconfigurationWithSync, or received in an RRCResume message, or received in an RRCReconfiguration message including reconfigurationWithSync embedded in an RRCResume message or embedded in an RRCReconfiguration message or embedded in an E-UTRA RRCConnectionReconfiguration message or embedded in an E-UTRA RRCConnectionResume message:
      3> if the sCellState is included:
         4> configure lower layers to consider the SCell to be in activated state;
      3> else:
         4> configure lower layers to consider the SCell to be in deactivated state.

Cell group configuration is introduced in 3GPP specification 38.331 v16.6.0, one or more parts of which are quoted below:

### CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells).

### CellGroupConfig Information Element

-- Configuration of one Cell-Group:
CellGroupConfig ::= SEQUENCE {
cellGroupId CellGroupId,
rlc-BearerToAddModList SEQUENCE
(SIZE(1..maxLC-ID)) OF RLC-BearerConfig
OPTIONAL, -- Need N
rlc-BearerToReleaseList SEQUENCE
(SIZE(1..maxLC-ID)) OF LogicalChannelIdentity
OPTIONAL, -- Need N
mac-CellGroupConfig MAC-CellGroupConfig
OPTIONAL, -- Need M
physicalCellGroupConfig PhysicalCellGroupConfig
OPTIONAL, -- Need M
spCellConfig SpCellConfig
OPTIONAL, -- Need M
sCellToAddModList SEQUENCE (SIZE
(1..maxNrofSCells)) OF SCellConfig OPTIONAL,-
- Need N
sCellToReleaseList SEQUENCE (SIZE
(1..maxNrofSCells)) OF SCellIndex OPTIONAL,-
- Need N
...,
[ [
simultaneousTCI-UpdateList1-r16 SEQUENCE (SIZE
(1..maxNrofServingCellsTCI-r16)) OF ServCellIndex OPTIONAL, -
- Need R
simultaneousTCI-UpdateList2-r16 SEQUENCE (SIZE
(1..maxNrofServingCellsTCI-r16)) OF ServCellIndex OPTIONAL,-
- Need R
simultaneousSpatial-UpdatedList1-r16 SEQUENCE (SIZE
(1..maxNrofServingCellsTCI-r16)) OF ServCellIndex OPTIONAL,-
- Need R
simultaneousSpatial-UpdatedList2-r16 SEQUENCE (SIZE
(1..maxNrofServingCellsTCI-r16)) OF ServCellIndex OPTIONAL,-
- Need R
] ] ,
}
-- Serving cell specific MAC and PHY parameters for a SpCell:
SpCellConfig ::= SEQUENCE {
servCellIndex ServCellIndex
OPTIONAL, -- Cond SCG
reconfigurationWithSync ReconfigurationWithSync
OPTIONAL, -- Cond ReconfWithSync
rlf-TimersAndConstants SetupRelease { RLF-
TimersAndConstants } OPTIONAL, -- Need M
spCellConfigDedicated ServingCellConfig
OPTIONAL, -- Need M
...
}
ReconfigurationWithSync ::= SEQUENCE {
spCellConfigCommon ServingCellConfigCommon
OPTIONAL, -- Need M
newUE-Identity RNTI-Value,
t304 ENUMERATED {ms50, ms100, ms150, ms200, ms500, ms1000, ms2000, ms10000},
rach-ConfigDedicated CHOICE {
uplink RACH-ConfigDedicated,
supplementaryUplink RACH-ConfigDedicated
}
OPTIONAL, -- Need N
...,
[ [
smtc SSB-MTC
OPTIONAL -- Need S
] ] ,
}
SCellConfig ::= SEQUENCE {
sCellIndex SCellIndex,
sCellConfigCommon ServingCellConfigCommon
OPTIONAL, -- Cond SCellAdd
sCellConfigDedicated ServingCellConfig
OPTIONAL, -- Cond SCellAddMod
• • • ,
[ [
smtc SSB-MTC
OPTIONAL -- Need S
]],
[ [
sCellState-r16 ENUMERATED {activated}
OPTIONAL, -- Cond SCellAddSync
secondaryDRX-GroupConfig-r16 ENUMERATED {true}
OPTIONAL -- Cond DRX-Config2
]]}

CellGroupConfig field descriptions
mac-CellGroupConfig
MAC parameters applicable for the entire cell group.
rlc-BearerToAddModList
Configuration of the MAC Logical Channel, the corresponding RLC entities and association with radio bearers.
sCellState
Indicates whether the SCell shall be considered to be in activated state upon SCell configuration.
sCellToAddModList
List of secondary serving cells (SCells) to be added or modified.
sCellToReleaseList
List of secondary serving cells (SCells) to be released.
secondaryDRX-GroupConfig
The field is used to indicate whether the SCell belongs to the secondary DRX group. All serving cells in the secondary DRX group shall belong to one Frequency Range and all serving cells in the legacy DRX group shall belong to another Frequency Range.
simultaneousTCI-UpdateList1, simultaneousTCI-UpdateList2
List of serving cells which can be updated simultaneously for TCI relation with a MAC CE. The simultaneousTCI-UpdateList1 and simultaneousTCI-UpdateList2 shall not contain same serving cells. Network should not configure serving cells that are configured with a BWP with two different values for the coresetPoolIndex in these lists.
simultaneousSpatial-UpdatedList1, simultaneousSpatial-UpdatedList2
List of serving cells which can be updated simultaneously for spatial relation with a MAC CE. The simultaneousSpatial-UpdatedList1 and simultaneousSpatial-UpdatedList2 shall not contain same serving cells. Network should not configure serving cells that are configured with a BWP with two different values for the coresetPoolIndex in these lists.
spCellConfig
Parameters for the SpCell of this cell group (PCell of MCG or PSCell of SCG).

ReconfigurationWithSync field descriptions
rach-ConfigDedicated
Random access configuration to be used for the reconfiguration with sync (e.g. handover). The UE performs the RA according to these parameters in the firstActiveUplinkBWP (see UplinkConfig).

SpCellConfig field descriptions
reconfiguration WithSync
Parameters for the synchronous reconfiguration to the target SpCell.
rlf-TimersAndConstants
Timers and constants for detecting and triggering cell-level radio link failure. For the SCG, rlf-TimersAndConstants can only be set to setup and is always included at SCG addition.
servCellIndex
Serving cell ID of a PSCell. The PCell of the Master Cell Group uses ID = 0.

### CellGroupId

The IE CellGroupId is used to identify a cell group. Value 0 identifies the master cell group. Other values identify secondary cell groups. In this version of the specification only values 0 and 1 are supported.

### CellGroupId Information Element

CellGroupId ::= INTEGER (0..
maxSecondaryCellGroups)

### CellIdentity

The IE Cellldentity is used to unambiguously identify a cell within a PLMN/SNPN.

### CellIdentity Information Element

Cellldentity ::= BIT STRING (SIZE (36))

### ServCellIndex

The IE ServCelllndex concerns a short identity, used to uniquely identify a serving cell (i.e. the PCell, the PSCell or an SCell) across the cell groups. Value 0 applies for the PCell, while the SCellIndex that has previously been assigned applies for SCells.

### ServCellIndex Information Element

ServCellIndex ::= INTEGER (0..maxNrofServingCells-1)

### ServingCellConfig

The IE ServingCellConfig is used to configure (add or modify) the UE with a serving cell, which may be the SpCell or an SCell of an MCG or SCG. The parameters herein are mostly UE specific but partly also cell specific (e.g. in additionally configured bandwidth parts). Reconfiguration between a PDCCH and PUCCHless SCell is only supported using an SCell release and add.

### ServingCellConfig Information Element

ServingCellConfig ::= SEQUENCE {
tdd-UL-DL-ConfigurationDedicated TDD-UL-DL-ConfigDedicated
OPTIONAL, -- Cond TDD
initialDownlinkBWP BWP-DownlinkDedicated
OPTIONAL, -- Need M
downlinkBWP-ToReleaseList SEQUENCE (SIZE
(1..maxNrofBWPs)) OF BWP-Id OPTIONAL,
-- Need N
downlinkBWP-ToAddModList SEQUENCE (SIZE
(1..maxNrofBWPs)) OF BWP-Downlink OPTIONAL,
-- Need N
firstActiveDownlinkBWP-Id BWP-Id
OPTIONAL, -- Cond SyncAndCellAdd
bwp-InactivityTimer ENUMERATED {ms2, ms3, ms4, ms5, ms6, ms8, ms10, ms20, ms30,
ms40,ms50, ms60, ms80, ms100, ms200, ms300, ms500,
ms750, ms1280,
ms1920, ms2560, spare10, spare9, spare8,
spare7, spare6,
spare5, spare4, spare3, spare2, spare1 } OPTIONAL, --Need R
defaultDownlinkBWP-Id BWP-Id
OPTIONAL, -- Need S
uplinkConfig UplinkConfig
OPTIONAL, -- Need M
supplementaryUplink UplinkConfig
OPTIONAL, -- Need M
pdcch-ServingCellConfig SetupRelease { PDCCH-
ServingCellConfig } OPTIONAL, -- Need
M
pdsch-ServingCellConfig SetupRelease { PDSCH-
ServingCellConfig } OPTIONAL, -- Need
M
csi-MeasConfig SetupRelease { CSI-MeasConfig
} OPTIONAL, -- Need M
sCellDeactivationTimer ENUMERATED {ms20, ms40, ms80, ms160, ms200, ms240,
ms320, ms400, ms480, ms520, ms640, ms720,
ms840, ms1280,
spare2,spare1} OPTIONAL, -
UplinkConfig ::= SEQUENCE {
initialUplinkBWP BWP-UplinkDedicated
OPTIONAL, -- Need M
uplinkBWP-ToReleaseList SEQUENCE (SIZE
(1..maxNrofBWPs)) OF BWP-Id OPTIONAL,-
- Need N
uplinkBWP-ToAddModList SEQUENCE (SIZE
(1..maxNrofBWPs)) OF BWP-Uplink OPTIONAL,-
- Need N
firstActiveUplinkBWP-Id BWP-Id
OPTIONAL, -- Cond SyncAndCellAdd
pusch-ServingCellConfig SetupRelease { PUSCH-
ServingCellConfig } OPTIONAL, -- Need
M
carrierSwitching SetupRelease { SRS-
CarrierSwitching } OPTIONAL, --
Need M
...,
}

ServingCellConfig field descriptions
bwp-Inactivitytimer
The duration in ms after which the UE falls back to the default Bandwidth Part (see TS 38.321 [3], clause 5.15). When the network releases the timer configuration, the UE stops the timer without switching to the default BWP.
dormantBWP-Config
The dormant BWP configuration for an SCell. This field can be configured only for a (non-PUCCH) SCell.
downlinkBWP-ToAddModList
List of additional downlink bandwidth parts to be added or modified. (see TS 38.213 [13], clause 12).
downlinkBWP-ToReleaseList
List of additional downlink bandwidth parts to be released. (see TS 38.213 [13], clause 12).
downlinkChannelBW-PerSCS-List
A set of UE specific channel bandwidth and location configurations for different subcarrier spacings (numerologies). Defined in relation to Point A. The UE uses the configuration provided in this field only for the purpose of channel bandwidth and location determination. If absent, UE uses the configuration indicated in scs-SpecificCarrierList in DownlinkConfigCommon / DownlinkConfigCommonSIB. Network only configures channel bandwidth that corresponds to the channel bandwidth values defined in TS 38.101-1 [15] and TS 38.101-2 [39].
initialDownlinkBWP
The dedicated (UE-specific) configuration for the initial downlink bandwidth-part (i.e. DL BWP#0). If any of the optional IEs are configured within this IE, the UE considers the BWP#0 to be an RRC configured BWP (from UE capability viewpoint). Otherwise, the UE does not consider the BWP#0 as an RRC configured BWP (from UE capability viewpoint). Network always configures the UE with a value for this field if no other BWPs are configured. NOTE1
pdsch-ServingCellConfig
PDSCH related parameters that are not BWP-specific.
sCellDeactivationTimer
SCell deactivation timer in TS 38.321 [3]. If the field is absent, the UE applies the value infinity.
servingCellMO
measObjectId of the MeasObjectNR in MeasConfig which is associated to the serving cell. For this MeasObjectNR, the following relationship applies between this MeasObjectNR and frequencyInfoDL in ServingCellConfigCommon of the serving cell: if ssbFrequency is configured, its value is the same as the absoluteFrequencySSB and if csi-rs-ResourceConfigMobility is configured, the value of its subcarrierSpacing is present in one entry of the scs-SpecificCarrierList, csi-RS-CellListMobility includes an entry corresponding to the serving cell (with cellld equal to physCellId in ServingCellConfigCommon) and the frequency range indicated by the csi-rs-MeasurementBW of the entry in csi-RS-CellListMobility is included in the frequency range indicated by in the entry of the scs-SpecificCarrierList.
supplementaryUplink
Network may configure this field only when supplementaryUplinkConfig is configured in ServingCellConfigCommon or supplementaryUplink is configured in ServingCellConfigCommonSIB.
supplementaryUplinkRelease
If this field is included, the UE shall release the uplink configuration configured by supplementaryUplink. The network only includes either supplementaryUplinkRelease or supplementaryUplink at a time.
tag-Id
Timing Advance Group ID, as specified in TS 38.321 [3], which this cell belongs to.
uplinkConfig
Network may configure this field only when uplinkConfigCommon is configured in ServingCellConfigCommon or ServingCellConfigCommonSIB. Addition or release of this field can only be done upon SCell addition or release (respectively).
servingCellMO
measObjectId of the MeasObjectNR in MeasConfig which is associated to the serving cell. For this MeasObjectNR, the following relationship applies between this MeasObjectNR and frequencyInfoDL in ServingCellConfigCommon of the serving cell: if ssbFrequency is configured, its value is the same as the absoluteFrequencySSB and if csi-rs-ResourceConfigMobility is configured, the value of its subcarrierSpacing is present in one entry of the scs-SpecificCarrierList, csi-RS-CellListMobility includes an entry corresponding to the serving cell (with cellld equal to physCellId in ServingCellConfigCommon) and the frequency range indicated by the csi-rs-MeasurementBW of the entry in csi-RS-CellListMobility is included in the frequency range indicated by in the entry of the scs-SpecificCarrierList.
supplementaryUplink
Network may configure this field only when supplementaryUplinkConfig is configured in ServingCellConfigCommon or supplementaryUplink is configured in ServingCellConfigCommonSIB.
supplementaryUplinkRelease
If this field is included, the UE shall release the uplink configuration configured by supplementaryUplink. The network only includes either supplementaryUplinkRelease or supplementaryUplink at a time.
tag-Id
Timing Advance Group ID, as specified in TS 38.321 [3], which this cell belongs to.
uplinkConfig
Network may configure this field only when uplinkConfigCommon is configured in ServingCellConfigCommon or ServingCellConfigCommonSIB. Addition or release of this field can only be done upon SCell addition or release (respectively).

### TCI-State

The IE TCI-State associates one or two DL reference signals with a corresponding quasi-colocation (QCL) type.

### TCI-State Information Element

-- ASN1START
-- TAG-TCI-STATE-START
TCI-State ::= SEQUENCE {
tci-StateId TCI-StateId,
qcl-Typel QCL-Info,
qcl-Type2 QCL-Info
OPTIONAL, -- Need R
...
}
QCL-Info ::= SEQUENCE {
cell ServCellIndex
OPTIONAL, -- Need R
bwp-Id BWP-Id
OPTIONAL, -- Cond CSI-RS-Indicated
referenceSignal CHOICE {
csi-rs NZP-CSI-RS-ResourceId,
ssb SSB-Index
},
qcl-Type ENUMERATED {typeA, typeB,
typeC, typeD},
}
-- TAG-TCI-STATE-STOP
-- ASN1STOP

QCL-Info field descriptions
bwp-Id
The DL BWP which the RS is located in.
cell
The UE’s serving cell in which the referenceSignal is configured. If the field is absent, it applies to the serving cell in which the TCI-State is configured. The RS can be located on a serving cell other than the serving cell in which the TCI-State is configured only if the qcl-Type is configured as typeC or typeD. See TS 38.214 [19] clause 5.1.5.
referenceSignal
Reference signal with which quasi-collocation information is provided as specified in TS 38.214 [19] subclause 5.1.5.
qcl-Type
QCL type as specified in TS 38.214 [19] subclause 5.1.5.

### TCI-StateId

The IE TCI-Stateld is used to identify one TCI-State configuration.

### TCI-StateId Information Element

-- ASN1START
-- TAG-TCI-STATEID-START
TCI-StateId ::= INTEGER (0..maxNrofTCI-States-1)
-- TAG-TCI-STATEID-STOP
-- ASN1STOP

Random access procedure is introduced in 3GPP specification 38.321 v16.6.0, one or more parts of which are quoted below:

### 5.1 Random Access Procedure

### 5.1.1 Random Access Procedure Initialization

The Random Access procedure described in this clause is initiated by a PDCCH order, by the MAC entity itself, or by RRC for the events in accordance with TS 38.300 [2]. There is only one Random Access procedure ongoing at any point in time in a MAC entity. The Random Access procedure on an SCell shall only be initiated by a PDCCH order with ra-Preamblelndex different from 0b000000.

NOTE 1: If a new Random Access procedure is triggered while another is already ongoing in the MAC entity, it is up to UE implementation whether to continue with the ongoing procedure or start with the new procedure (e.g. for SI request).

NOTE 2: If there was an ongoing Random Access procedure that is triggered by a PDCCH order while the UE receives another PDCCH order indicating the same Random Access Preamble, PRACH mask index and uplink carrier, the Random Access procedure is considered as the same Random Access procedure as the ongoing one and not initialized again.

When the Random Access procedure is initiated on a Serving Cell, the MAC entity shall:
1> flush the Msg3 buffer;
1> flush the MSGA buffer;
1> set the PREAMBLE_TRANSMISSION_COUNTER to 1;
1> set the PREAMBLE_POWER_RAMPING_{_}COUNTER to 1;
1> set the PREAMBLE_BACKOFF to 0 ms;
1> set POWER_OFFSET_2STEP_RA to 0 dB;
1> if the carrier to use for the Random Access procedure is explicitly signalled:
   2> select the signalled carrier for performing Random Access procedure;
   2> set the PCMAX to P_{CMAX},_{f},_{c} of the signalled carrier.
1> else if the carrier to use for the Random Access procedure is not explicitly signalled; and
1> if the Serving Cell for the Random Access procedure is configured with supplementary uplink as specified in TS 38.331 [5]; and
1> if the RSRP of the downlink pathloss reference is less than rsrp-ThresholdSSB-SUL:
   2> select the SUL carrier for performing Random Access procedure;
   2> set the PCMAX to P_{CMAX},_{f},_{c} of the SUL carrier.
1> else:
   2> select the NUL carrier for performing Random Access procedure;
   2> set the PCMAX to P_{CMAX},_{f},_{c} of the NUL carrier.
1> perform the BWP operation as specified in clause 5.15;
1> if the Random Access procedure is initiated by PDCCH order and if the ra-Preamblelndex explicitly provided by PDCCH is not 0b000000; or
1> if the Random Access procedure was initiated for SI request (as specified in TS 38.331 [5]) and the Random Access Resources for SI request have been explicitly provided by RRC; or
1> if the Random Access procedure was initiated for SpCell beam failure recovery (as specified in clause 5.17) and if the contention-free Random Access Resources for beam failure recovery request for 4-step RA type have been explicitly provided by RRC for the BWP selected for Random Access procedure; or
1> if the Random Access procedure was initiated for reconfiguration with sync and if the contention-free Random Access Resources for 4-step RA type have been explicitly provided in rach-ConfigDedicated for the BWP selected for Random Access procedure:
   2> set the RA_TYPE to 4-stepRA.
   [...]
1> perform initialization of variables specific to Random Access type as specified in clause 5.1.1a; [...]
   2> perform the Random Access Resource selection procedure (see clause 5.1.2).

### 5.1.2 Random Access Resource Selection

If the selected RA_TYPE is set to 4-stepRA, the MAC entity shall: [...]
1> else if the ra-Preamblelndex has been explicitly provided by PDCCH; and
1> if the ra-PreambleIndex is not 0b000000:
   2> set the PREAMBLE_INDEX to the signalled ra-PreambleIndex;
   2> select the SSB signalled by PDCCH.
1> else if the contention-free Random Access Resources associated with SSBs have been explicitly provided in rach-ConfigDedicated and at least one SSB with SS-RSRP above rsrp-ThresholdSSB amongst the associated SSBs is available:
   2> select an SSB with SS-RSRP above rsrp-ThresholdSSB amongst the associated SSBs;
   2> set the PREAMBLE_{_}INDEX to a ra-Preamblelndex corresponding to the selected SSB.
1> else if the contention-free Random Access Resources associated with CSI-RSs have been explicitly provided in rach-ConfigDedicated and at least one CSI-RS with CSI-RSRP above rsrp-ThresholdCSl-RS amongst the associated CSI-RSs is available:
   2> select a CSI-RS with CSI-RSRP above rsrp-ThresholdCSI-RS amongst the associated CSI-RSs;
   2> set the PREAMBLE_INDEX to a ra-Preamblelndex corresponding to the selected CSI-RS. [...]
1> else (i.e. for the contention-based Random Access preamble selection):
   2> if at least one of the SSBs with SS-RSRP above rsrp-ThresholdSSB is available:
      3> select an SSB with SS-RSRP above rsrp-ThresholdSSB.
   2> else:
      3> select any SSB.
      [...] 2> select a Random Access Preamble randomly with equal probability from the Random Access Preambles associated with the selected SSB and the selected Random Access Preambles group;
   2> set the PREAMBLE_INDEX to the selected Random Access Preamble.
   [...]
1> else if an SSB is selected above:
   2> determine the next available PRACH occasion from the PRACH occasions corresponding to the selected SSB permitted by the restrictions given by the ra-ssb-OccasionMaskIndex if configured or indicated by PDCCH (the MAC entity shall select a PRACH occasion randomly with equal probability amongst the consecutive PRACH occasions according to clause 8.1 of TS 38.213 [6], corresponding to the selected SSB; the MAC entity may take into account the possible occurrence of measurement gaps when determining the next available PRACH occasion corresponding to the selected SSB).
1> else if a CSI-RS is selected above:
   2> if there is no contention-free Random Access Resource associated with the selected CSI-RS:
      3> determine the next available PRACH occasion from the PRACH occasions, permitted by the restrictions given by the ra-ssb-OccasionMasklndex if configured, corresponding to the SSB in candidateBeamRSList which is quasi-colocated with the selected CSI-RS as specified in TS 38.214 [7] (the MAC entity shall select a PRACH occasion randomly with equal probability amongst the consecutive PRACH occasions according to clause 8.1 of TS 38.213 [6], corresponding to the SSB which is quasi-colocated with the selected CSI-RS; the MAC entity may take into account the possible occurrence of measurement gaps when determining the next available PRACH occasion corresponding to the SSB which is quasi-colocated with the selected CSI-RS).
   2> else:
      3> determine the next available PRACH occasion from the PRACH occasions in ra-OccasionList corresponding to the selected CSI-RS (the MAC entity shall select a PRACH occasion randomly with equal probability amongst the PRACH occasions occurring simultaneously but on different subcarriers, corresponding to the selected CSI-RS; the MAC entity may take into account the possible occurrence of measurement gaps when determining the next available PRACH occasion corresponding to the selected CSI-RS).
1> perform the Random Access Preamble transmission procedure (see clause 5.1.3).

### 5.1.3 Random Access Preamble Transmission

The MAC entity shall, for each Random Access Preamble: [...]
1> set PREAMBLE_RECEIVED_TARGET_POWER to preambleReceivedTargetPower + DELTA_PREAMBLE + (PREAMBLE_POWER_RAMPING_COUNTER - 1) × PREAMBLE_POWER_RAMPING_STEP + POWER_OFFSET_2STEP_RA;
1> except for contention-free Random Access Preamble for beam failure recovery request, compute the RA-RNTI associated with the PRACH occasion in which the Random Access Preamble is transmitted;
1> instruct the physical layer to transmit the Random Access Preamble using the selected PRACH occasion, corresponding RA-RNTI (if available), PREAMBLE_INDEX, and PREAMBLE_RECEIVED_TARGET_POWER.

### 5.1.4 Random Access Response Reception

Once the Random Access Preamble is transmitted and regardless of the possible occurrence of a measurement gap, the MAC entity shall:
1> if the contention-free Random Access Preamble for beam failure recovery request was transmitted by the MAC entity:
   2> start the ra-ResponseWindow configured in BeamFailureRecoveryConfig at the first PDCCH occasion as specified in TS 38.213 [6] from the end of the Random Access Preamble transmission;
   2> monitor for a PDCCH transmission on the search space indicated by recoverySearchSpaceld of the SpCell identified by the C-RNTI while ra-ResponseWindow is running.
1> else:
   2> start the ra-ResponseWindow configured in RACH-ConfigCommon at the first PDCCH occasion as specified in TS 38.213 [6] from the end of the Random Access Preamble transmission;
   2> monitor the PDCCH of the SpCell for Random Access Response(s) identified by the RA-RNTI while the ra-ResponseWindow is running.
1> if notification of a reception of a PDCCH transmission on the search space indicated by recoverySearchSpaceld is received from lower layers on the Serving Cell where the preamble was transmitted; and
1> if PDCCH transmission is addressed to the C-RNTI; and
1> if the contention-free Random Access Preamble for beam failure recovery request was transmitted by the MAC entity:
   2> consider the Random Access procedure successfully completed.
1> else if a valid (as specified in TS 38.213 [6]) downlink assignment has been received on the PDCCH for the RA-RNTI and the received TB is successfully decoded:
   2> if the Random Access Response contains a MAC subPDU with Backoff Indicator:
      3> set the PREAMBLE_BACKOFF to value of the BI field of the MAC subPDU using Table 7.2-1, multiplied with SCALING_FACTOR_BI.
   2> else:
      3> set the PREAMBLE_BACKOFF to 0 ms.
   2> if the Random Access Response contains a MAC subPDU with Random Access Preamble identifier corresponding to the transmitted PREAMBLE_INDEX (see clause 5.1.3):
      3> consider this Random Access Response reception successful.
   2> if the Random Access Response reception is considered successful:
      3> if the Random Access Response includes a MAC subPDU with RAPID only:
         4> consider this Random Access procedure successfully completed;
         4> indicate the reception of an acknowledgement for SI request to upper layers.
      3> else:
         4> apply the following actions for the Serving Cell where the Random Access Preamble was transmitted:
         5> process the received Timing Advance Command (see clause 5.2);
         5> indicate the preambleReceivedTargetPower and the amount of power ramping applied to the latest Random Access Preamble transmission to lower layers (i.e. (PREAMBLE_POWER_RAMPING_COUNTER - 1) × PREAMBLE_POWER_RAMPING_STEP);
         5> if the Random Access procedure for an SCell is performed on uplink carrier where pusch-Config is not configured:
         6> ignore the received UL grant.
         5> else:
         6> process the received UL grant value and indicate it to the lower layers.
         4> if the Random Access Preamble was not selected by the MAC entity among the contention-based Random Access Preamble(s):
         5> consider the Random Access procedure successfully completed.
         4> else:
         5> set the TEMPORARY_C-RNTI to the value received in the Random Access Response;
         5> if this is the first successfully received Random Access Response within this Random Access procedure:
         6> if the transmission is not being made for the CCCH logical channel:
         7> indicate to the Multiplexing and assembly entity to include a C-RNTI MAC CE in the subsequent uplink transmission.
         6> if the Random Access procedure was initiated for SpCell beam failure recovery and spCell-BFR-CBRA with value true is configured:
         7> indicate to the Multiplexing and assembly entity to include a BFR MAC CE or a Truncated BFR MAC CE in the subsequent uplink transmission.
         6> obtain the MAC PDU to transmit from the Multiplexing and assembly entity and store it in the Msg3 buffer.

### 5.1.5 Contention Resolution

Once Msg3 is transmitted the MAC entity shall:
1> start the ra-ContentionResolutionTimer and restart the ra-ContentionResolutionTimer at each HARQ retransmission in the first symbol after the end of the Msg3 transmission;
1> monitor the PDCCH while the ra-ContentionResolutionTimer is running regardless of the possible occurrence of a measurement gap;
1> if notification of a reception of a PDCCH transmission of the SpCell is received from lower layers:
   2> if the C-RNTI MAC CE was included in Msg3:
      3> if the Random Access procedure was initiated for SpCell beam failure recovery (as specified in clause 5.17) and the PDCCH transmission is addressed to the C-RNTI; or
      3> if the Random Access procedure was initiated by a PDCCH order and the PDCCH transmission is addressed to the C-RNTI; or
      3> if the Random Access procedure was initiated by the MAC sublayer itself or by the RRC sublayer and the PDCCH transmission is addressed to the C-RNTI and contains a UL grant for a new transmission:
         4> consider this Contention Resolution successful;
         4> stop ra-ContentionResolutionTimer;
         4> discard the TEMPORARY_C-RNTl;
         4> consider this Random Access procedure successfully completed.
   2> else if the CCCH SDU was included in Msg3 and the PDCCH transmission is addressed to its TEMPORARY_C-RNTl:
      3> if the MAC PDU is successfully decoded:
         4> stop ra-ContentionResolutionTimer;
         4> if the MAC PDU contains a UE Contention Resolution Identity MAC CE; and
         4> if the UE Contention Resolution Identity in the MAC CE matches the CCCH SDU transmitted in Msg3:
         5> consider this Contention Resolution successful and finish the disassembly and demultiplexing of the MAC PDU;
         5> if this Random Access procedure was initiated for SI request:
         6> indicate the reception of an acknowledgement for SI request to upper layers.
         5> else:
         6> set the C-RNTI to the value of the TEMPORARY_C-RNTI;
         5> discard the TEMPORARY_C-RNTI;
         5> consider this Random Access procedure successfully completed.
         4> else:
         5> discard the TEMPORARY_C-RNTI;
         5> consider this Contention Resolution not successful and discard the successfully decoded MAC PDU.

### 5.1.6 Completion of the Random Access Procedure

Upon completion of the Random Access procedure, the MAC entity shall:
1> discard any explicitly signalled contention-free Random Access Resources for 2-step RA type and 4-step RA type except the 4-step RA type contention-free Random Access Resources for beam failure recovery request, if any;
1> flush the HARQ buffer used for transmission of the MAC PDU in the Msg3 buffer and the MSGA buffer.

Upon successful completion of the Random Access procedure initiated for DAPS handover, the target MAC entity shall:

1> indicate the successful completion of the Random Access procedure to the upper layers.

### 5.9 Activation/Deactivation of SCells

If the MAC entity is configured with one or more SCells, the network may activate and deactivate the configured SCells. Upon configuration of an SCell, the SCell is deactivated unless the parameter sCellState is set to activated for the SCell by upper layers.

The configured SCell(s) is activated and deactivated by:
receiving the SCell Activation/Deactivation MAC CE described in clause 6.1.3.10;
configuring sCellDeactivationTimer timer per configured SCell (except the SCell configured with PUCCH, if any): the associated SCell is deactivated upon its expiry;
configuring sCellState per configured SCell: if configured, the associated SCell is activated upon SCell configuration.

The MAC entity shall for each configured SCell:
1> if an SCell is configured with sCellState set to activated upon SCell configuration, or an SCell Activation/Deactivation MAC CE is received activating the SCell:
   2> if the SCell was deactivated prior to receiving this SCell Activation/Deactivation MAC CE; or
   2> if the SCell is configured with sCellState set to activated upon SCell configuration:
      3> if firstActiveDownlinkBWP-Id is not set to dormant BWP:
         4> activate the SCell according to the timing defined in TS 38.213 [6] for MAC CE activation and according to the timing defined in TS 38.133 [11] for direct SCell activation; i.e. apply normal SCell operation including:
         5> SRS transmissions on the SCell;
         5> CSI reporting for the SCell;
         5> PDCCH monitoring on the SCell;
         5> PDCCH monitoring for the SCell;
         5> PUCCH transmissions on the SCell, if configured.
      3> else (i.e. firstActiveDownlinkBWP-Id is set to dormant BWP):
         4> stop the bwp-InactivityTimer of this Serving Cell, if running.
      3> activate the DL BWP and UL BWP indicated by firstActiveDownlinkBWP-Id and firstActiveUplinkBWP-Id respectively.
   2> start or restart the sCellDeactivationTimer associated with the SCell according to the timing defined in TS 38.213 [6] for MAC CE activation and according to the timing defined in TS 38.133 [11] for direct SCell activation;
   2> if the active DL BWP is not the dormant BWP:
      3> (re-)initialize any suspended configured uplink grants of configured grant Type 1 associated with this SCell according to the stored configuration, if any, and to start in the symbol according to rules in clause 5.8.2;
      3> trigger PHR according to clause 5.4.6.
1> else if an SCell Activation/Deactivation MAC CE is received deactivating the SCell; or
1> if the sCellDeactivationTimer associated with the activated SCell expires:
   2> deactivate the SCell according to the timing defined in TS 38.213 [6];
   2> stop the sCellDeactivationTimer associated with the SCell;
   2> stop the bwp-InactivityTimer associated with the SCell;
   2> deactivate any active BWP associated with the SCell;
   2> clear any configured downlink assignment and any configured uplink grant Type 2 associated with the SCell respectively;
   2> clear any PUSCH resource for semi-persistent CSI reporting associated with the SCell;
   2> suspend any configured uplink grant Type 1 associated with the SCell;
   2> flush all HARQ buffers associated with the SCell;
   2> cancel, if any, triggered consistent LBT failure for the SCell.
1> if PDCCH on the activated SCell indicates an uplink grant or downlink assignment; or
1> if PDCCH on the Serving Cell scheduling the activated SCell indicates an uplink grant or a downlink assignment for the activated SCell; or
1> if a MAC PDU is transmitted in a configured uplink grant and LBT failure indication is not received from lower layers; or
1> if a MAC PDU is received in a configured downlink assignment:
   2> restart the sCellDeactivationTimer associated with the SCell.
1> if the SCell is deactivated:
   2> not transmit SRS on the SCell;
   2> not report CSI for the SCell;
   2> not transmit on UL-SCH on the SCell;
   2> not transmit on RACH on the SCell;
   2> not monitor the PDCCH on the SCell;
   2> not monitor the PDCCH for the SCell;
   2> not transmit PUCCH on the SCell.

HARQ feedback for the MAC PDU containing SCell Activation/Deactivation MAC CE shall not be impacted by PCell, PSCell and PUCCH SCell interruptions due to SCell activation/deactivation in TS 38.133 [11].

When SCell is deactivated, the ongoing Random Access procedure on the SCell, if any, is aborted.

In NR, a UE may perform a handover procedure to switch from one cell to another cell. The UE performs the handover procedure in response to a Radio Resource Control (RRC) signaling transmitted by a network. The RRC signaling comprises cell information of a target cell. The network determines to initiate the handover procedure based on measurement reports of the UE. Change of a Primary Cell (PCell) and/or a PSCell via reconfiguration with sync (e.g. involving Layer-3 (L3) RRC message) may involve higher latency and/or more overhead than Layer-1 (L1)/Layer-2 (L2) signaling (e.g. beam switch mobility). Alternatively and/or additionally, in operation on Frequency Range 2 (FR2), frequent Secondary Cell Group (SCG) changes will occur, which may also lead to high latency for UE-NW communication if L3 Handover is used. In the present disclosure, the term “PSCell” may refer to a Primary SCG Cell and/or a Primary Secondary Cell. Therefore, in WID on NR further mobility enhancements provided in RP-212710, an objective of the work item may be to specify a mechanism and/or procedure for dynamic switching mechanism among serving cells, including one or more Special Cells (SpCells) and/or one or more Secondary Cells (SCells) based on L1/L2 signaling. In the present disclosure, the term “L1/L2 signaling” may refer to L1 signaling and/or L2 signaling.

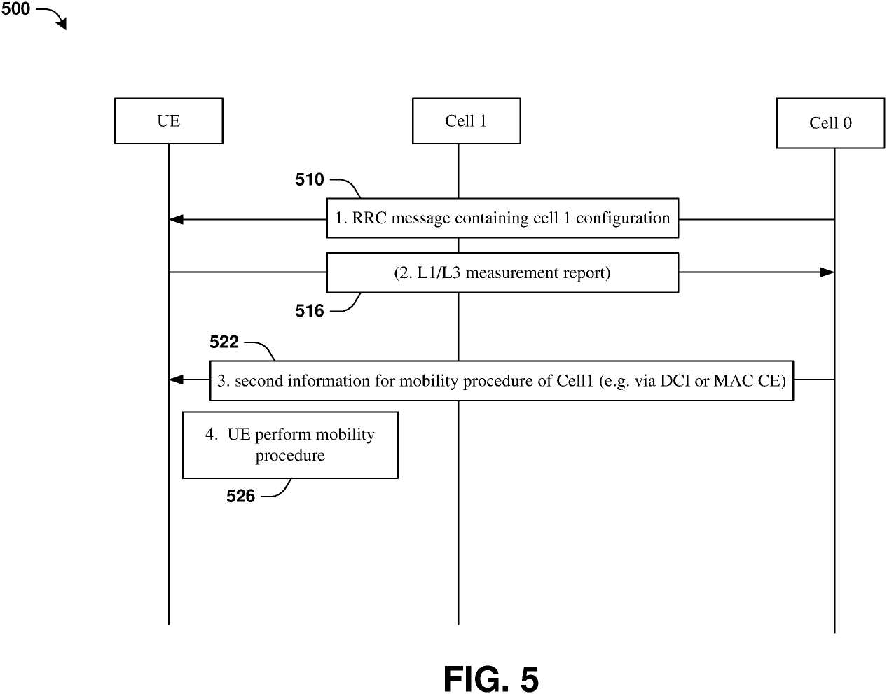

FIG. 5 illustrates a scenario 500 associated with a UE, a first cell “Cell 0”, and a second cell “Cell 1”. The UE may receive a first information 510 (e.g., a step 1 RRC message), comprising Cell 1 configuration, from Cell 0. The UE may perform RRC connection with Cell 0. The Cell 1 configuration may comprise a Serving Cell configuration of Cell 1. Cell 1 may be a neighboring cell, a SCell, or a PCell of the UE. The UE may transmit a L1/L3 measurement report 516 to Cell 0 (e.g., the L1/L3 measurement report 516 may comprise measurement associated with Cell 1). The Cell 0 may transmit a second information 522 (e.g., a step 3 Downlink Control Information (DCI) or Medium Access Control (MAC) Control Element (CE)) to the UE for initiating a mobility procedure associated with Cell 1. In response to receiving the second information 522, the UE may initiate and/or perform a mobility procedure 526 associated with Cell 1. Corresponding to various setups for the information (e.g., the first information 510 and/or the second information 522) and/or procedure (e.g., procedure), the UE may perform one or more procedures to Cell 1 (e.g., SCell addition and/or SCell release; PCell switching, etc.). The present disclosure provides methods and procedures to achieve SCell switching in L1/L2 mobility procedure.

A concept of the present disclosure is that a UE may receive a first information comprising one or more configurations of one or more cells. The UE may receive a second information indicating, to the UE, an index/identity associated with at least one cell of the one or more cells. In the present disclosure, the term “index/identity” may correspond to an index and/or an identity (id). The second information may not comprise (e.g., may not indicate) the configurations of the one or more cells. The second information may indicate to the UE (e.g., instruct the UE) to initiate a mobility procedure (e.g., the second information may comprise signaling initiating the mobility procedure and/or may comprise information for the mobility procedure, such as information that is necessary to perform the mobility procedure). The UE may initiate a mobility procedure in response to receiving the second information. The UE may not initiate the mobility procedure in response to receiving the first information. Alternatively and/or additionally, the UE may consider a first cell (e.g., at least one cell) of the one or more cells to be a Serving Cell of the UE in response to a completion of the mobility procedure initiated in response to receiving the second information. The UE may not consider the first cell of the one or more cells to be a Serving Cell of the UE in response to receiving the first information (and/or before performing and/or completing the mobility procedure initiated in response to receiving the second information).

The first information and the second information may be transmitted in different signalings. In the present disclosure, the term “signaling” may correspond to at least one of a signal, a set of signals, a transmission, a message, etc.

The first information and the second information may be transmitted at different timings. In the present disclosure, the term “timing” may correspond to at least one of a time, a time period, a time unit, a slot, a symbol, etc.

### Embodiment 1

In Embodiment 1, the first information may include multiple sets of cells and/or Cell Groups (CGs), and the second information may indicate which set of cells, of a multiple sets of cells, to apply.

The configurations may include serving cell configuration.

The first information (received by the UE) may indicate one or more sets of cells (e.g., CellGroupConfig). In the present disclosure, the term “set of cells” may correspond to a set of cells and/or CGs, wherein the set of cells and/or CGs may comprise one or more cells and/or one or more CGs. Each set of the one or more sets may comprise one or more cells and/or one or more CGs. Each set of the one or more sets may comprise a SpCell (e.g., a PCell and/or a PSCell) associated with the UE (e.g., the SpCell may be in a Master Cell Group (MCG) associated with the UE, or in a SCG associated with the UE). Each set of the one or more sets may comprise one or more SCells associated with the UE (e.g., the one or more SCells may be in the MCG, or in the SCG). The first information may indicate cell configuration (e.g., ServingCellconfig) associated with each of the cells (e.g., for each cell of the one or more sets, the first information may indicate a cell configuration associated with the cell). Alternatively and/or additionally, the first information may indicate whether a cell in the one or more sets is a SpCell (e.g., a candidate SpCell) or a SCell. Each set of the one or more sets may comprise one or more neighboring cells associated with the UE. Each set of the one or more sets may comprise one or more non-serving cells of the UE (e.g., the one or more non-serving cells may correspond to one or more cells associated with one or more Physical Cell Identifiers (PCIs) different from one or more Serving Cells). Each set of the one or more sets may be a candidate cell group or a candidate set of cells for the UE to perform mobility procedure and/or L1/L2 mobility. Alternatively and/or additionally, the first information may indicate a configuration for each set of the one or more sets of cells (e.g., CellGroupConfig).

Each set of the one or more sets may be associated with (e.g., may be assigned with) an index/identity. The index/identity may be provided (e.g., indicated) in the first information.

The second information (received by the UE) may indicate an index/identity associated with a first set among the one or more sets. The UE may add and/or activate one or more cells, comprising one, some and/or all cells associated with (e.g., indicated in) the first set, in response to a mobility procedure corresponding to the second information (e.g., in response to initiation or completion of the mobility procedure) and/or in response to reception of the second information. The UE may consider the one or more cells associated with (e.g., indicated in) the first set to be one or more Serving Cells in response to the mobility procedure (e.g., in response to initiation or completion of the mobility procedure) and/or in response to reception of the second information. The second information may indicate whether the first set is for MCG or for SCG. Alternatively and/or additionally, the first information may not indicate whether the first set is for MCG or for SCG. The first set may correspond to a set of one or more cells and/or a set of one or more CGs.

Alternatively and/or additionally, when the first set is for a CG (e.g., MCG or SCG), the UE may release, remove and/or deactivate one or more cells in the CG (e.g., one or more cells that are originally in the CG and/or that are not indicated in the first set) in response to the mobility procedure corresponding to the second information (e.g., in response to initiation or completion of the mobility procedure) and/or in response to reception of the second information. Alternatively and/or additionally, the UE may release cells in a CG that is not associated with (e.g., that is not indicated in the first set) in response to the mobility procedure (e.g., in response to initiation or completion of the mobility procedure). For example, the UE may release cells in a SCG (in response to the mobility procedure, for example) based on the first set being for MCG (e.g., the first set being indicated as comprising cells of a MCG).

Alternatively and/or additionally, the second information may indicate an index/identity associated with a second set among the one or more sets. The UE may add and/or activate one or more cells, comprising one, some and/or all cells associated with (e.g., indicated in) the second set, in response to a mobility procedure corresponding to the second information (e.g., in response to initiation or completion of the mobility procedure) and/or in response to reception of the second information. The UE may consider the one or more cells associated with (e.g., indicated in) the second set to be one or more Serving Cells in response to the mobility procedure (e.g., in response to initiation or completion of the mobility procedure) and/or in response to reception of the second information. The second information may indicate whether the second set is for MCG or for SCG. In some examples, the first set and the second set may be for different CGs (e.g., the first set may be for a first CG and the second set may be for a second CG different than the first CG). The second set may correspond to a set of one or more cells and/or a set of one or more CGs.

Alternatively and/or additionally, when the second set is for a CG (e.g., MCG or SCG), the UE may release, remove and/or deactivate one or more cells in the CG (e.g., one or more cells that are originally in the CG and/or that are not indicated in the second set) in response to the mobility procedure corresponding to the second information (e.g., in response to initiation or completion of the mobility procedure) and/or in response to reception of the second information.

For example, the second information may be indicative of a first set identity for MCG of the UE and a second set identity for SCG of the UE. In response to (and/or when) (i) initiating or completing the mobility procedure associated with the second information and/or (ii) reception of the second information, the UE may (A) consider cells of a set of cells (e.g., a set of cells associated with the first set id, wherein the set of cells may correspond to the first set) to be Serving Cells in the MCG, and (B) consider cells of a set of cells (e.g., a set of cells associated with the second set id, wherein the set of cells may correspond to the second set) to be Serving Cells in the SCG.

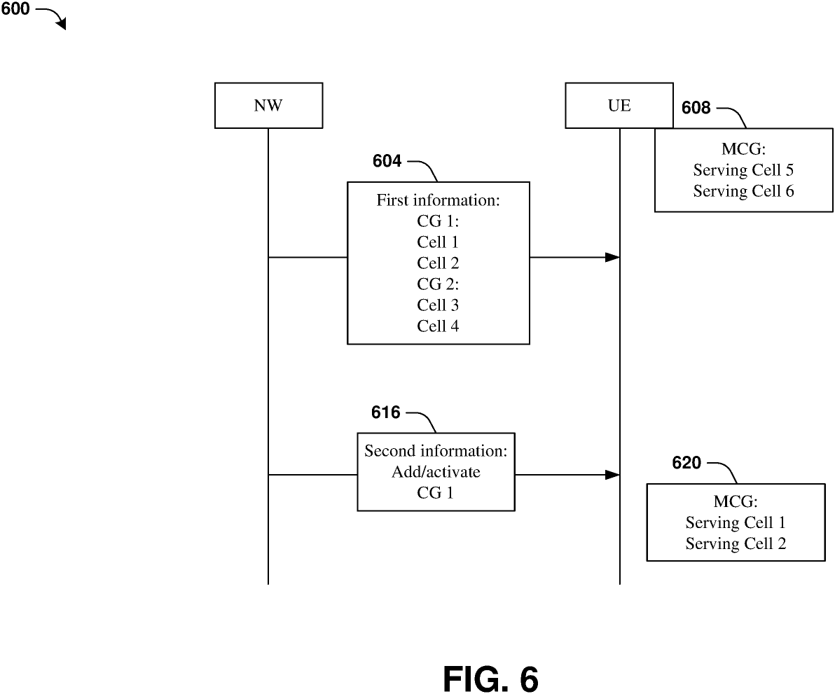

FIG. 6 illustrates a scenario 600 associated with a UE and a network “NW”. The UE may perform communication with the NW via a Serving Cell 5 and Serving Cell 6 in a MCG 608. The NW provides (e.g., configures) the UE with a first information 604. The first information 604 indicates a candidate cell group CG1 comprising a Cell 1 and a Cell 2 and a candidate cell group CG2 comprising a Cell 3 and Cell 4. The NW transmits a second information 616 (via MAC CE or DCI, for example) to the UE. The second information 616 may be indicative of adding and/or activating CG 1. The second information 616 may include an index/identity of the CG1. The UE, in response to receiving the second information 616, may initiate a mobility procedure to the NW to change one or more cells of the UE to Cell 1 and Cell 2. In response to initiation and/or completion of the mobility procedure, the UE may switch Serving Cells (of the UE) to Cell 1 and Cell 2 (e.g., switch the Serving Cells from Serving Cell 5 and Serving Cell 6 to Cell 1 and Cell 2). The UE may release and/or deactivate Serving Cell 5 and Serving Cell 6 (e.g., original MCG and/or SCG cells of the UE) in response to the mobility procedure. The UE may consider Cell 1 and Cell 2 to be Serving Cells of the UE in response to the mobility procedure. In an example, after the mobility procedure, the UE may perform communication with the NW via Serving Cells 620 comprising Serving Cell 1 (e.g., Cell 1) and Serving Cell 2.

### Embodiment 2

In Embodiment 2, one or more different types of cells may be indicated in one or more different sets of cells.

In some examples, the first information may indicate multiple sets of cells. Each set of the multiple sets may be associated with a type of cell (e.g., each set of the multiple sets may be associated with merely a single type of cell). In an example, the type may be one of Serving Cell, neighboring cell, non-serving cell, or a cell with PCI different from Serving Cell. In an example, the multiple sets may comprise a set of one or more Serving Cells, a set of one or more neighboring Cells, a set of one or more non-serving cells, and/or a set of one or more cells having PCI different than PCI of one or more Serving Cells. The first information may indicate and/or categorize different types of Cells in different sets of the multiple sets of Cells.

In some examples, each set, in the multiple sets, may be associated with (e.g., may be assigned with) an index/identity. The index/identity may be provided (e.g., indicated) in the first information.

The second information may indicate a plurality of indexes/identities associated with a plurality of sets of the multiple sets of Cells. For example, each index/identity of the plurality of indexes/identities may be indicative of a set of cells of the plurality of sets of cells. The UE may consider Cells indicated in the plurality of sets of cells (indicated by the plurality of indexes/identities) to be Serving Cells in response to the mobility procedure (e.g., in response to initiation or completion of the mobility procedure) and/or in response to reception of the second information. The second information may indicate whether the plurality of sets (of the multiple sets) is for MCG or for SCG.

Alternatively and/or additionally, when the plurality of sets of the multiple sets are for a CG (e.g., MCG or SCG), the UE may release, remove and/or deactivate one or more Cells in the CG (e.g., one or more cells that are originally in the CG and/or that are not indicated in the plurality of sets) in response to the mobility procedure corresponding to the second information (e.g., in response to initiation or completion of the mobility procedure) and/or in response to reception of the second information.

### Embodiment 3

In Embodiment 3, two sets of cells may be indicated for each CG.

In some examples, the first information may indicate Cells associated with different CGs in different sets of Cells. For example, the first information may indicate a first set of Cells (associated with a first set id, for example). The first set of Cells may comprise Cells associated with a MCG of the UE. The first information may indicate a second set of Cells (associated with a second set id, for example). The second set of Cells may comprise Cells associated with a SCG of the UE. The second information may indicate two indexes/identities associated with two sets of Cells in the one or more sets (e.g., the one or more sets of cells indicated by the first information). In some examples, the two sets of Cells (indicated by the two indexes/identities) may comprise one set of Cells for each CG (e.g., the two sets of Cells may comprise a set of cells for the MCG of the UE and a set of cells for the SCG of the UE). For example, the second information may indicate the first set identity and the second set identity to the UE. In response to (and/or when) (i) initiating or completing the mobility procedure associated with the second information and/or (ii) reception of the second information, the UE may (A) consider the Cells associated with the first set of Cells to be Serving Cells in the MCG, and may consider the Cells associated with the second set of Cells to be Serving Cells in the SCG. In an example, the UE may consider the cells associated with the first set of cells to be Serving Cells in the MCG based on the two indexes/identities indicated by the second information comprising a first index/identity corresponding to the first set of cells. In an example, the UE may consider the cells associated with the second set of cells to be Serving Cells in the SCG based on the two indexes/identities indicated by the second information comprising a second index/identity corresponding to the first set of cells.

### Embodiment 4

In Embodiment 4, cells of two CGs may be included in one set of Cells (indicated by the first information, for example).

In some examples, the first information may indicate one or more sets of Cells (e.g., one or more sets of MCG and SCG cells). Alternatively and/or additionally, each set of the one or more sets indicated in the first information may comprise one or more Cells to be associated with a MCG of the UE and one or more Cells to be associated with a SCG of the UE. Each set, of the one or more sets, may be associated with (e.g., may be assigned with) an index/identity. The index/identity may be provided in (e.g., indicated by) the first information. The UE may differentiate between Cells associated with MCG and Cells associated with SCG based on Serving Cell index/identity. Alternatively, each Cell in a set of Cells (e.g., one set of cells of the one or more sets indicated by the first information) may be associated with an indication (e.g., a flag and/or parameter provided via the first information) for indicating which Cell group (e.g., MCG or SCG) the Cell belongs to. The second information may indicate an index/identity associated with one set (e.g., one set of cells comprising one or more cells associated with the MCG and one or more cells associated with the SCG) of the one or more sets of Cells. In response to (and/or when) (i) initiating or completing the mobility procedure associated with the second information and/or (ii) reception of the second information, the UE may (A) consider a first subset of Cells in the one set (e.g., the one set of Cells indicated by the index/identity indicated by the second information) to be one or more Serving Cells of the MCG of the UE and (B) consider a second subset of Cells in the one set (e.g., the second subset of Cells may comprise remaining cells, of the one set, other than the first subset of Cells) to be one or more Serving Cells of the SCG of the UE.

Alternatively and/or additionally, the UE may release, remove and/or deactivate one or more Cells in the MCG and/or release, remove and/or deactivate one or more Cells in the SCG (e.g., one or more cells that are originally in the MCG and/or the SCG, and/or that are not indicated by the one set) in response to the mobility procedure corresponding to the second information (e.g., in response to initiation or completion of the mobility procedure) and/or in response to reception of the second information.

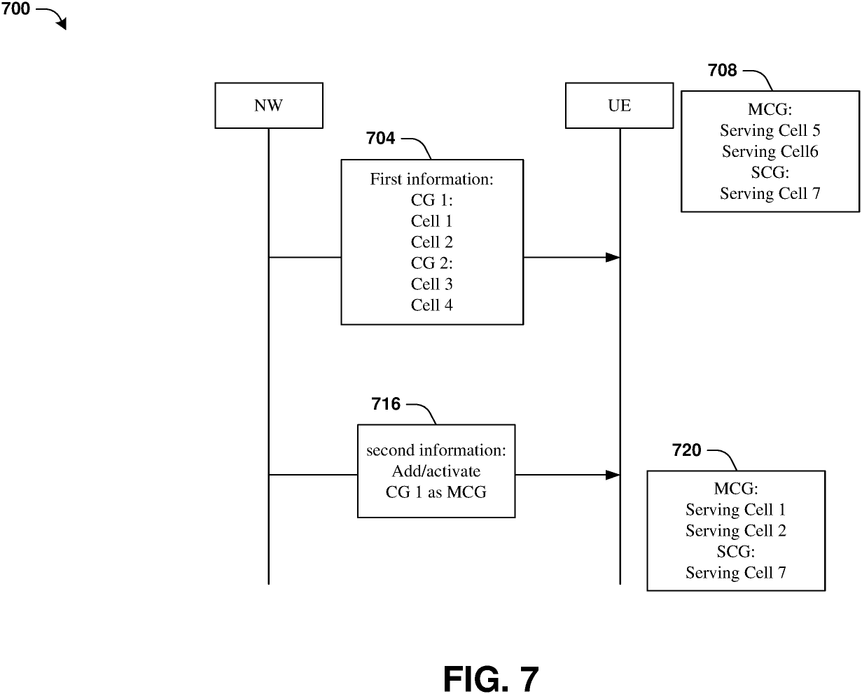

FIG. 7 illustrates a scenario 700 associated with a UE and a network “NW”. The UE may perform communication with the NW Serving Cells 708. The Serving Cells 708 may comprise a Serving Cell 5 and Serving Cell 6 in a MCG, and a Serving Cell 7 in a SCG. The NW provides (e.g., configures) the UE with a first information 704. The first information 704 indicates a candidate Cell group CG1 comprising Cell 1 and Cell 2 and a candidate Cell group CG2 comprising a Cell 3 and Cell 4. The NW transmits a second information 716 (via MAC CE or DCI, for example) to the UE. The second information 716 may be indicative of adding and/or activating CG 1. The second information 716 may include an index/identity of the CG1. The second information 716 may indicate adding and/or activating CG1 as MCG. The UE, in response to receiving the second information 716, may initiate a mobility procedure to the NW to change one or more Cells in MCG of the UE to Cell 1 and Cell 2. In response to initiation or completion of the mobility procedure, the UE may switch its Serving Cells in MCG to Cell 1 and Cell 2. For example, the UE may switch the Serving Cells in MCG from Serving Cell 5 and Serving Cell 6 to Cell 1 and Cell 2. The UE may release and/or deactivate Serving Cell 5 and Serving Cell 6 (e.g., original MCG cells) in response to the mobility procedure. The UE may not release and/or deactivate Serving Cell 7 in response to the mobility procedure (based on Serving Cell 7 being in the SCG of the UE, for example). In an example, after the mobility procedure, the UE may perform communication with the NW via Serving Cells 720 comprising Serving Cell 1 (e.g., Cell 1) and Serving Cell 2 in the MCG and Serving Cell 7 in the SCG. Alternatively and/or additionally, the UE may release and/or deactivate Serving Cell 7 (e.g., release SCG) in response to the mobility procedure.

### Embodiment 5

In Embodiment 5, the second information may indicate one or more cells (e.g., a SCell and/or a SpCell) to change (e.g., add, change and/or remove).

In some examples, the second information may indicate (e.g., may include and/or may implicitly or explicitly indicate) cell information associated with one or more first cells. The one or more first cells may include (e.g., may be) one or more SCells. The one or more first cells may include (e.g., may be) one or more PSCells (e.g., one or more target PSCells). The one or more first cells may include (e.g., may be) one or more non-serving cells, one or more neighboring cells and/or one or more cells associated with one or more PCIs different from a PCell (e.g., the target cell or the source cell) of the UE.

In some examples, the first information may not indicate (and/or may not include) the cell information. The first information may not indicate Cells to be considered as Serving Cells for mobility procedures (e.g., the first information may not be indicative of a set of cells that the UE should consider to be Serving Cells for mobility procedures). Alternatively and/or additionally, the first information may indicate a Serving Cell configuration (e.g., ServingCellconfig) associated with cells including the one or more first cells. The first information may not indicate a CG associated with the one or more first cells.

Each cell, in the one or more first cells, may be associated with (e.g., may be assigned with) an index/identity. The index/identity may be provided (e.g., indicated) in the first information. The index/identity may be a candidate cell identity.

The second information may indicate one or more indexes/identities of the index/identity assigned by the first information to the UE, wherein the UE considers the one or more first cells associated with the one or more indexes/identities indicated in the second information to be one or more Serving Cells in response to (and/or when) (i) initiating or completing mobility procedure or (ii) reception of the second information. For example, the first information may be indicative of a plurality of indexes/identities, and the second information may indicate the one or more indexes/identities (of the plurality of indexes/identities) associated with the one or more first cells that the UE may consider to be one or more Serving Cells in response to (and/or when) (i) initiating or completing mobility procedure or (ii) reception of the second information. For example, the second information may comprise a bitmap. Each bit of the bitmap may indicate an index/identity provided (e.g., indicated) in the first information (e.g., each bit of the bitmap may map to an index/identity of the plurality of indexes/identities provided in the first information). For example, a first bit of the bitmap being set to ‘1’ may indicate that the UE may add and/or activate a cell associated with a first index/identity provided in the first information (in response to initiating or completing mobility procedure and/or receiving the second information, for example). The second bit of the bitmap being set to ‘0’ may indicate that the UE may not add and/or activate a cell associated with a second index/identity provided in the first information (in response to initiating or completing mobility procedure and/or receiving the second information, for example). In an example, the one or more first cells may be associated with (e.g., assigned with) one or more indexes/identities, of the plurality of indexes/identities, for which one or more bits in the bitmap are set to ‘1’.

Alternatively and/or additionally, ServCellIndex and/or SCellindex of the one or more first cells may be indicated (e.g., implicitly indicated) based on an order of the one or more first cells indicated in the second information (e.g., ServCellIndex and/or Scellindex of the one or more first cells may be based on an order in which indications of the one or more first cells are arranged in the second information).

The UE may determine whether to add, change, modify, switch, and/or release a cell (e.g., PCell, SCell or PSCell) or a cell group (e.g., SCG) in association with (e.g., when initiating, performing, or completing) the mobility procedure based on the cell information indicated (e.g., included) in the second information. In some examples, the UE may not determine whether to add, change, modify, switch, and/or release a SCell or a SCG in association with (e.g., when initiating, performing, or completing) the mobility procedure based on merely the first information.

The Cell information may indicate to the UE (e.g., instruct the UE) to add the one or more first cells (e.g., the one or more first cells may be one or more serving cells). The cell information may indicate to the UE (e.g., instruct the UE) to consider the one or more first cells to be Serving Cells (when initiating or completing the mobility procedure, for example). The cell information may indicate one or more PCIs (e.g., physCellId) associated with the one or more first cells to be added (e.g., added as Serving Cells or SCells). Alternatively and/or additionally, the cell information may indicate one or more cell indexes (e.g., ServCellIndex) associated with the one or more first cells to be added (e.g., added as Serving Cells or SCells). Alternatively and/or additionally, the cell information may indicate one or more cell indexes (e.g., sCellIndex) associated with the one or more first cells to be added (e.g., added as Serving Cell or SCell). A cell configuration of the one or more first cells (e.g., the cell configuration may comprise one or more parameters in sCellConfigCommon and/or sCellConfigDedicated) may be indicated in the first information.

Alternatively and/or additionally, the second information may indicate to the UE (e.g., instruct the UE) to remove/release/deactivate one or more second cells (e.g., the one or more second cells may be one or more serving cells). In the present disclosure, the term “remove/release/deactivate” may refer to remove, release and/or deactivate (e.g., removing, releasing and/or deactivating a cell). The second information may indicate one or more PCIs (e.g., physCellId) associated with the one or more second cells to be removed/released/deactivated. Alternatively and/or additionally, the second information may indicate one or more Serving Cell indexes (e.g., ServCellIndex) and/or one or more SCell indexes (e.g., SCellIndex) associated with the one or more second cells to be removed/released/deactivated. For example, the second information may comprise a bitmap. Each bit of the bitmap may indicate an index/identity provided (e.g., indicated) in the first information (e.g., each bit of the bitmap may map to an index/identity of a plurality of indexes/identities provided in the first information). For example, a first bit of the bitmap being set to ‘1’ may indicate that the UE may remove/release/deactivate a first cell associated with the first index/identity provided in the first information (in response to initiating or completing mobility procedure and/or receiving the second information, for example). The second bit of the bitmap being set to ‘0’ may indicate that the UE may not remove/release/deactivate a cell associated with a second index/identity provided in the first information (in response to initiating or completing mobility procedure and/or receiving the second information, for example). In an example, the one or more second cells may be associated with (e.g., assigned with) one or more indexes/identities, of the plurality of indexes/identities, for which one or more bits in the bitmap are set to ‘1’. Alternatively and/or additionally, the second information may indicate to the UE (e.g., instruct the UE) to remove/release/deactivate one, some and/or all Cells (e.g., all Serving Cells). Alternatively and/or additionally, the second information may indicate to the UE (e.g., instruct the UE) to remove/release/deactivate one, some and/or all cells of a CG (e.g., all Serving Cells of the CG). Alternatively and/or additionally, the UE may remove/release/deactivate one, some and/or all cells (e.g., all Serving Cells) in response to receiving the second information. Alternatively and/or additionally, the UE may remove/release/deactivate one, some and/or all cells of a CG (e.g., all Serving Cells of the CG) in response to receiving the second information. The second information may be indicative of a CG, wherein the UE may remove/release/deactivate one, some and/or all cells of the CG (e.g., all Serving Cells of the CG), wherein the one, some and/or all cells of the CG (e.g., the all Serving Cells of the CG) may be removed/released/deactivated by the UE (in response to receiving the second information, for example) based on the second information indicating the CG.

### Embodiment 6

In Embodiment 6, the second information may indicate addition and/or release of one or more cells.

The second information may indicate whether one or more cells (e.g., one or more cells, such as one or more Serving Cells, indicated by the second information) are to be added or to be removed/released/deactivated. For example, the second information may comprise a field (e.g., a bit field or a SCell state field) associated with the one or more cells. The UE may determine whether to add or to remove/release/deactivate the one or more cells based on the value of the field. For example, the second information may comprise a first bit field, associated with one or more first cells, with a value set to ‘1’. The UE may add the one or more first cells (e.g., add the one or more first cells as one or more SCells of the UE) in response to (i) receiving the second information and/or (ii) a mobility procedure associated with the second information (e.g., in response to completion or initiation of the mobility procedure). For example, the one or more first cells may be added based on the first bit field having the value set to ‘1’. The second information may comprise a second bit field, associated with a one or more second cells, with a value set to ‘0’. The UE may remove/release/deactivate the one or more second cells in response to (i) receiving the second information and/or (ii) a mobility procedure associated with the second information (e.g., in response to completion or initiation of the mobility procedure). For example, the one or more second cells may be removed/released/deactivated based on the second bit field having the value set to ‘0’.

Alternatively and/or additionally, the second information may indicate (e.g., implicitly indicate) whether to add or to remove/release/deactivate one or more cells. For example, the UE may be configured with a first set of SCells (before initiating a mobility procedure to a target cell, for example). The UE may receive the second information initiating a mobility procedure to a target cell (after being configured with the first set of SCells, for example). The second information may indicate a second set of SCells. The second set of SCells may be a subset of the first set of SCells. The UE may remove/release/deactivate the second set of SCells. For example, the UE may remove/release/deactivate the second set of SCells in response to (i) reception of the second information and/or (ii) the mobility procedure (e.g., in response to completion or initiation of the mobility procedure). Alternatively and/or additionally, the UE may remove/release/deactivate a third set of SCells (rather than removing/releasing/deactivating the second set of SCells, for example). For example, the UE may remove/release/deactivate the third set of SCells in response to (i) reception of the second information and/or (ii) the mobility procedure (e.g., in response to completion or initiation of the mobility procedure). The third set of SCells may comprise (e.g., may be) one or more cells that are in the first set of SCells and are not in the second set of SCells. Alternatively and/or additionally, the second information may indicate an index/identity associated with a Serving Cell (e.g., an existing and/or configured Serving Cell) of the UE (e.g., the index/identity associated with the Serving Cell may be indicated via a SCellindex).

### Embodiment 7

In Embodiment 7, the second information may indicate a CG.

In some examples, the cell information (in the second information, for example) may indicate whether to add one or more cells to a MCG or to a SCG. Alternatively and/or additionally, the cell information may indicate a first subset of one or more cells (e.g., one or more cells indicated by the second information) to be added in the MCG of the UE and a second subset of the one or more cells to be added in the SCG of the UE. For example, the cell information may comprise one or more bit fields, associated with the one or more cells, identifying a corresponding cell group of the one or more cells. For example, the cell information may comprise a bit field associated with one or more cells set to ‘0’, wherein the bit field being set to ‘0’ may indicate that the one or more cells may be added in (or removed/released/deactivated from) MCG of the UE. Alternatively and/or additionally, the bit field, in the cell information, associated with the one or more cells may be to ‘1’, wherein the bit field being set to ‘1’ may indicate that the one or more cells may be added in (or removed/released/deactivated from) SCG of the UE. Alternatively, the cell information may indicate (e.g., implicitly indicate) a CG, wherein the one or more cells may be added to the CG indicated (e.g., implicitly indicated) by the cell information or may be removed/released/deactivated from the CG indicated (e.g., implicitly indicated) by the cell information. For example, the cell information may indicate one or more indexes/identities (e.g., SCell identity or SCellIndex), wherein the one or more indexes/identities may be used (by the UE, for example) separately and/or differently in different CGs (e.g., the one or more indexes/identities may comprise (i) a first index/identity that may be used to identify a first CG and/or one or more cells of the first CG, (ii) a second index/identity that may be used to identify a second CG and/or one or more cells of the second CG, etc.). The UE may determine in which CG to add or remove/release/deactivate the one or more cells based on the index/identity indicated in the cell information.

### Embodiment 8

In Embodiment 8, the second information may indicate a cell type. In some examples, the cell information may indicate a cell type for each of the one or more cells. The cell type of a cell may be one of PCell, SCell, or PSCell. The UE may consider each of the one or more cells to be PCell, SCell, or PSCell based on the cell information in response to initiation or completion of mobility procedure. The UE may consider each of the one or more cells to be PCell, SCell, or PSCell based on the cell information in response to reception of the second information. For example, the UE may determine cell type of the one or more cells indicated in the cell information based on an order of the one or more cells indicated in the cell information. For example, a first cell (e.g., an initial cell) indicated in the cell information may be a PCell. A second cell (e.g., a cell following, such as directly following, the initial cell) indicated in the cell information may be an PSCell. A third cell (e.g., a cell following, such as directly following, the second cell) indicated in the cell information may be a SCell.

Alternatively and/or additionally, the cell information may indicate (e.g., comprise) a field indicating cell type associated with each of the one or more cells. For example, a 2-bit field in the cell information may be associated with a cell. The field may be set to ‘00’ indicating the cell type of the cell to be a PCell. The field may be set to ‘01’ indicating the cell type of the cell to be a PSCell. The field may be set to ‘10’ indicating the cell type of the cell to be a SCell.

Alternatively and/or additionally, the cell information may indicate to the UE (e.g., instruct the UE) to activate or deactivate the one or more Cells (e.g., one or more Serving Cells indicated by the second information, for example) (in response to initiation or completion of a mobility procedure, for example). The UE may determine whether to consider the one or more cells to be in activated state or in deactivated state (during or after completion of the mobility procedure, for example) based on the cell information. The cell information may indicate a SCell state field (e.g., a bit field) indicating whether to activate or deactivate a Cell (e.g., a Serving Cell of the one or more cells) when initiating or completing the mobility procedure. The cell information may indicate a SCell state field (e.g., a bit field) indicating an initial state (e.g., activated or deactivated) of the Cell (e.g., the Serving Cell). The cell information may indicate one or more Serving Cell indexes (e.g., ServCellIndex) or one or more SCell indexes (e.g., SCellIndex) associated with the one or more cells. The UE may activate or deactivate the one or more cells (e.g., the one or more Serving Cells) in response to completion or initiation of the mobility procedure. Alternatively and/or additionally, the UE may indicate (e.g., implicitly indicate) to the UE (e.g., implicitly instruct the UE) to activate or deactivate the one or more cells via the cell information. For example, the UE may determine whether to consider a SCell to be in activated state or in deactivated state during (or after completion) of a mobility procedure based on whether the SCell is indicated in the cell information (in the second information). The UE may consider the SCell to be in activated state if the SCell is indicated in the cell information (e.g., the cell information may be indicative of a SCell index of the SCell and/or the SCell may be included in a list in the cell information). The UE may consider the SCell to be in deactivated state (and/or may consider the SCell to be released) if the SCell is not indicated in the cell information.

### Embodiment 9

In Embodiment 9, the second information may indicate switching and/or changing a cell.

In some examples, the second information may indicate to the UE (e.g., instruct the UE) to change a Serving Cell. The second information may indicate to the UE (e.g., instruct the UE) to change a first serving cell (e.g., a SCell) to a second cell (e.g., a Serving Cell, non-serving cell or a neighboring cell) when initiating or completing a mobility procedure. The second information may indicate a first cell identity (e.g., ServCellindex, physCellId or SCellindex) and a second cell identity (e.g., ServCellindex, physCellId or SCellindex, and/or an index/identity indicated in the first information). The first cell identity may be associated with a Serving Cell (e.g., a SCell) associated with the UE, wherein the Serving Cell associated with the first cell identity may be an existing, configured and/or activated Serving Cell (e.g., the Serving Cell may be existing, configured and/or activated before initiating a mobility procedure). The second cell identity may be associated with a candidate Serving Cell/SCell (e.g., a neighboring cell or a configured serving cell of the UE before initiating a mobility procedure), wherein the candidate Serving Cell/SCell associated with the second cell identity may be deactivated (for the UE) before initiating the mobility procedure. In the present disclosure, the term “Serving Cell/SCell” may refer to a Serving Cell and/or a SCell. In response to receiving the second information, the UE may, based on the second information, remove/release/deactivate the Serving Cell associated with the first cell identity and add the candidate Serving Cell/SCell associated with the second cell identity (e.g., the UE may add the candidate Serving Cell/SCell as a Serving Cell/SCell). In response to initiation or completion of the mobility procedure (and/or in response to reception of the second information), the UE may apply SCellindex of the Serving Cell associated with the first cell identity to the cell associated with the second cell identity. Alternatively and/or additionally, the UE may apply ServCellindex of the Serving Cell associated with the first cell identity to the cell associated with the second cell identity in response to (i) initiation or completion of the mobility procedure and/or (ii) reception of the second information.

### Embodiment 10

In Embodiment 10, the first information may indicate one or more beams associated with a set of the one or more sets of cells (e.g., the one or more sets of cells may be indicated by the first information). In some examples, the first information may indicate one or more beams associated with a set of the one or more sets of cells. The set may comprise one or more cells and/or CGs. The first information may indicate (e.g., comprise) an association between beams and sets of cells and/or CGs. Each set of the one or more sets may be associated with (e.g., indicated with) one or more beams. For example, the first information may indicate at least one of (i) one or more first beams associated with a first set of the one or more sets, (ii) one or more second beams associated with a second set of the one or more sets, etc. One or more cells and/or one or more CGs in the same set may be associated with the same one or more beams. For example, each cell and/or CG in the first set may be associated with the one or more first beams, and/or each cell and/or CG in the second set may be associated with the one or more second beams. One or more beams (e.g., the one or more first beams, the one or more second beams, etc.) may be indicated via one or more reference signals and/or one or more Transmission Configuration Indicator (TCI) states. Each set of the one or more sets of cells and/or CGs may be associated with (e.g., may be indicated as being associated with) one or more reference signals. The one or more reference signals may be Synchronization Signal Block (SSB) or Channel State Information Reference Signal (CSI-RS). Each of the one or more reference signals may be associated with one or more TCI states (e.g., one or more Downlink (DL) or Uplink (UL) TCI states) and/or spatial relation info. The one or more beams may be used to monitor and/or receive DL transmission from a set of cells (of the one or more sets of cells) when (and/or after) activating and/or adding the set of cells and/or CGs in a mobility procedure or when (and/or after) receiving the second information. The UE may activate (and/or may generate) the one or more beams for one or more cells and/or one or more CGs in the set in response to adding and/or activating the one or more cells and/or the one or more CGs (e.g., the one or more cells and/or the one or more CGs in the set may be added and/or activated in response to and/or when (i) receiving the second information and/or (ii) initiating or completing a mobility procedure comprising adding and/or activating the one or more cells and/or the one or more CGs). Alternatively and/or additionally, the first information may indicate and/or configure one or more additional beams (other than the one or more beams associated with the set of cells), wherein the UE does not activate the one or more additional beams when adding and/or activating the set of cells and/or CGs (in response to the second information and/or the mobility procedure, for example).

For example, each set of the one or more sets of cells may be associated with (and/or indicated as being associated with) a TCI state (e.g., a DL or UL TCI state) in the first information (e.g., the TCI state may be indicated via TCI-StateId). For example, a first set of cells (of the one or more sets of cells) may be associated with (and/or indicated as being associated with) a first TCI state identity. In an example, the first information may be indicative of the first TCI state identity and/or may indicate that the first TCI state identity is associated with the first set of cells. In response to (and/or when) (i) initiating or completing a mobility procedure associated with adding and/or activating the first set of cells and/or (ii) receiving the second information associated with adding and/or activating the first set of cells, the UE may activate a beam (and/or a reference signal), associated with the first TCI state id, for monitoring DL signaling (and/or transmitting UL data) on one or more cells in the first set of cells. In some examples, the second information may not indicate a TCI state or reference signal associated with the first set of cells.

Alternatively and/or additionally, each set of the one or more sets of cells may be associated with (and/or indicated as being associated with) one or more spatial relation info (e.g., indicated via one or more spatial relation info IDs). For example, the first set of cells may be associated with (and/or indicated as being associated with) a first spatial relation info ID (e.g., the first spatial relation info ID may be indicated in the first information, such as where the first information indicates that the first spatial relation info ID is associated with the first set of cells). In response to (and/or when) (i) initiating or completing a mobility procedure associated with adding and/or activating the first set of cells and/or (ii) receiving the second information associated with adding and/or activating the first set of cells, the UE may activate a beam (and/or a reference signal), associated with the first spatial relation info ID, for UL transmission (e.g., Physical Uplink Control Channel (PUCCH) or Physical Uplink Shared Channel (PUSCH) transmissions) on one or more cells in the first set of cells. In some examples, the second information may not indicate the first spatial relation info ID associated with the first set of cells.

In some examples, the second information may not indicate TCI state or spatial relation info of the one or more sets.

### Embodiment 11

In Embodiment 11, one or more multiple Transmission and Reception Point (mTRP) beams may be indicated (e.g., the one or more mTRP beams may be indicated by the first information).

In some examples, each set of the one or more sets of cells may be indicated with multiple beams (e.g., mTRP beams). Each set of the one or more sets of cells may be indicated with a list of TCI states (e.g., a list of DL or UL TCI states) (e.g., the list of TCI states may be indicated in the first information, such as where the first information indicates that the list of TCI states is associated with a set of cells of the one or more sets of cells). The list of TCI states may indicate multiple TCI states (e.g., multiple DL or UL TCI states). Each of the multiple TCI states may be associated with multiple TRPs (e.g., different TRPs). The multiple TRPs may be associated with one or more cells in the set of cells and/or CGs. Alternatively and/or additionally, in addition to being associated with the one or more cells in the set of cells, the multiple TRPs may be associated with an additional cell with a PCI different from Cells in the set of cells and/or CGs. For example, the first set of cells (of the one or more sets of cells) may be associated with (and/or indicated as being associated with) multiple TCI states in a list of TCI states (e.g., the list of TCI states and/or the multiple TCI states may be indicated in the first information, such as where the first information indicates that the list of TCI states and/or the multiple TCI states are associated with the first set of cells). In response to (and/or when) (i) initiating or completing a mobility procedure associated with adding and/or activating the first set of cells and/or (ii) receiving the second information associated with adding and/or activating the first set of cells, the UE may activate multiple TCI states, in the list of TCI states, for the first set of cells, wherein the multiple TCI states and/or the list of TCI states are associated with the first set of cells.

### Embodiment 12

In Embodiment 12, the first information may indicate multiple beams, and the second information may activate a beam (e.g., one beam) of the multiple beams (e.g., the UE may activate the beam based on the second information).

In some examples, the first information may indicate a first set of beams associated with a set of cells in the one or more sets of cells. The second information may indicate a second set of beams associated with the set. In response to (and/or when) (i) initiating or completing a mobility procedure associated with adding and/or activating the set of cells and/or (ii) receiving the second information associated with adding and/or activating the set of cells and/or CGs, the UE may activate the second set of beams (indicated in the second information) for one or more cells and/or one or more CGs associated with the set of cells and/or CGs. The UE may not activate one or more beams, in the first set of beams, that are not in the second set of beams. The second set of beams may be a subset of the first set of beams. The second information may indicate the second set of beams via one or more indexes/identities (e.g., SSB-index or CSI-RS resource ID and/or TCI state identity). For example, each beam in the first set of beams may be associated with (e.g., assigned with) an index/identity. The second information may include the one or more indexes/identities of one or more beams in the first set of beams.

The second set of beams may comprise (and/or indicate) a single beam. For example, the second information may indicate a reference signal and/or a TCI state associated with the single beam. The UE may activate the single beam for Cells (e.g., all cells) in a set of cells when adding and/or activating the set of cells (e.g., adding and/or activating the set of cells in response to the second information and/or in response to a mobility procedure initiated by the second information).

Alternatively and/or additionally, the second set of beams may comprise (and/or indicate) multiple beams. Each of the multiple beams may be associated with different TRPs of a cell in the set of cells. The UE may activate multiple beams for receiving and/or monitoring different TRP of the cell in response to activating and/or adding the cell (e.g., adding and/or activating the cell in response to receiving the second information and/or in response to initiating or completing a mobility procedure).

### Embodiment 13

In Embodiment 13, the UE may activate different beams for different cells in a set.

In some examples, the first information may indicate different beams for different cells in a same set in the one or more sets of cells.

For example, the first information may indicate a first set of cells (of the one or more sets of cells). The first information may indicate a first beam (e.g., the first information may comprise SSB index, CSI-RS resource ID, and/or TCI state identity associated with and/or indicating the first beam) for a first cell in the first set of cells and a second beam for a second cell in the first set of cells. In response to (and/or when) (i) initiating or completing a mobility procedure associated with adding and/or activating the first set of cells and/or (ii) receiving the second information associated with adding and/or activating the first set of cells (which includes the first cell and the second cell), the UE may activate the first beam for the first cell (when activating the first cell, for example) and the UE may activate the second beam for the second cell (when activating the second cell, for example). The first beam and the second beam may be different beams.

### Embodiment 14

In Embodiment 14, a beam to use may be indicated (e.g., implicitly indicated) based on cell indication. The first information may indicate a cell (e.g., a reference cell) associated with a same beam update for a set of cells. The first information may indicate simultaneousTCI-UpdateList for a cell and/or a set of cells.

In some examples, the first information may indicate, for a first set in the one or more set of cells, a reference cell. The reference cell may be a SCell or a PCell of the UE (e.g., a current and/or existing SCell or PCell of the UE). The reference cell may be a serving cell (e.g., SCell or PCell) of the UE. The reference cell may be a non-serving cell (e.g., a cell with PCI different from any Serving Cells of the UE). In response to (and/or when) (i) initiating or completing a mobility procedure associated with adding and/or activating the first set of cells and/or (ii) receiving the second information associated with adding and/or activating the first set of cells, the UE may activate one or more beams and/or one or more TCI states for one or more cells in the first set of cells, wherein the one or more beams and/or the one or more TCI states are the same as (and/or are associated with) one or more beams of the reference cell (e.g., one or more activated/working/current beams of the reference cell) and/or one or more TCI states of the reference cell (e.g., one or more activated/working/current TCI states of the reference cell). In the present disclosure, the term “activated/working/current beam” may correspond to a beam that is activated, being used by the UE (e.g., the UE may communicate with a cell using the beam), and/or that is currently active. In the present disclosure, the term “activated/working/current TCI state” may correspond to a TCI state that is activated, being used by the UE (e.g., the UE may communicate with a cell using the TCI state), and/or that is currently active.

For example, the first information may indicate a first reference cell for a first set of cells. In response to (and/or when) (i) initiating or completing a mobility procedure associated with adding and/or activating the first set of cells and/or (ii) receiving the second information associated with adding and/or activating the first set of cells, the UE may activate one or more beams and/or one or more TCI states for one or more cells in the first set of cells, wherein the one or more beams and/or the one or more TCI states are the same as (and/or are associated with) one or more beams of the first reference cell (e.g., one or more activated/working/current beams of the first reference cell) and/or one or more TCI states of the first reference cell (e.g., one or more activated/working/current TCI states of the first reference cell). The one or more beams of the first reference cell (e.g., the one or more activated/working/current beams of the first reference cell) and/or the one or more TCI states of the first reference cell (e.g., the one or more activated/working/current TCI states of the first reference cell)may be activated (and/or may not be deactivated) before the UE receives the second information and/or before the mobility procedure is initiated. The one or more cells in the first set of cells may be updated concurrently (e.g., simultaneously), with the first reference cell, for spatial relation and/or TCI relation with a MAC CE (e.g., the MAC CE may comprise a TCI state activation MAC CE and/or a Spatial relation info activation MAC CE). The first set of cells may be associated with (e.g., indicated as being associated with) the same first reference cell. Alternatively and/or additionally, cells in the first set of cells may be associated with multiple reference cells.

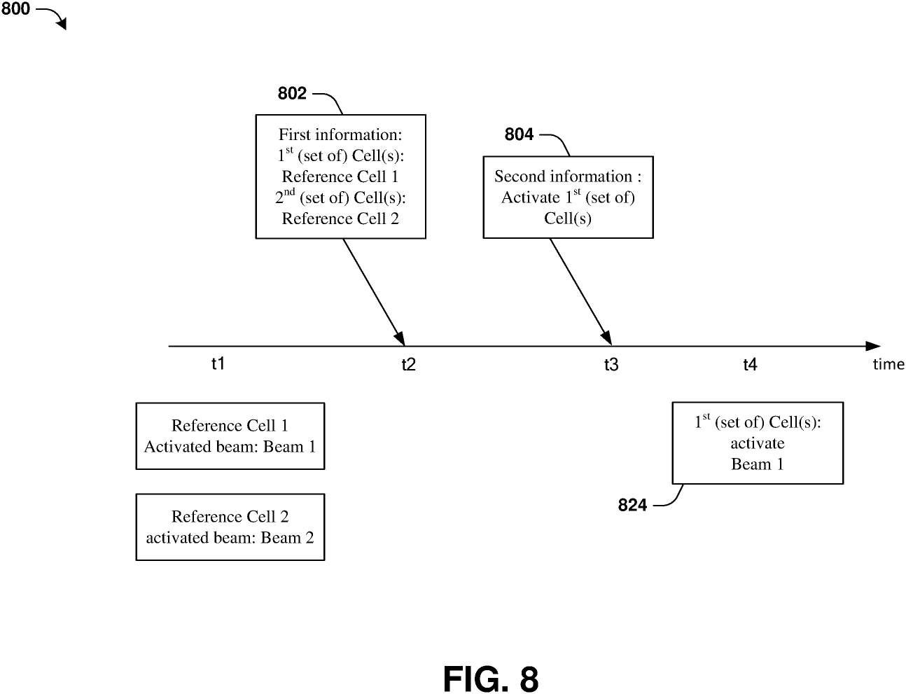

FIG. 8 illustrates a scenario 800 associated with a UE. At timing t1, the UE is configured with and/or performs communication with (i) a reference cell, Reference Cell 1 (e.g., an activated cell) with activated beam, Beam 1, and (ii) a reference cell, Reference Cell 2 (e.g., an activated cell) with activated beam, Beam 2. At timing t2, the UE receives a first information 802 (e.g., a RRC message from a gNB) indicating a cell configuration associated with a first set of cells (e.g., a first set of one or more cells) and a second set of cells (e.g., a second set of one or more cells). The first set of cells may comprise one or more candidate cells for PCell and/or SCells in MCG or SCG. The first set of cells is indicated as being associated with Reference Cell 1 (for beam activation, for example) and the second set of cells is indicated as being associated with Reference Cell 2 (for beam activation, for example). For example, the first information 802 may indicate that the first set of cells is associated with Reference Cell 1 (for beam activation, for example) and the second set of cells is associated with Reference Cell 2 (for beam activation, for example). At timing t3, the UE receives a second information 804 indicating adding and/or activating the first set of cells. In response to the second information 804, the UE adds and/or activates one or more cells in the first set of cells (e.g., the one or more cells may comprise one, some and/or all cells of the first set of cells). The UE activates one or more beams (e.g., at timing t4) for the first set of cells based on an activated beam (e.g., Beam 1) of Reference Cell 1 (e.g., the one or more beams may be activated in response to the second information 804). In an example, the one or more beams may comprise Beam 1 of Reference Cell 1. At timing t4 (after receiving the second information 804 and/or after mobility procedure initiated by the second information 804), the UE performs communication with the first set of cells via Beam 1. Reference Cell 1 and Reference Cell 2 may be current and/or existing cells of the UE (with respect to the second information 804 and/or with respect to adding and/or activating the first set of cells). In an example, Reference Cell 1 and Reference Cell 2 may be current and/or existing cells of the UE when the UE receives the second information 804 and/or adds and/or activates the first set of cells.

### Embodiment 15

In Embodiment 15, the UE may release one or more reference cells (e.g., the one or more reference cells may be released after activating one or more target cells, such as one or more cells of the first set of cells).

In some examples, the UE may remove/release/deactivate the one or more reference cells in response to (and/or when) adding and/or activating the first set of cells. The second information may not indicate to (e.g., may not instruct the UE to) activate the reference cell after the mobility procedure and/or when adding and/or activating the set of cells.

Alternatively and/or additionally, the UE may not remove/release/deactivate the one or more reference cells in response to and/or when adding and/or activating the first set of cells.

Alternatively and/or additionally, the first information may indicate an update list (e.g., simultaneousTCI-UpdateList1 or simultaneousTCI-UpdateList2) for a set of cells in the one or more set of cells. The update list may comprise one, some and/or all cells in the set of cells. Alternatively and/or additionally, the update list may be indicated via a parameter and/or a bit value indicating which update list the set of cells belong to. In response to receiving the second information associated with (e.g., indicative of) adding and/or activating the set of cells, the UE may activate one or more beams/TCI states for one, some and/or all Cells in the set of cells. In the present disclosure, the term “beam/TCI state” may correspond to a beam and/or a TCI state. The one or more beams/TCI states may comprise one or more activated/working/current beams of one or more current cells associated with the update list. For example, the first information may indicate a first update list (e.g., via a parameter and/or a flag) for the first set of cells. In response to (and/or when) (i) initiating or completing a mobility procedure associated with adding and/or activating the first set of cells and/or (ii) receiving the second information associated with adding and/or activating the first set of cells, the UE may activate one or more beams/TCI states for one, some and/or all Cells in the first set of cells. The update list may be associated with the one, some and/or all Cells in the first set of cells. The one or more beams/TCI states may be one or more activated/working/current beams/TCI states of one or more second cells associated with the first update list. The one or more activated/working/current beams/TCI states of the one or more second cells may be activated (and may not be deactivated) before the UE receives the second information and/or before initiating the mobility procedure. The one or more second cells may be one or more current and/or existing cells of the UE. The one, some and/or all cells in the first set of cells may be updated concurrently (e.g., simultaneously), with cells associated with the update list, for spatial relation and/or TCI relation with a MAC CE (e.g., a TCI state activation MAC CE and/or a Spatial relation info activation MAC CE).

### Embodiment 16

In Embodiment 16, the UE may activate one or more beams using a cell that is not released from the list after adding the target cells.

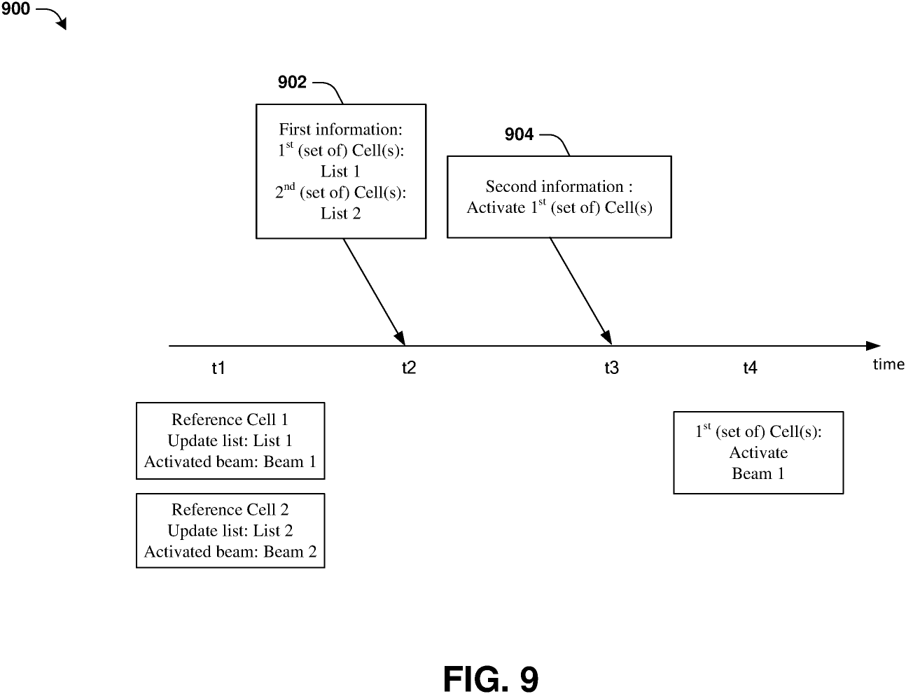

FIG. 9 illustrates a scenario 900 associated with a UE. At timing t1, the UE is configured with and/or performs communication with (i) a reference cell, Reference Cell 1 (e.g., an activated cell) with activated beam, Beam 1, wherein Reference Cell 1 is associated with (e.g., configured with) an update list, List 1, and (ii) a reference cell, Reference Cell 2 (e.g., an activated cell) with activated beam, Beam 2, wherein Reference Cell 2 is associated with (e.g., configured with) an update list, List 2. At timing t2, the UE receives a first information 902 (e.g., a RRC message from a gNB) indicating a cell configuration associated with a first set of cells (e.g., a first set of one or more cells) and a second set of cells (e.g., a second set of one or more cells). The first set of cells may comprise one or more candidate cells for PCell and/or SCells in MCG or SCG. The first set of cells is indicated as being associated with List 1 (for beam activation, for example) and the second set of cells is indicated as being associated with List 2 (for beam activation, for example). For example, the first information 902 may indicate that the first set of cells is associated with List 1 (for beam activation, for example) and the second set of cells is associated with List 2 (for beam activation, for example). At timing t3, the UE receives a second information 904 indicating adding and/or activating the first set of cells. In response to the second information 904, the UE adds and/or activates one or more cells in the first set of cells (e.g., the one or more cells may comprise one, some and/or all cells of the first set of cells). The UE activates one or more beams (e.g., at timing t4) for the first set of cells based on an activated beam (e.g., Beam 1 of Reference Cell 1) of a current cell (e.g., Reference Cell 1) associated with List 1 (e.g., the one or more beams may be activated in response to the second information 904). In an example, the one or more beams may comprise Beam 1 of Reference Cell 1. At timing t4 (after receiving the second information 904 and/or after mobility procedure initiated by the second information 904), the UE performs communication with the first set of cells via Beam 1. In response to (and/or after) receiving the second information 904, the UE may deactivate and/or release Reference Cell 1. Alternatively and/or additionally, in response to (and/or after) receiving the second information 904, the UE may keep Reference Cell 1 activated. In response to (and/or after) receiving the second information 904, the UE may consider the first set of cells to be in List 1 and/or the UE may be indicated (e.g., informed) that the first set of cells is in List 1.

### Embodiment 17

In Embodiment 17, there may be different update lists for UL and DL.

In some examples, the first information may indicate a first update list (e.g., simultaneousTCI-UpdateList1 or simultaneousTCI-UpdateList2), for the first set of cells, indicating a DL beam activation for one or more cells in the first set of cells. The first information may indicate a second update list (e.g., simultaneousSpatial-UpdatedListlor simultaneousSpatial-UpdatedList2), for the first set of cells, indicating UL beam activation. The first update list and the second update list may be indicated via different indexes/identities (in the first information, for example).

### Embodiment 18

In Embodiment 18, the UE may deactivate a current beam for a current CG/Cell. In the present disclosure, the term “CG/Cell” may correspond to a CG and/or a cell. Alternatively and/or additionally, the UE may update a same beam for a current CG/Cell that shares the same update list with an added cell.

In some examples, the UE may deactivate an activated beam/TCI state of a first cell in response to receiving the second information and/or in response to initiating or completing a mobility procedure adding and/or activating a second cell. The first cell may be the same cell as the second cell. The first cell may be a different cell from the second cell. In some examples, the first cell may not be indicated in the second information. Alternatively and/or additionally, the UE may deactivate the first cell in response to receiving the second information and/or in response to initiating or completing the mobility procedure adding and/or activating the second cell. Alternatively and/or additionally, the UE may activate a new beam/TCI state (e.g., different than the current beam/TCI state) for the first cell in response to receiving the second information and/or in response to initiating or completing the mobility procedure adding and/or activating the second cell. In some examples, the new beam may be associated with the second cell (in addition to being associated with the first cell, for example). The first cell and the second cell may be associated with a same TCI state update list (e.g., simultaneousTCI-UpdateList1 or simultaneousTCI-UpdateList2).

The first cell may be a PCell or a SCell (e.g., a current and/or existing SCell). The UE may activate the first cell before receiving the first information, before receiving the second information and/or before initiating the mobility procedure adding and/or activating the second cell. The UE may switch one or more beams of the first cell in response to receiving the second information. Alternatively and/or additionally, the second information may indicate one or more beams to which the first cell switches (e.g., the UE may switch from using one or more previous beams to communicate with the first cell to using the one or more beams indicated by the second information to communicate with the first cell). Alternatively and/or additionally, the second information may indicate a third cell, wherein the UE may switch one or more activated beams of the first cell to a beam that is the same as an activated beam of the third cell (e.g., the UE may switch to using the activated beam of the third cell to communicate with the first cell based on the indication of the third cell in the second information).

### Embodiment 19

In Embodiment 19, the first information does not indicate a beam for the one or more sets of cells.

In some examples, the first information may not indicate one or more beams/TCI states (to be activated when receiving the second information and/or when initiating and/or completing a mobility procedure adding and/or activating the set of cells) for the one or more sets of cells. The first information may comprise cell indexes/identities for the one or more sets of cells. The second information may indicate one or more beams/TCI states for at least a first set of cells in the one or more sets of cells. The second information may indicate to the UE (e.g., instruct the UE) to activate and/or add the first set of Cells. The second information may indicate one or more indexes/identities of the first set of cells.

For example, the second information may indicate one or more beams (e.g., a beam, SSB and/or CSI-RS) and/or one or more TCI states associated with the first set of cells. In response to receiving the second information associated with adding and/or activating the first set of cells, the UE may activate and/or add the one or more beams for the first set of cells. Alternatively and/or additionally, in response to initiating or completing a mobility procedure adding and/or activating cells in the first set of cells, the UE may activate and/or add the one or more beams for the first set of cells. The UE may activate and/or use the one or more beams (and/or the one or more TCI states) for one or more cells in the first set of cells. The UE may not activate one or more beams, associated with the first set of cells, that are not indicated in the second information (e.g., the UE may not activate one or more beams that are indicated in the first information but not indicated in the second information) when adding and/or activating the first set of cells (e.g., adding and/or activating the first set of cells in response to receiving the second information).

Alternatively and/or additionally, the second information may indicate a reference cell (e.g., via a serving cell index) for the first set of cells. The first information may not indicate one or more reference cells for the first set of cells. In response to receiving the second information, the UE may activate and/or add one or more cells in the first set of cells. Alternatively and/or additionally, in response to initiating or completing a mobility procedure associated with adding and/or activating cells in the first set of cells, the UE may activate and/or add one or more cells in the first set of cells. In response to receiving the second information and/or in response to initiating or completing a mobility procedure adding and/or activating cells in the first set of cells, the UE may activate and/or use a same set of one or more beams/TCI states that are activated and/or used in the reference cell for the one or more cells in the first set of cells. The reference cell may be a SCell (e.g., a current and/or existing SCell) or a PCell (e.g., a current and/or existing PCell) of the UE.

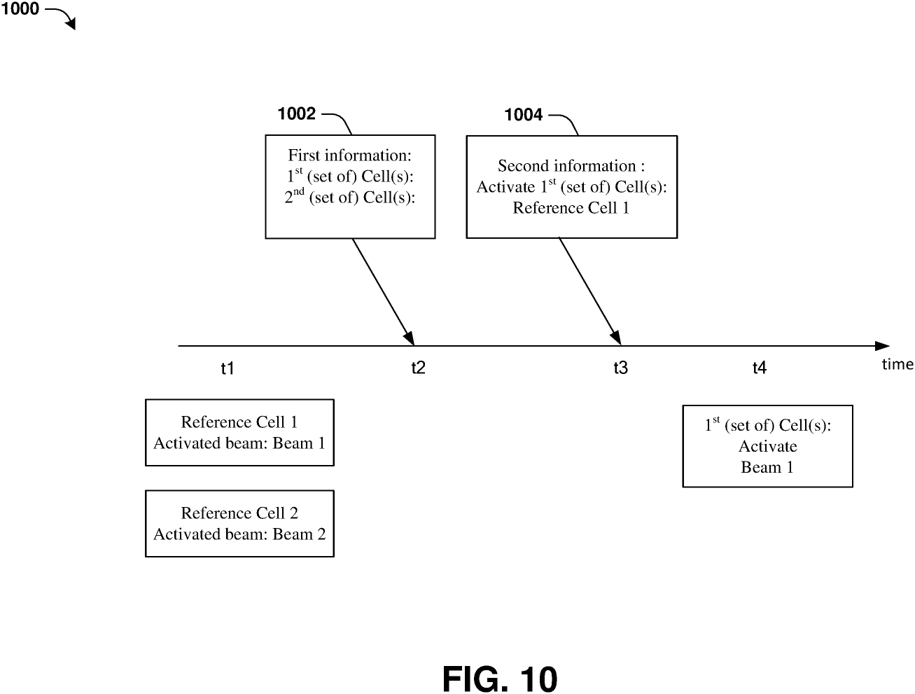

FIG. 10 illustrates a scenario 1000 associated with a UE. At timing t1, the UE is configured with and/or performs communication with (i) a reference cell, Reference Cell 1 (e.g., an activated cell) with activated beam, Beam 1, and (ii) a reference cell, Reference Cell 2 (e.g., an activated cell) with activated beam, Beam 2. At timing t2, the UE receives a first information 1002 (e.g., a RRC message from a gNB) indicating a cell configuration associated with a first set of cells (e.g., a first set of one or more cells) and a second set of cells (e.g., a second set of one or more cells). The first set of cells may comprise one or more candidate cells for PCell and/or SCells in MCG or SCG. At timing t3, the UE receives a second information 1004 indicating adding and/or activating the first set of cells. The first set of cells is indicated as being associated with Reference Cell 1 (for beam activation, for example) in the second information 1004. For example, the second information 1004 may indicate that the first set of cells is associated with Reference Cell 1 (for beam activation, for example). In response to the second information 1004, the UE adds and/or activates one or more cells in the first set of cells (e.g., the one or more cells may comprise one, some and/or all cells of the first set of cells). The UE activates one or more beams for the first set of cells (e.g., at timing t4) based on an activated beam (e.g., Beam 1) of Reference Cell 1 (e.g., the one or more beams may be activated in response to the second information 1004). In an example, the one or more beams may comprise Beam 1 of Reference Cell 1. At timing t4 (after receiving the second information 1004 and/or after mobility procedure initiated by the second information 1004), the UE performs communication with the first set of cells via Beam 1. In response to (and/or after) receiving the second information 1004, the UE may deactivate and/or release Reference Cell 1. Alternatively and/or additionally, in response to (and/or after) receiving the second information 1004, the UE may keep Reference Cell 1 activated. Reference Cell 1 and Reference Cell 2 may be current and/or existing cells of the UE (with respect to the second information 1004 and/or with respect to adding and/or activating the first set of cells). In an example, Reference Cell 1 and Reference Cell 2 may be current and/or existing cells of the UE when the UE receives the second information 1004 and/or adds and/or activates the first set of cells.

Alternatively and/or additionally, the second information may indicate an update list (e.g., simultaneousTCI-UpdateList1 or simultaneousTCI-UpdateList2) associated with the first set of cells (e.g., the update list may be indicated via a bit field or a flag). The first information may not indicate one or more update lists for the first set of cells. The update list (indicated by the second information) may indicate (e.g., may comprise) one, some and/or all cells of the first set of cells. The update list may be indicated via a bit field and/or a flag in the second information. In response to receiving the second information and/or or in response to initiating or completing the mobility procedure adding and/or activating cells in the first set of cells, the UE may activate and/or use one or more beams/TCI states for one, some and/or all cells of the first set of cells. The one or more beams/TCI states may be same as and/or associated with one or more beams/TCI states that are activated and/or used, in one or more cells (e.g., current and/or existing cells) associated with the update , before receiving the second information and/or initiating the mobility procedure. The one or more cells (e.g., current and/or existing cells) may be in the update list (e.g., included in the update list) before receiving the second information and/or before initiating the mobility procedure. The one or more cells (e.g., current and/or existing cells) may be in the update list (e.g., included in the update list) after receiving the second information and/or after the mobility procedure. Alternatively and/or additionally, the one or more cells (e.g., current and/or existing cells) may be removed/released/deactivated from the update list after receiving the second information and/or after the mobility procedure. The cells in the first set of cells may be included (and/or configured) in the update list in response to receiving the second information.

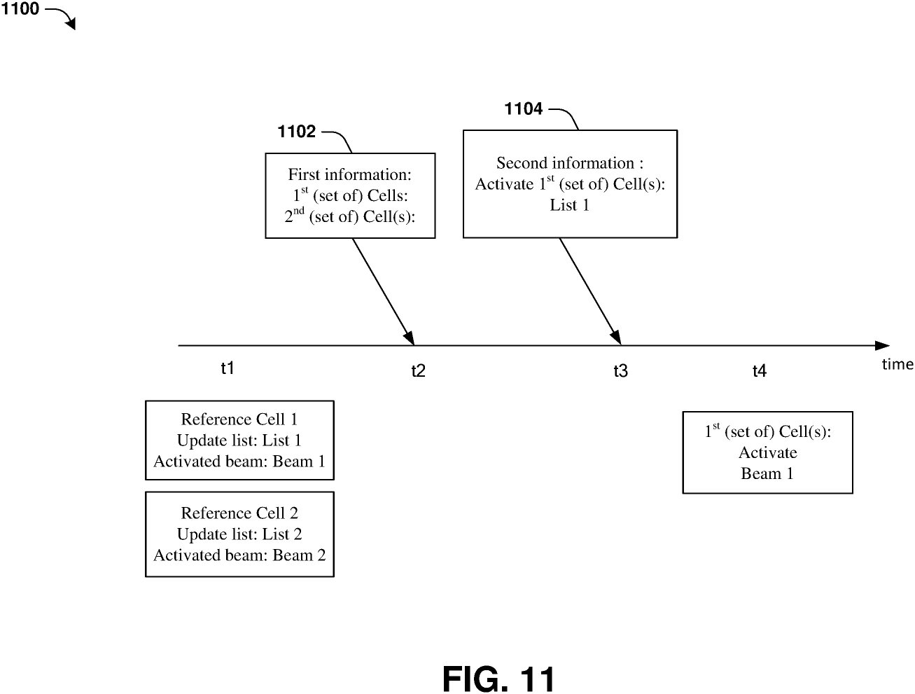

FIG. 11 illustrates a scenario 1100 associated with a UE. At timing t1, the UE is configured with and/or performs communication with (i) a reference cell, Reference Cell 1 (e.g., an activated cell) with activated beam, Beam 1, wherein Reference Cell 1 is associated with (e.g., configured with) an update list, List 1, and (ii) a reference cell, Reference Cell 2 (e.g., an activated cell) with activated beam, Beam 2, wherein Reference Cell 2 is associated with (e.g., configured with) an update list, List 2. At timing t2, the UE receives a first information 1102 (e.g., a RRC message from a gNB) indicating cell configuration associated with a first set of cells (e.g., a first set of one or more cells) and a second set of cells (e.g., a second set of one or more cells). The first set of cells may comprise one or more candidate cells for PCell and/or SCells in MCG or SCG. At timing t3, the UE receives a second information 1104 indicating adding and/or activating the first set of cells. The first set of cells is indicated as being associated with List 1 (for beam activation, for example) in the second information 1104. For example, the second information 1104 may indicate that the first set of cells is associated with Reference Cell 1 (for beam activation, for example). In response to the second information 1104, the UE adds and/or activates one or more cells in the first set of cells (e.g., the one or more cells may comprise one, some and/or all cells of the first set of cells). The UE activates one or more beams (e.g., at timing t4) for the first set of cells based on an activated beam (e.g., Beam 1 of Reference Cell 1) of a current cell (e.g., Reference Cell 1) associated with List 1 (e.g., Beam 1 of Reference Cell 1) (e.g., the one or more beams may be activated in response to the second information 1104). In an example, the one or more beams may comprise Beam 1 of Reference Cell 1. At timing t4 (after receiving the second information 1104 and/or after mobility procedure initiated by the second information 1104), the UE performs communication with the first set of cells via Beam 1. In response to (and/or after) receiving the second information 1104, the UE may deactivate and/or release Reference Cell 1. Alternatively and/or additionally, in response to (and/or after) receiving the second information 1104, the UE may keep Reference Cell 1 activated. In response to (and/or after) receiving the second information 1104, the UE may consider the first set of cells to be in List 1 and/or may be indicated (e.g., informed) that the first set of cells is in List 1.

### Embodiment 20

In Embodiment 20, there may be different update lists for UL and DL.

In some examples, the second information may indicate a first update list (e.g., simultaneousTCI-UpdateList1 or simultaneousTCI-UpdateList2), for the first set of cells, indicating DL beam activation for one or more cells in the first set of cells. The second information may indicate a second update list (e.g., simultaneousSpatial-UpdatedList1 or simultaneousSpatial-UpdatedList2), for the first set of cells, indicating UL beam activation (for one or more cells in the first set of cells, for example). The first update list and the second update list may be indicated via different indexes/identities (in the second information, for example).

### Embodiment 21

In Embodiment 21, a beam of a current cell may be changed and/or reused based on an indication in the second information.

In some examples, the second information may indicate whether or not the UE activates a new beam (and deactivates a current beam, for example) for a cell (e.g., a current and/or existing cell) in response to receiving the second information. The current and/or existing cell may be a SCell or a PCell of the UE.

The UE may determine whether to reuse a current beam for a current and/or existing cell based on the second information. For example, the UE may reuse one or more current beams for a current cell (e.g., PCell or SCell) if the second information does not indicate (e.g., may comprise) the current cell. Alternatively or additionally, the UE may change the one or more current beams to one or more new beams for the current cell (and/or activate a new beam for the current cell) if (and/or when) the second information indicates the current cell (e.g., via a cell index/identity). The second information may indicate a reference cell and/or an update list associated with the current cell. For example, the second information may indicate the current cell by indicating the reference cell and/or the update list associated with the current cell. The second information may indicate one or more beams (e.g., one or more new beams) associated with the current cell. Alternatively and/or additionally, the UE may remove/release/deactivate the current cell if (and/or when) the second information does not indicate the current cell.

### Embodiment 22

In Embodiment 22, if beam information is not provided to the UE, the UE may use one or more beams of a current PCell and/or a current PSCell for one or more added SCells (e.g., one or more SCells added and/or activated by the UE in response to the second information).

In some examples, the second information (associated with adding and/or activating a set of cells, for example) may not provide beam information for the set of cells (when adding and/or activating the set of cells, for example)). In response to (and/or when) receiving the second information associated with adding and/or activating a first set of cells, wherein the second information does not indicate beam information associated with the first set of cells, the UE may activate and/or use one or more beams (e.g., one or more UL and/or DL beams), associated with a PCell (e.g., a current PCell) and/or a PSCell (e.g., a current PSCell) of the UE, on the first set of cells.

The beam information may comprise one or more TCI state identities.

The beam information may comprise spatial relation information.

The beam information may comprise a reference signal index (e.g., SSB and/or CSI-RS).

The beam information may comprise cell index of a reference cell.

The beam information may comprise an indication of an update list.

### Embodiment 23

In Embodiment 23, the first information may indicate per-Cell information.

In some examples, the first information may indicate one or more cells (for SCell change or for PCell change, for example). The first information may indicate a Serving Cell configuration (e.g., ServingCellConfig) associated with one or more cells. The one or more cells may comprise one or more serving cells of the UE. The one or more cells may comprise one or more non-serving cells of the UE and/or one or more neighboring cells of the UE.

The first information may provide (e.g., indicate) one or more indexes/identities associated with the one or more cells. Each of the one or more cells may be associated with an index/identity of the one or more indexes/identities provided (e.g., indicated) in the first information. The second information may indicate one or more indicated cells of the one or more cells. For example, the second information may indicate one or more first indexes/identities (of the one or more indexes/identities provided by the first information, for example) associated with the one or more indicated cells. The UE may consider the one or more indicated cells to be one or more Serving Cells (e.g. one or more activated Serving Cells) in response to (and/or when) receiving the second information and/or in response to initiating or completing a mobility procedure adding and/or activating the one or more indicated cells. The mobility procedure may be initiated in response to the second information.

### Embodiment 24

In Embodiment 24, the first information may indicate beam information for one or more cells. The second information may indicate a subset of beams that are indicated by the first information.

The first information may be indicative of one or more cells and/or beams associated with the one or more cells. The beams indicated by the first information may comprise one or more beams for each of the one or more cells. In response to (and/or when) (i) initiating or completing a mobility procedure associated with adding and/or activating the one or more cells and/or (ii) receiving the second information associated with adding and/or activating the one or more cells, the UE may activate a beam (and/or reference signal) associated with an indicated spatial relation info ID for UL transmission (e.g., PUCCH and/or PUSCH transmissions) on the set of cells in the one or more cells. The indicated spatial relation info ID may correspond to a spatial relation info ID that is indicated by the first information. In some examples, the second information may not indicate one or more beams/TCI states for the one or more cells. The first information and/or the second information may indicate a CG associated with each cell of the one or more cells. The UE may activate (and/or be indicated with) the one or more beams for the one or more cells in response to adding and/or activating the one or more cells (in response to and/or when (i) receiving a second information and/or (ii) initiating or completing a mobility procedure adding and/or activating the one or more cells). Alternatively and/or additionally, the first information may indicate and/or configure one or more additional beams other than the one or more beams associated with the one or more cells, wherein the UE does not activate the one or more additional beams when adding and/or activating the one or more cells (in response to the second information and/or the mobility procedure, for example).

For example, the first information may indicate one or more cells, and may indicate one or more beams/TCI states for the one or more cells (e.g., one or more beams/TCI states may be indicated for each of the one or more cells indicated by the first information). In response to (and/or when) (i) receiving the second information (indicating adding and/or activating a first cell of the one or more cells indicated by the first information, for example) and/or (ii) initiating or completing a mobility procedure adding and/or activating the first cell, the UE may activate and/or use one or more first beams/TCI states associated with the first cell (e.g., the first cell indicated in the first information). The second information may not indicate one or more beams/TCI states for the first cell (e.g., the second information may not indicate the one or more first beams/TCI states).

Alternatively and/or additionally, the UE may receive a second information indicating adding and/or activating the first cell and a second cell. The UE may activate and/or use the one or more first beams/TCI states associated with the first cell and activate and/or use one or more second beams/TCI states associated with the second cell.

Alternatively and/or additionally, the second information may indicate a subset of beams/TCI states for each cell in one or more first cells. The second information may indicate adding and/or activating the one or more first cell. The one or more cells, indicated by the first information, may comprise the one or more first cells. The subset of beams/TCI states may comprise a subset of beams/TCI states indicated in the first information for each of the one or more first cells. In response to receiving the second information and/or in response to initiating or completing a mobility procedure adding and/or activating the one or more first cells, the UE may activate and/or use the subset of beams/TCI states for each of the one or more first cells. The second information may indicate one or more indexes/identities associated with the one or more first cells. The UE may not activate and/or use one or more beams/TCI states , indicated in the first information, that are associated with a cell that is not indicated in the second information (e.g., the UE may not activate and/or use the one or more beams/TCI states in response to and/or when adding and/or activating the cell in response to the second information). In some examples, before receiving the second information, the UE may not activate and/or use one or more beams/TCI states, indicated in the first information, for a cell. The UE may determine, based on the subset of beams/TCI states for a cell (e.g., the second information may be indicative of the subset of beams/TCI states and/or the cell), one or more beams/TCI states to activate and/or use for (and/or when) adding and/or activating the cell (e.g., the UE may determine which beams/TCI states to activate and/or use for the cell based on the subset of beams/TCI states, for the cell, indicated by the second information).

Alternatively and/or additionally, beams/TCI states associated with a cell (indicated in the first information and/or the second information, for example) may be associated with different TRPs of the cell. For example, the first information may indicate a first beam for a first TRP of a first cell in the one or more cells and a second beam for a second TRP of the first cell. In response to (and/or when) (i) initiating or completing a mobility procedure associated with adding and/or activating the first cell (and/or one or more other cells and/or CGs) and/or (ii) receiving the second information associated with adding and/or activating the first cell (and/or the one or more other cells and/or CGs), the UE may activate and/or use the first beam on the first TRP of the first cell and activate and/or use the second beam on the second TRP of the first cell. The first beam and the second beam may be indicated by the second information. An association between beams and TRPs of a cell may be indicated in the first information and/or the second information.

### Embodiment 25

In Embodiment 25, the first information indicates a reference cell.

In some examples, the first information may be indicative of one or more cells and/or one or more reference cells associated with the one or more cells. The one or more reference cells indicated by the first information may comprise a reference cell for each of the one or more cells. The reference cell may be a serving cell (e.g., SCell or PCell) of the UE. The reference cell may be a SCell (e.g., a current and/or existing SCell) or a PCell (e.g., a current and/or existing PCell) of the UE. The reference cell may be a non-serving cell (e.g., a cell with PCI different from any Serving Cells of the UE). For example, the first information may indicate a first reference cell for a first cell in the one or more cells. In response to (and/or when) (i) initiating or completing a mobility procedure associated with adding and/or activating the first cell and/or (ii) receiving the second information associated with adding and/or activating the first cell, the UE may activate one or more beams/TCI states for the first cell, wherein the one or more beams/TCI states are the same as and/or are associated with one or more activated beams/TCI states of the first reference cell. The first cell may be updated concurrently (e.g., simultaneously), with the first reference cell, for spatial relation and/or TCI relation with a MAC CE (e.g., a TCI state activation MAC CE and/or a Spatial relation info activation MAC CE). In response to (and/or when) (i) initiating or completing a mobility procedure associated with adding and/or activating the one or more cells and/or (ii) receiving the second information associated with adding and/or activating the one or more cells, the UE may activate one or more beams/TCI states for one, some and/or all cells in the one or more cells, wherein the one or more beams/TCI states are the same as (and/or are associated with) one or more beams/TCI states of the reference cell (e.g., one or more activated/working/current beams/TCI states of the reference cell).

Alternatively and/or additionally, the first information may indicate a second reference cell for a second cell in the one or more cells. In response to (and/or when) (i) initiating or completing a mobility procedure associated with adding and/or activating the first cell and the second cell and/or (ii) receiving the second information associated with adding and/or activating the first cell and the second cell, the UE may: (A) activate one or more first beams/TCI states for the first cell, wherein the one or more first beams/TCI states are the same as and/or are associated with one or more activated beams/TCI states of the first reference cell, and/or (B) activate one or more second beams/TCI states for the second cell, wherein the one or more second beams/TCI states are the same as and/or are associated with one or more activated beams/TCI states of the second reference cell. The first cell may be updated concurrently (e.g., simultaneously), with the first reference cell, for spatial relation and/or TCI relation with a MAC CE (e.g., a TCI state activation MAC CE and/or a Spatial relation info activation MAC CE). The second cell may be updated concurrently (e.g., simultaneously), with the second reference cell, for spatial relation and/or TCI relation with a MAC CE (e.g., a TCI state activation MAC CE and/or a Spatial relation info activation MAC CE).

### Embodiment 26

In Embodiment 26, the first information indicates an update list.

In some examples, the first information may indicate an update list (e.g., simultaneousTCI-UpdateList1 or simultaneousTCI-UpdateList2) for one or more cells, such as one or more cells indicated by the first information (e.g., the update list may be included in a RRC parameter). The first information may be indicative of one or more update lists comprising an update list (e.g., simultaneousTCI-UpdateList1 or simultaneousTCI-UpdateList2) for each cell of the one or more cells.

For example, the first information may indicate a first update list for a first cell in the one or more cells. In response to (and/or when) (i) initiating or completing a mobility procedure associated with adding and/or activating the first cell and/or (ii) receiving the second information associated with adding and/or activating the first cell, the UE may activate one or more beams/TCI states for the first cell, wherein the one or more beams/TCI states are the same as and/or are associated with one or more activated/working beams/TCI states of one or more cells associated with the first update list. The first cell may be updated concurrently (e.g., simultaneously), with the one or more cells associated with the first update list, for spatial relation and/or TCI relation with a MAC CE (e.g., a TCI state activation MAC CE and/or a Spatial relation info activation MAC CE).

Alternatively and/or additionally, the first information may indicate a second update list for a second cell (e.g., a second cell of one or more cells indicated by the first information). In response to (and/or when) (i) initiating or completing a mobility procedure associated with adding and/or activating the first cell and the second cell and/or (ii) receiving the second information associated with adding and/or activating the first cell and the second cell, the UE may: (A) activate one or more first beams/TCI states for the first cell, wherein the one or more first beams/TCI states are the same as and/or are associated with one or more activated/working beams/TCI states) of one or more cells associated with the first update list, and/or (B) activate one or more second beams/TCI states for the second cell, wherein the one or more second beams/TCI states are the same as and/or associated with one or more activated/working beams/TCI states of one or more cells associated with the second update list. The first cell may be updated concurrently (e.g., simultaneously), with the one or more cells associated with the first update list, for spatial relation and/or TCI relation with a MAC CE (e.g., a TCI state activation MAC CE and/or a Spatial relation info activation MAC CE). The second cell may be updated concurrently (e.g., simultaneously), with the one or more cells associated with the second update list, for spatial relation and/or TCI relation with a MAC CE (e.g., a TCI state activation MAC CE and/or a Spatial relation info activation MAC CE).

### Embodiment 27

In Embodiment 27, the first information does not indicate beams, and/or the second information indicates per-cell beam information.

In some examples, the first information may not indicate (e.g., may not comprise) one or more beams/TCI states (e.g., any beam/TCI state) associated with one or more cells (e.g., one or more cells indicated by the first information). In an example, the first information may not indicate (e.g., may not comprise) one or more beams/TCI states to be activated in response to (and/or when) activating the one or more cells (e.g., the one or more cells may be activated in response to and/or when receiving the second information).

The second information may indicate (e.g., may comprise) one or more beams associated with at least one cell of the one or more cells. The second information may comprise (and/or the one or more beams may be indicated via) one or more SSB indexes, one or more CSI-RS resource identities, one or more TCI state identities, one or more spatial relation info IDs, and/or one or more reference signal indexes. The UE may activate and/or add the at least one cell in response to (and/or when) (i) receiving the second information and/or (ii) initiating a mobility procedure adding and/or activating the at least one cell. The mobility procedure may be triggered and/or initiated by the second information. The second information may indicate, to the UE (e.g., instruct the UE), to activate and/or add the at least one cell. The second information may indicate a serving cell index and/or a cell identity (e.g., PCI) associated with the at least one cell. The UE may not activate or add cells in the one or more cells (e.g., cells indicated by the first information) that are not indicated in the second information. In response to adding and/or activating the at least one cell, the UE may activate and/or use the one or more beams associated with the at least one cell (indicated in the second information). In some examples, the one or more beams may be associated with different TRPs (e.g., where each beam of the one or more beams is associated with a TRP of the different TRPs). The UE may activate different beams in the one or more beams for monitoring different TRPs in the at least one cell in response to receiving the second information.

### Embodiment 28

In Embodiment 28, the second information indicates a reference cell.

In some examples, the second information may indicate a reference cell for the at least one cell (e.g., the second information may indicate a reference cell for each cell of the at least one cell). The reference cell (indicated by the second information for the at least one cell) may be a SCell or a PCell of the UE (e.g., a current and/or existing SCell or PCell of the UE). The first information may not indicate reference cells for each of the one or more cells (e.g., cells indicated by the first information), which may comprise the at least one cell. The reference cell (indicated by the second information for the at least one cell) may be a serving cell (e.g., SCell or PCell) of the UE. The reference cell may be a non-serving cell (e.g., a cell with PCI different from any Serving Cells of the UE). In an example, the second information may indicate a first reference cell for a first cell in the at least one cell (e.g., via a cell index/identity). In response to (and/or when) (i) initiating or completing a mobility procedure associated with adding and/or activating the at least one cell and/or (ii) receiving the second information associated with adding and/or activating the at least one cell, the UE may activate one or more beams/TCI states for the first cell, wherein the one or more beams/TCI states are the same as and/or are associated with one or more activated beams/TCI states of the reference cell. The first cell may be updated concurrently (e.g., simultaneously), with the reference cell, for spatial relation and/or TCI relation with a MAC CE (e.g., a TCI state activation MAC CE and/or a Spatial relation info activation MAC CE).

Alternatively and/or additionally, the second information may indicate a second reference cell for a second cell in the at least one cell. In response to (and/or when) (i) initiating or completing a mobility procedure associated with adding and/or activating the at least the first cell and the second cell and/or (ii) receiving the second information associated with adding and/or activating the first cell and the second cell (and/or one or more other cells), the UE may: (A) activate one or more first beams/TCI states for the first cell, wherein the one or more first beams/TCI states are the same as and/or are associated with one or more activated beams/TCI states of the first reference cell, and/or (B) activate one or more second beams/TCI states for the second cell, wherein the one or more second beams/TCI states are the same as and/or are associated with one or more activated beams/TCI states of the second reference cell. The first cell may be updated concurrently (e.g., simultaneously), with the reference cell, for spatial relation and/or TCI relation with a MAC CE (e.g., a TCI state activation MAC CE and/or a Spatial relation info activation MAC CE). The second cell may be updated concurrently (e.g., simultaneously), with the second reference cell, for spatial relation and/or TCI relation with a MAC CE (e.g., TCI state activation MAC CE and/or a Spatial relation info activation MAC CE).

Alternatively and/or additionally, the UE may remove/release/deactivate the reference cell in response to (i) the second information and/or (ii) adding and/or activating the at least one cell. Alternatively, the UE may not remove/release/deactivate the reference cell (e.g., the UE may keep the reference cell activated) in response to (i) the second information and/or (ii) adding and/or activating the at least one cell.

### Embodiment 29

In Embodiment 29, there may be different reference cells for UL and DL.

In some examples, the first information and/or the second information may indicate a first DL reference cell for the first cell and/or the first set of cells, wherein the first DL reference cell may be indicative of DL beam activation for the first cell and/or the first set of cells (e.g., same as activate DL beam as the first DL reference cell). For example, the first DL reference cell may be associated with one or more DL beams, wherein an indication of the first DL reference cell in the second information may correspond to (i) an indication that the one or more DL beams are associated with the first cell and/or the first set of cells and/or (ii) an indication (e.g., an instruction) for the UE to activate the one or more DL beams for the first cell (e.g., the UE may use the one or more DL beams for communication with the first cell and/or the first set of cells). The second information may indicate a first UL reference cell for the first cell and/or the first set of cells, wherein the first UL reference cell may be indicative of UL beam activation (e.g., same as activate UL beam as the first UL reference cell). For example, the first UL reference cell may be associated with one or more UL beams, wherein an indication of the first UL reference cell in the second information may correspond to (i) an indication that the one or more UL beams are associated with the first cell and/or the first set of cells and/or (ii) an indication (e.g., an instruction) for the UE to activate the one or more UL beams for the first cell and/or the first set of cells (e.g., the UE may use the one or more UL beams for communication with the first cell). The first DL reference cell and the first UL reference cell may be indicated via different indexes/identities. The first DL reference cell and the first UL reference cell may be the same or different cells.

In some examples, the UE may remove/release/deactivate one or more current and/or existing cells (which may comprise the first DL reference cell and/or the first UL reference cell) in response to (i) the second information and/or (ii) adding and/or activating the at least one cell (which may comprise the first cell). Alternatively and/or additionally, the UE may not remove/release/deactivate the one or more current and/or existing cells (e.g., the UE may keep the one or more current and/or existing cells activated) in response to (i) the second information and/or (ii) adding and/or activating the at least one cell. Alternatively and/or additionally, the UE may select the one or more current and/or existing cells associated with an update list based on whether or not the one or more current or existing cells are activated after and/or in response to adding and/or activating the at least one cell.

### Embodiment 30

In Embodiment 30, if a beam and/or beam information associated with one or more added SCells is not provided, the one or more added SCells may use a beam associated with a current PCell.

In some examples, the second information may not provide beam information for a cell (when adding and/or activating the cell, for example). In some examples, the second information is associated with adding and/or activating the cell. In response to (and/or when) receiving the second information associated with adding and/or activating a first cell, wherein the second information does not indicate beam information associated with the first cell, the UE may activate and/or use one or more beams (e.g., one or more UL and/or DL beams), associated with a PCell (e.g., a current PCell) and/or a PSCell (e.g., a current PSCell) of the UE, on the first cell.

The beam information may comprise one or more TCI state identities.

The beam information may comprise spatial relation information.

The beam information may comprise a reference signal index (e.g., SSB and/or CSI-RS).

The beam information may comprise cell index of a reference cell.

The beam information may comprise an indication of an update list.

### Embodiment 31

In Embodiment 31, each beam of one or more beams (indicated by the first information and/or the second information, for example) may be associated with one or more cells and/or CGs. In some examples, each of the one or more beams may be associated with one or more cells and/or CGs. In some examples, the one or more cells and/or CGs being associated with a same beam in the one or more beams may mean that the one or more cells and/or CGs are in a same update list (e.g., simultaneousTCI-UpdateList1, simultaneousTCI-UpdateList2, simultaneousSpatial-UpdatedList1, and/or simultaneousSpatial-UpdatedList2). Alternatively and/or additionally, the one or more cells and/or CGs being associated with a same beam in the one or more beams may mean that the UE is configured with the same beam for the one or more cells and/or CGs. In some examples, one or more cells and/or CGs (e.g., one or more sets of cells) may be indicated and/or configured via the first information. Alternatively and/or additionally, a CG is associated with a beam in the one or more beams. For example, the UE may be configured with the beam for one, some and/or all cells configured in the CG. Alternatively and/or additionally, the UE may be configured with the beam for a first subset of cells configured in the CG, but not for a second subset of cells configured in the CG. For example, the one or more beams may be associated with different Cells (and/or each of the one or more beams may be associated with a different cell or different group of cells of the different cells). For each beam of the one or more beams, the UE may determine one or more cells are associated with the beam. Each of the one or more cells and/or CGs may be associated with a group of one or more beams comprising one, some and/or all of the one or more beams. The one or more beams may be indicated and/or configured via the first information. For example, the first information may indicate serving cell configurations for the one or more cells and/or CGs. The first information may indicate (e.g., include) a beam (and/or one or more other beams) associated with a PCell in a set of cells (e.g., a set of one or more cells) and/or in a CG.

In an example, the first information may indicate an association between the one or more beams and the one or more cells and/or CGs. Alternatively and/or additionally, the association between the one or more beams and the one or more cells may be indicated via a network message (e.g., a RRC reconfiguration message) different from the first information and/or the second information (e.g., the network message may comprise a RRC message before receiving the first information). Alternatively and/or additionally, the association may be predefined in the UE and/or may be derived by the UE.

### Embodiment 32

In Embodiment 32, a set of cells may be associated with a beam in the first information (e.g., a beam indicated by the first information).

In some examples, each set of the one or more sets of cells (indicated by the first information and/or the second information, for example) may be associated with a beam (e.g., the same beam) in the one or more beams.

Each set in the one or more sets may be associated with (e.g., may be assigned with) an index/identity. The index/identity may be provided (e.g., indicated) in the first information.

In some examples, the second information may not indicate one or more indexes/identities associated with the one or more sets of cells (e.g., the second information may not indicate any index/identity associated with the one or more sets of cells). In some examples, the second information may not indicate one or more indexes/identities (e.g., PCI and/or serving cell index) of one or more cells in the one or more sets of cells (e.g., the second information may not indicate any index/identity associated with any cell in the one or more sets of cells).

In some examples, the second information may indicate a group of beams (e.g., a group of one or more beams). The group of beams may comprise one, some and/or all of the one or more beams. The group of beams may be associated with a set of cells in the one or more sets of cells. One, some and/or all beams in the group of beams may be associated with the same set of cells (of the one or more sets of cells, for example). Alternatively and/or additionally, each beam in the group of beams may be associated with a set of cells in the one or more sets of cells. Different beams in the group of beams may be associated with different sets of cells (of the one or more sets of cells, for example). The one or more sets of cells may correspond to one or more first sets of cells.

For example, the second information may indicate (e.g., include) one or more indexes/identities associated with one or more beams in the group of beams (e.g., the one or more indexes/identities may comprise SSB index, CSI-RS resource id, TCI state identity, and/or spatial relation info identity).

In response to (and/or when) (i) receiving the second information and/or (ii) initiating or completing a mobility procedure, the UE may add and/or activate one or more sets of cells and/or CGs (as Serving Cells, for example) based on one or more beams (e.g., the group of beams indicated by the second information) indicated in the second information (e.g., the one or more sets of cells may be added and/or activated based on association between the one or more sets of cells and the one or more beams). The second information may indicate adding and/or activating one or more sets of cells in the one or more first sets of cells. The mobility procedure may be initiated and/or performed to add and/or activate one or more sets of cells in the one or more first sets of cells (e.g., the one or more sets of cells may be indicated by the second information). The UE may activate or add one or more cells and/or CGs that are in one or more sets of cells associated with the group of beams indicated in the second information. The UE may not activate or add one or more cells and/or CGs that are in one or more sets of cells that are not associated with the group of beams.

In response to adding and/or activating the one or more sets of cells (after receiving the second information and/or after the mobility procedure, for example), the UE may activate the group of beams for (e.g., on) the one or more sets of cells for DL and/or UL communication with the one or more sets of cells.

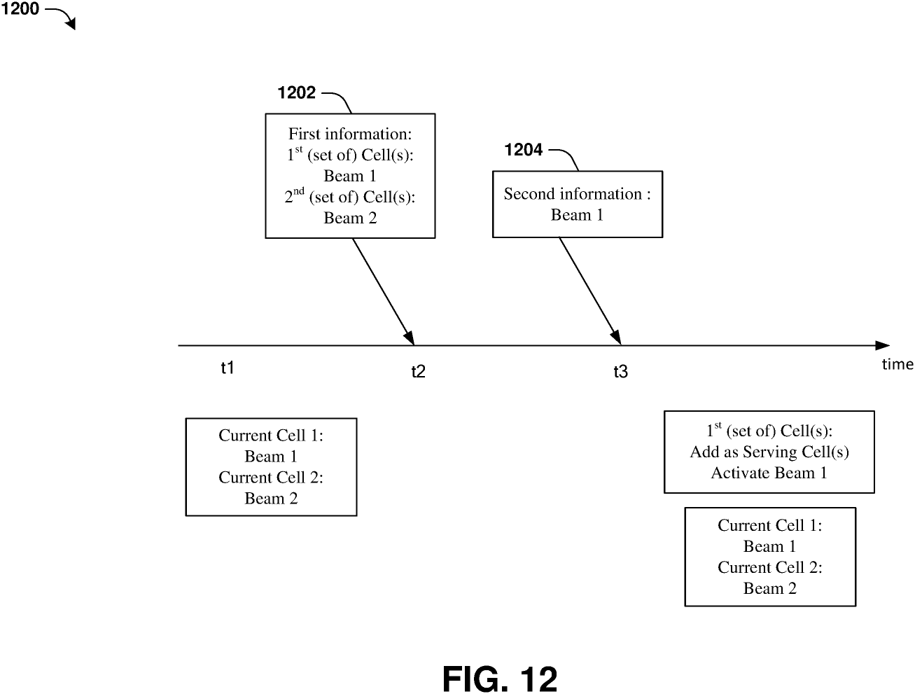

FIG. 12 illustrates a scenario 1200 associated with a UE. At timing t1, the UE is configured with and/or performs communication with (i) a cell, Current Cell 1 (e.g., an activated cell) with activated beam, Beam 1, and (ii) a cell, Current Cell 2 (e.g., an activated cell) with activated beam, Beam 2. At timing t2, the UE receives a first information 1202 (e.g., a RRC message) indicating (i) a first set of cells (e.g., a first set of one or more cells) with an associated beam, Beam 1, and (ii) a second set of cells (e.g., a second set of one or more cells) with an associated beam, Beam 2. For example, the first information 1202 may indicate that the first set of cells is associated with Beam 1 (associated with Current Cell 1) and/or that the second set of cells is associated with Beam 2 (associated with Current Cell 2). At timing t3, the UE receives a second information 1204 indicating Beam 1. In some examples, the second information 1204 does not indicate index/identity associated with the first set of cells and the second information 1204 does not indicate index/identity associated with the second set of cells. In some examples, the second information 1204 does not indicate cell index/identity associated with cells. In response to the second information 1204, the UE may add and/or activate the first set of cells as one or more Serving Cells (based on the first set of cells being associated with Beam 1 and/or based on the second information 1204 being indicative of Beam 1, for example). The first set of cells may be added and/or activated (in response to the second information 1204) after timing t3. The UE may activate Beam 1 for (e.g., on) the first set of cells (after timing t3, for example). The UE may add and/or activate the first set of cells as one or more Serving Cells and may activate Beam 1 for (e.g., on) the first set of cells at different timings. In some examples, the UE may not deactivate Current Cell 1 in response to the second information 1204. The second information 1204 may indicate to the UE (e.g., instruct the UE) to activate and/or add one or more cells (e.g., the first set of cells) associated with Beam 1 (e.g., the one or more cells may comprise one or more cells indicated via the first information 1202 and/or via one or more other RRC messages).

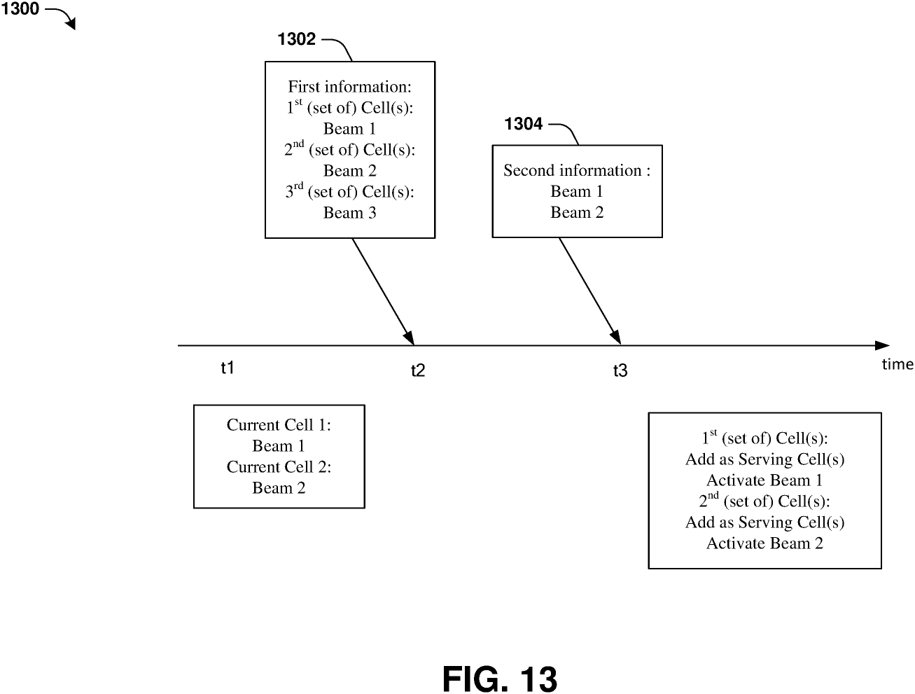

FIG. 13 illustrates a scenario 1300 associated with a UE. At timing t1, a UE is configured with and/or performs communication with (i) a cell, Current Cell 1 (e.g., an activated cell) with activated beam, Beam 1, and (ii) a cell, Current Cell 2 (e.g., an activated cell) with activated beam, Beam 2. At timing t2, the UE receives a first information 1302 (e.g., a RRC message) indicating (i) a first set of cells (e.g., a first set of one or more cells) with an associated beam, Beam 1, (ii) a second set of cells (e.g., a second set of one or more cells) with an associated beam, Beam 2, and (iii) a third set of cells (e.g., a third set of one or more cells) with an associated beam, Beam 3. For example, the first information 1302 may indicate that the first set of cells is associated with Beam 1 (associated with Current Cell 1), the second set of cells is associated with Beam 2 (associated with Current Cell 2), and/or the third set of cells is associated with Beam 3. At timing t3, the UE receives a second information 1304 indicating Beam 1 and Beam 2. In some examples, the second information 1304 does not indicate index/identity associated with the first set of cells, the second information 1304 does not indicate index/identity associated with the second set of cells, and the second information 1304 does not indicate index/identity associated with the third set of cells. In some examples, the second information 1304 does not indicate cell index/identity associated with cells. In response to the second information 1304, the UE may add and/or activate the first set of cells as one or more Serving Cells and add and/or activate the second set of cells as one or more Serving Cells (based on the first set of cells being associated with the Beam 1, based on the second set of cells being associated with the Beam 2, and/or based on the second information 1304 being indicative of Beam 1 and Beam 2, for example). The first set of cells and/or the second set of cells may be added and/or activated (in response to the second information 1304) after timing t3. The UE may activate Beam 1 for (e.g., on) the first set of cells, and activate Beam 2 for (e.g., on) the second set of cells. In some examples, the UE may perform actions at different timings, wherein the actions comprise (i) adding and/or activating the first set of cells as one or more Serving Cells, (ii) adding and/or activating the second set of cells as one or more Serving Cells, (iii) activating Beam 1 (for the first set of cells, for example), and/or (iv) activating Beam 2 (for the second set of cells, for example). In some examples, the UE may perform one or more first actions at one or more first timings and one or more second actions at one or more second timings. The one or more first timings may be different than the one or more second timings. The one or more first actions may comprise (i) adding and/or activating the first set of cells as one or more Serving Cells, and/or (ii) adding and/or activating the second set of cells as one or more Serving Cells. The one or more second actions may comprise (i) activating Beam 1 (for the first set of cells, for example), and/or (ii) activating Beam 2 (for the second set of cells, for example). The UE may not activate the third set of cells in response to the second information 1304 (e.g., the UE may not activate the third set of cells based on the second information 1304 not including an indication of Beam 3).

### Embodiment 33

In Embodiment 33, other cells associated with a beam may be added.

In some examples, the UE may activate and/or add one or more cells that are associated with one or more beams in the group of beams indicated in the second information (e.g., the UE may activate and/or add all cells that are associated with the one or more beams in the group of beams). The one or more cells associated with the one or more beams in the group of beams may not be associated with (and/or may not be included in) the one or more sets of cells (e.g., the one or more first sets of cells).

### Embodiment 34

In Embodiment 34, one or more existing cells with an indicated beam may be removed/released/deactivated.

In some examples, in response to (and/or when) (i) receiving the second information and/or (ii) initiating or completing a mobility procedure, the UE may remove/release/deactivate one or more current and/or existing cells comprising one, some and/or all current and/or existing cells that are associated with the group of beams indicated in the second information. The one or more current and/or existing cells may not be considered to be Serving Cells of the UE after receiving the second information (and/or after completion of the mobility procedure).

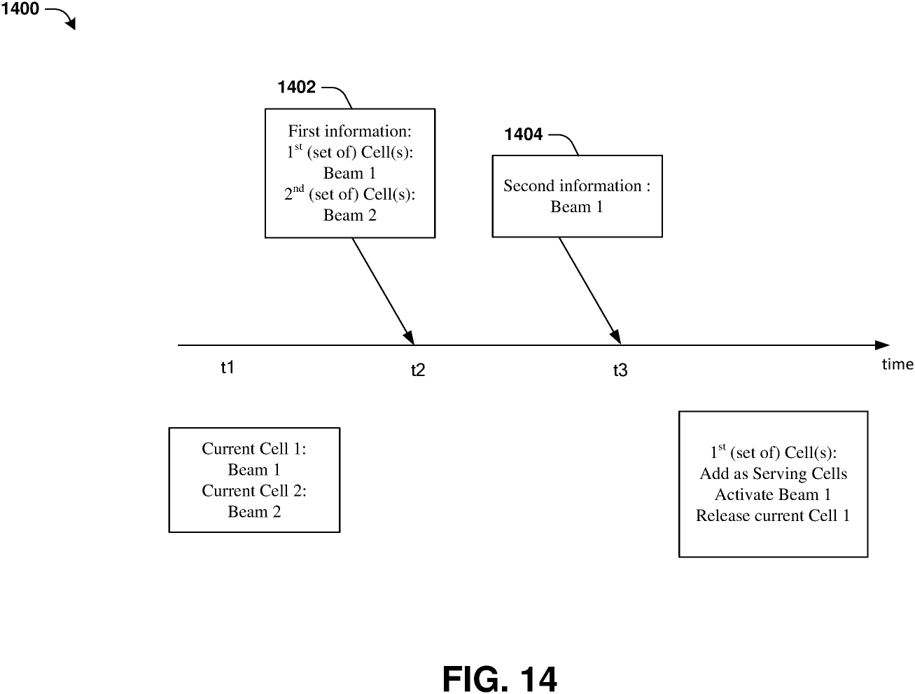

FIG. 14 illustrates a scenario 1400 associated with a UE. At timing t1, the UE is configured with and/or performs communication with (i) a cell, Current Cell 1 (e.g., an activated cell) with activated beam, Beam 1, and (ii) a cell, Current Cell 2 (e.g., an activated cell) with activated beam, Beam 2. At timing t2, the UE receives a first information 1402 (e.g., a RRC message) indicating (i) a first set of cells (e.g., a first set of one or more cells) with an associated beam, Beam 1, and (ii) a second set of cells (e.g., a second set of one or more cells) with an associated beam, Beam 2. For example, the first information 1402 may indicate that the first set of cells is associated with Beam 1 (associated with Current Cell 1) and/or that the second set of cells is associated with Beam 2 (associated with Current Cell 2). At timing t3, the UE receives a second information 1404 indicating Beam 1. In some examples, the second information 1404 does not indicate index/identity associated with the first set of cells and the second information 1404 does not indicate index/identity associated with the second set of cells. In some examples, the second information 1404 does not indicate cell index/identity associated with cells. In response to the second information 1404, the UE may add and/or activate the first set of cells as one or more Serving Cells (based on the first set of cells being associated with Beam 1 and/or based on the second information 1404 being indicative of Beam 1, for example). The first set of cells may be added and/or activated (in response to the second information 1404) after timing t3. The UE may activate Beam 1 for (e.g., on) the first set of cells (after timing t3, for example). The UE may add and/or activate the first set of cells as one or more Serving Cells and may activate Beam 1 for (e.g., on) the first set of cells at different timings. The UE may remove/release/deactivate Current Cell 1 in response to the second information 1404 (since the second information 1404 indicates Beam 1, for example). In some examples, the UE may not remove/release/deactivate Current Cell 2 in response to the second information 1404 (since the second information 1404 does not indicate Beam 2, for example).

### Embodiment 35

In Embodiment 35, one or more cells that are not associated with the group of beams may be removed/released/deactivated.

In some examples, in response to (and/or when) (i) receiving the second information and/or (ii) initiating or completing a mobility procedure, the UE may remove/release/deactivate one or more cells that are not associated with the group of beams indicated in the second information. The one or more removed/released/deactivated cells may be current and/or existing cells of the UE.

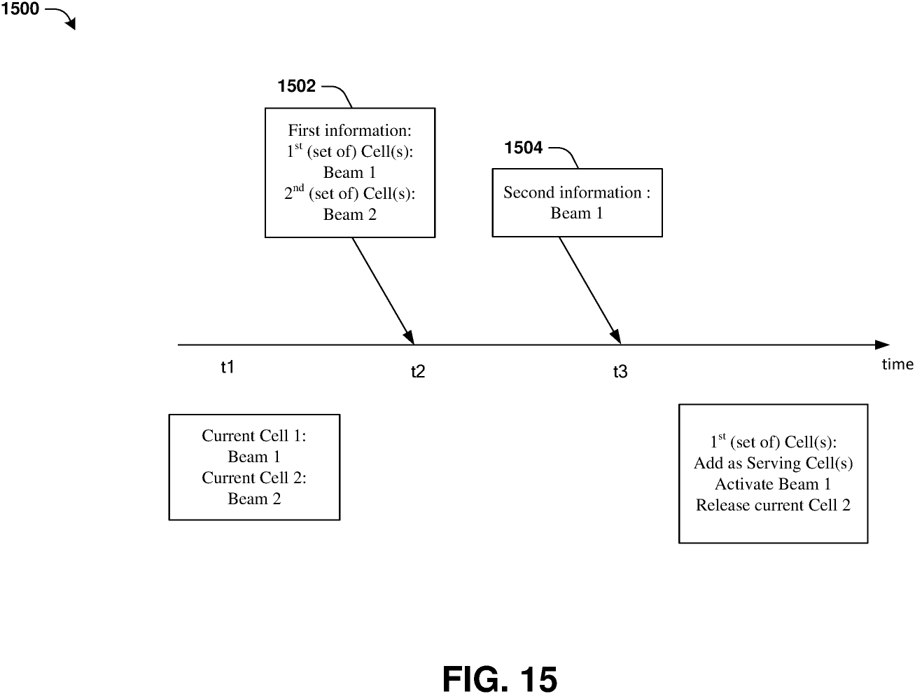

FIG. 15 illustrates a scenario 1500 associated with a UE. At timing t1, the UE is configured with and/or performs communication with (i) a cell, Current Cell 1 (e.g., an activated cell) with activated beam, Beam 1, and (ii) a cell, Current Cell 2 (e.g., an activated cell) with activated beam, Beam 2. At timing t2, the UE receives a first information 1502 (e.g., a RRC message) indicating (i) a first set of cells (e.g., a first set of one or more cells) with an associated beam, Beam 1, and (ii) a second set of cells (e.g., a second set of one or more cells) with an associated beam, Beam 2. For example, the first information 1502 may indicate that the first set of cells is associated with Beam 1 (associated with Current Cell 1) and/or that the second set of cells is associated with Beam 2 (associated with Current Cell 2). At timing t3, the UE receives a second information 1504 indicating Beam 1. In some examples, the second information 1504 does not indicate index/identity associated with the first set of cells and the second information 1504 does not indicate index/identity associated with the second set of cells. In some examples, the second information 1504 does not indicate cell index/identity associated with cells. In response to the second information 1504, the UE may add and/or activate the first set of cells as one or more Serving Cells (based on the first set of cells being associated with the Beam 1 and/or based on the second information 1504 being indicative of Beam 1, for example). The first set of cells may be added and/or activated (in response to the second information 1504) after timing t3. The UE may activate Beam 1 for (e.g., on) the first set of cells. The UE may remove/release/deactivate Current Cell 2 in response to the second information 1504 (e.g., since the second information 1504 indicates Beam 1 and Current Cell 2 is not associated with Beam 2and/or is not activated with Beam 2). In some examples, the UE may not remove/release/deactivate Current Cell 1 in response to the second information 1504. Alternatively, the UE may also remove/release/deactivate Current Cell 1 in response to the second information 1504.

Alternatively and/or additionally, the UE may not remove/release/deactivate one or more current and/or existing cells that are not associated with the group of beams (e.g., the group of beams indicated in the second information). The one or more current and/or existing cells that are not associated with the group of beams may be one or more Serving Cells of the UE after receiving the second information (and/or after completion of the mobility procedure).

Alternatively and/or additionally, the UE may not remove/release/deactivate one or more current and/or existing cells (e.g., the UE may not remove/release/deactivate any current and/or existing cell) in response to receiving the second information. The one or more current and/or existing cells may be one or more Serving Cells of the UE before (and after, for example) receiving the second information. Alternatively and/or additionally, the one or more current and/or existing cells may be one or more Serving Cells of the UE before (and after, for example) completion of the mobility procedure.

Alternatively and/or additionally, in response to the second information, the UE may remove/release/deactivate one or more current and/or existing cells comprising one, some and/or all current and/or existing cells (of the UE, for example). The one or more current and/or existing cells may be associated with the group of beams indicated in the second information (e.g., the one or more current and/or existing cells may comprise one, some and/or all current and/or existing cells associated with the group of beams indicated in the second information). The one or more current and/or existing cells may not be associated with the group of beams indicated in the second information (e.g., the one or more current and/or existing cells may comprise one, some and/or all current and/or existing cells that are not associated with the group of beams indicated in the second information). The one or more current and/or existing cells may be one or more Serving Cells of the UE before receiving the second information and/or before completion of the mobility procedure (e.g., the one or more current and/or existing cells may comprise one, some and/or all current and/or existing cells that are Serving Cells of the UE before receiving the second information and/or before completion of the mobility procedure).

Alternatively and/or additionally, in response to the second information associated with adding and/or activating one or more cells in a CG (e.g., MCG or SCG), the UE may remove/release/deactivate one or more current and/or existing cells of the CG (e.g., the one or more current and/or existing cells may comprise one, some and/or all current and/or existing cells of the CG). The UE may not remove/release/deactivate one or more current and/or existing cells of a CG different from the CG associated with the one or more added and/or activated cells (e.g., the one or more cells added and/or activated based on the second information).

Alternatively and/or additionally, in response to the second information associated with adding and/or activating one or more cells in a CG (e.g., MCG or SCG), the UE may remove/release/deactivate one or more current and/or existing cells of one or more CGs. The one or more current and/or existing cells may comprise one, some and/or all current and/or existing cells of the one or more CGs. The one or more CGs may comprise one, some and/or all CGs (that the UE is configured with, for example).

The second information may not indicate (e.g., include) one or more indexes/identities associated with one or more current and/or existing cells (to be removed/released/deactivated by the UE in response to the second information, for example).

Alternatively and/or additionally, the second information may indicate one or more indexes/identities associated with one or more current and/or existing cells to be removed/released/deactivated (by the UE) in response to receiving the second information. The UE may remove/release/deactivate the one or more current or existing cells associated with (e.g., configured with) the one or more indexes/identities. Alternatively and/or additionally, the UE may remove/release/deactivate one or more current and/or existing cells in a CG that includes one or more current or existing cells associated with the one or more indexes/identities indicated in the second information (e.g., the one or more current and/or existing cells removed/released/deactivated by the UE may comprise one, some and/or all current and/or existing cells in the CG).

### Embodiment 36

In Embodiment 36, cells may be associated with mTRP (e.g., mTRP beams).

In some examples, a set of cells may be associated with multiple beams (e.g., mTRP beams). Each of the multiple beams may be associated with a TRP of the set of cells. Different beams may be associated with different TRPs of the set of cells. The UE may activate multiple beams (e.g., multiple beams indicated in the second information) for the set of cells in response to receiving the second information indicating the multiple beams.

### Embodiment 37

In Embodiment 37, the UE may differentiate between inter-Cell mTRP indication, inter-cell mobility and SCell addition (based on at least one of a Logical channel ID (LCID), a field, a flag, etc., for example).

In response to (and/or when and/or upon) receiving a signaling, the UE may determine (e.g., decide), based on content of the signaling, whether (i) to add and/or activate one or more sets of cells or (ii) to perform inter-Cell mTRP operation. The signaling may indicate a group of beams (e.g., a group of one or more beams). A first MAC CE (e.g., a first type of MAC CE) may be used to indicate to the UE (e.g., instruct the UE) to perform inter-Cell mTRP operation on the group of beams. A second MAC CE (e.g., a second type of MAC CE) may be used to indicate to the UE (e.g., instruct the UE) to add and/or activate one or more sets of cells. The first MAC CE and the second MAC CE may be associated with different LCIDs. The first MAC CE may be different than the second MAC CE. The first type of MAC CE may be different than the second type of MAC CE. In an example, the UE may determine (e.g., decide) to perform inter-Cell mTRP operation (in response to the signaling) based on the signaling comprising the first MAC CE (and/or the first type of MAC CE). The UE may determine (e.g., decide) to add and/or activate one or more sets of cells (in response to the signaling) based on the signaling comprising the second MAC CE (and/or the second type of MAC CE).

In response to (and/or when and/or upon) receiving the second information (e.g., the signaling) indicating the group of beams, the UE may determine (e.g., decide) whether (i) to add and/or activate one or more sets of cells based on the second information, (ii) to perform inter-Cell mTRP operation based on the second information, or (iii) to perform inter-Cell mobility to the one or more sets of cells associated with the group of beams based on the second information (e.g., based on content of the second information).

For example, the second information may be associated with (e.g., may include) a LCID. The second information may be associated with multiple LCIDs. Different LCIDs may be associated with different actions (that may be performed based on the second information). In an example, a first LCID may be associated with one or more first actions (e.g., the UE may perform the one or more first actions based on the second information comprising the first LCID), a second LCID may be associated with one or more second actions (e.g., the UE may perform the one or more second actions based on the second information comprising the second LCID), etc. In response to receiving the second information indicating the group of beams, the UE may determine one or more actions to perform based on a LCID indicated by the second information, wherein the one or more actions may be selected (based on the LCID) from among multiple actions comprising: (i) adding and/or activating one or more cells (e.g., the one or more set of cells) associated with the group of beams (e.g., the one or more cells may be added and/or activated as Serving Cells), (ii) performing inter-Cell mTRP operation with one or more cells (e.g., the one or more set of cells) associated with the group of beams, (iii) switching PCell or PSCell of the UE to a cell (e.g., one cell) in the one or more set of cells associated with the group of beams, and/or (iv) removing/releasing/deactivating one or more current and/or existing cells.

Alternatively and/or additionally, the second information may be associated with different DCI formats. For example, the UE may determine the one or more actions (of the multiple actions) to perform based on a DCI format of a DCI associated with the second information (e.g., the second information may be received via the DCI, such as where the DCI comprises the second information).

Alternatively and/or additionally, the second information may indicate (e.g., may comprise) a field (e.g., a field in MAC CE or DCI) and/or a flag (e.g., a one-bit or two-bit flag) indicating (e.g., instructing) the UE to perform the one or more of the multiple actions according to the group of beams. For example, the UE may determine the one or more actions (of the multiple actions) to perform based on the field and/or the flag.

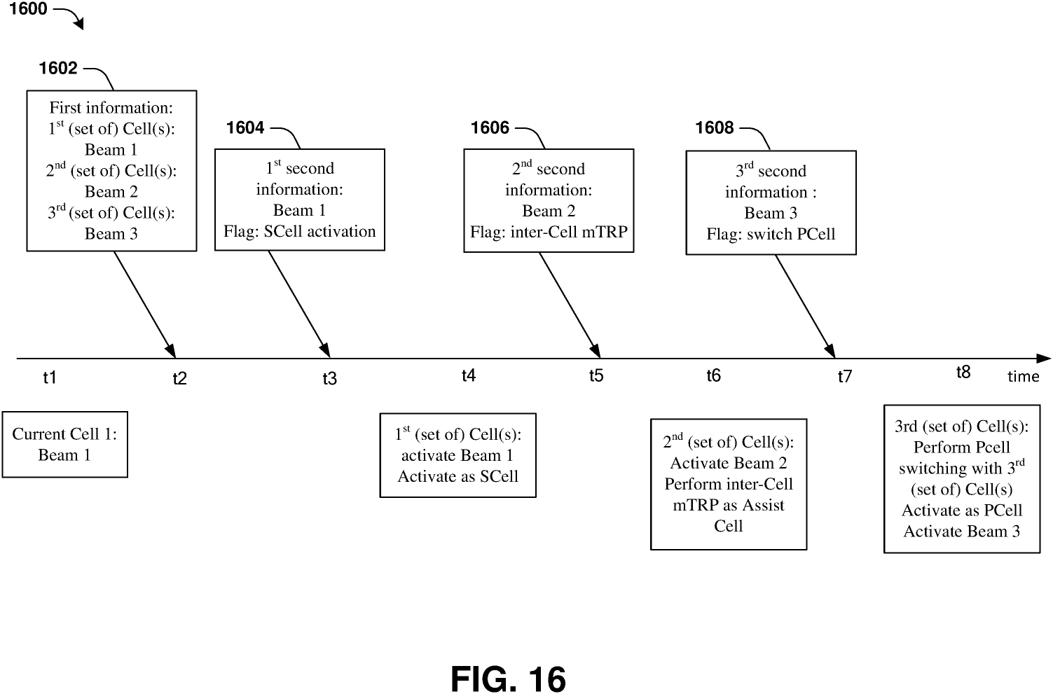

FIG. 16 illustrates a scenario 1600 associated with a UE. At timing t1, a UE is configured with and/or performs communication with a cell, Current Cell 1 (e.g., an activated cell) with activated beam, Beam 1. At timing t2, the UE receives a first information 1602 (e.g., a RRC message) indicating (i) a first set of cells (e.g., a first set of one or more cells) with an associated beam, Beam 1, (ii) a second set of cells (e.g., a second set of one or more cells) with an associated beam, Beam 2, and (iii) a third set of cells (e.g., a third set of one or more cells) with an associated beam, Beam 3. For example, the first information 1302 may indicate that the first set of cells is associated with Beam 1 (associated with Current Cell 1), the second set of cells is associated with Beam 2 (associated with Current Cell 2), and/or the third set of cells is associated with Beam 3. At timing t3, the UE receives a first set of second information 1604 which indicates Beam 1 and has a flag (and/or field and/or LCID) indicating SCell activation. In some examples, the first set of second information 1604 may comprise a DCI and/or a MAC CE. In response to the first set of second information 1604, the UE may add and/or activate the first set of cells as one or more Serving Cells (based on the first set of cells being associated with the Beam 1 and/or based on the first set of second information 1604 being indicative of Beam 1, for example). The UE may activate Beam 1 for (e.g., on) the first set of cells. The first set of cells may be added and/or activated and/or Beam 1 may be activated at timing t4. The UE may remove/release/deactivate Current Cell 1 in response to the first set of second information 1604. Alternatively, the UE may not remove/release/deactivate Current Cell 1 in response to the first set of second information 1604.

At timing t5, the UE receives a second set of second information 1606 which indicates Beam 2 and has a flag (and/or field and/or LCID) indicating inter-Cell mTRP. In some examples, the second set of second information 1606 may comprise a DCI and/or a MAC CE. In response to the second set of second information 1606, the UE activates Beam 2 for the second set of cells. The UE performs inter-Cell mTRP on the second set of cells in response to the second set of second information 1606 (as an assist cell, an additional cell and/or a non-serving cell, which is not a serving cell). For example, the UE may consider (and/or use) the second set of cells as one or more assist cells, one or more additional cells and/or one or more non-serving cells. The UE may be configured with one or more serving cells for performing inter-Cell mTRP operation with the second set of cells (e.g., the UE may be provided with an indication of the one or more serving cells). In an example, the inter-Cell mTRP operation may be performed using a serving cell of the one or more serving cells and one or more cells (e.g., one or more assist cells, one or more additional cells and/or one or more non-serving cells) of the second set of cells. The UE may activate Beam 2 for the second set of cells and/or may perform inter-cell mTRP on the second set of cells at timing t6.

At timing t7, the UE receives a third set of second information 1608 which indicates Beam 3 and has a flag indicating switching PCell (and/or mobility procedure and/or PCell change). In some examples, the third set of second information 1608 may comprise a DCI and/or a MAC CE. In response to the third set of second information 1608, the UE may switch a PCell of the UE to a cell (e.g., a single cell) of the third set of cells (based on the third set of cells being associated with the Beam 3 and/or based on the third set of second information 1608 being indicative of Beam 3, for example). The UE may activate Beam 3 for (e.g., on) the third set of cells in response to the third set of second information 1608. The UE may activate Beam 3 for the third set of cells and/or may switch the PCell of the UE at timing t8.

In some examples, the first set of second information 1604, the second set of second information 1606, and the third set of second information 1608 do not indicate cell index/identity associated with Cells, such as the first set of cells, the second set of cells and/or the third set of cells. In some examples, there is no servcellindex or physcellid in the first set of second information 1604, the second set of second information 1606, and/or the third set of second information 1608.

### Embodiment 38

In Embodiment 38, the second information may indicate an existing activated beam and/or a flag (e.g., a flag in the second information) indicates PCell switch.

In some examples, the second information may indicate a beam associated with a current and/or existing cell and/or a flag indicating PCell or PSCell switch. The current and/or existing cell may be a SCell. In response to the second information, the UE may (i) switch a PCell of the UE or PSCell of the UE to the current and/or existing cell, and (ii) use and/or activate a beam for (e.g., on) the current and/or existing cell, wherein the beam is the same beam that was used and/or activated (for communicating with the current and/or existing cell, for example) before receiving the second information (and/or before switching the PCell or the PSCell to the current and/or existing cell). Alternatively, in response to the second information, the UE may (i) switch the PCell or the PSCell to the current or existing cell, and (ii) use and/or activate the beam, that is indicated in the second information, for (e.g., on) the current and/or existing cell.

The UE may consider one or more cells in the one or more sets of cells (e.g., one, some and/or all cells of the one or more sets of cells which may be indicated by the first information and/or the second information) to be Serving Cells in response to the mobility procedure (e.g., in response to initiation or completion of the mobility procedure) and/or in response to reception of the second information. The first information and/or second information may indicate whether the one or more sets of cells are for MCG or for SCG.

Each set of the one or more sets of cells may be associated with (e.g., indicated as being associated with) a TCI state (e.g., a DL TCI state or a UL TCI state). For example, the first information (e.g., a TCI-StateId in the first information) may indicate a TCI state (e.g., a DL TCI state or a UL TCI state) associated with a set of the one or more sets of cells. A first set of cells (of the one or more sets of cells, for example) may be associated with (e.g., indicated as being associated with) a first TCI state identity. In response to (and/or when) (i) initiating or completing a mobility procedure associated with adding and/or activating the first set of cells and/or (ii) receiving the second information associated with adding and/or activating the first set of cells, the UE may activate a beam (and/or a reference signal) associated with the first TCI state identity for monitoring DL signaling (and/or transmitting UL data) on one or more Cells in the first set of cells. In some examples, the second information may not indicate a TCI state associated with the first set of cells and may not indicate a reference signal associated with the first set of cells.

In some examples, for switching a PCell or a PSCell of the UE to a cell associated with the group of beams, the UE may consider the cell to be a target cell.

In some examples, embodiments disclosed herein, such as embodiments described with respect to each of Embodiments 1-38, may be implemented independently and/or separately. Alternatively and/or additionally, a combination of embodiments described herein, such as embodiments described with respect to one, some and/or all of Embodiments 1-38, may be implemented. Alternatively and/or additionally, a combination of embodiments described herein, such as embodiments described with respect to one, some and/or all of Embodiments 1-38, may be implemented concurrently and/or simultaneously.

Various techniques, embodiments, methods and/or alternatives of the present disclosure may be performed independently and/or separately from one another. Alternatively and/or additionally, various techniques, embodiments, methods and/or alternatives of the present disclosure may be combined and/or implemented using a single system. Alternatively and/or additionally, various techniques, embodiments, methods and/or alternatives of the present disclosure may be implemented concurrently and/or simultaneously.

With respect to one or more embodiments herein, such as one or more techniques, devices, concepts, methods, example scenarios and/or alternatives described above, a mobility procedure may be used to add, release and/or switch one or more SCells of the UE. In some examples, the mobility procedure may not add, release or switch a PCell and/or a PSCell of the UE.

Alternatively and/or additionally, a mobility procedure may comprise the UE triggering and/or generating a message, and/or transmitting the message to the target cell. The mobility procedure may comprise the UE initiating a random access procedure (e.g., a contention-free random access procedure) on the target cell. The random access procedure may be initiated in response to the message becoming available for transmission. The message may indicate a completion of the mobility procedure. The mobility procedure may be used to switch the a PCell (or a PSCell) of the UE to the target cell. The UE may consider the mobility procedure to be completed in response to a completion of the random access procedure. The UE may consider the mobility procedure to be completed in response to receiving a positive acknowledgement associated with the message (from the target cell, for example). The message may be a mobility completion message. In some examples, the mobility completion message may not comprise a RRC message. The mobility completion message may comprise a MAC CE. The mobility completion message may be transmitted via a PUCCH or PUSCH transmission.

In some examples, a mobility procedure (e.g., a L1/L2 mobility procedure) may comprise a serving cell providing first information to a UE (e.g., the first information discussed with respect to one, some and/or all of Embodiments 1-38), wherein the first information provides (e.g., indicates) a configuration (e.g., a cell configuration) associated with a target cell. The configuration may comprise cell addition information and/or beam information associated with the target cell. The first information may be a dedicated signaling to the UE. The source cell may provide second information (e.g., the second information discussed with respect to one, some and/or all of Embodiments 1-38) to the UE indicating initiation of a mobility procedure to the target cell. The mobility procedure may comprise a random access procedure, one or more PUSCH transmissions and/or beam/TCI state activation. In some examples, the second information does not comprise RRC signaling and/or RRC messages. The second information may be a L1 (e.g., Downlink control information) or a L2 (e.g., MAC CE) message. The first information and the second information may be transmitted in different signaling and/or timings. In some examples, the UE may not initiate the mobility procedure to the target cell in response to the first information (e.g., in response to reception of the first information). The UE may transmit a mobility completion message to the target cell indicating a completion of the mobility procedure. Alternatively and/or additionally, the target cell may transmit an acknowledgement to the UE indicating completion of the mobility procedure. The UE may consider the mobility procedure to be completed in response to acknowledgement from the target cell. Alternatively and/or additionally, the UE may consider the mobility procedure to be complete in response to transmission of the mobility completion message. Alternatively and/or additionally, the UE may consider the mobility procedure to be complete in response to completion of a random access procedure (e.g., a random access procedure associated with the mobility procedure, such as a random access procedure performed as part of the mobility procedure).

The mobility procedure may comprise part of handover procedure and/or a reconfiguration with sync procedure.

A completion of a mobility procedure may correspond to a completion of a random access procedure associated with the mobility procedure. Alternatively and/or additionally, the completion of the mobility procedure may correspond to a transmission of a mobility completion message (to the target cell, for example). Alternatively and/or additionally, the completion of the mobility procedure may correspond to a reception of an acknowledgement of the mobility completion message (from the target cell, for example).

In some examples, the mobility procedure is not a reconfiguration with sync (e.g., not a Layer-3 handover).

With respect to one or more embodiments herein, the first information may be a RRC message (e.g., a RRCReconfiguration message).

The first information may comprise UL and/or DL resource configuration associated with the target cell (and/or one or more cells to be added as SCell when initiating or completing the mobility procedure).

The first information may comprise ServingCellConfigCommon of the target cell and the one or more cells. The one or more cells may be candidate Serving Cells for MCG or SCG of the UE.

With respect to one or more embodiments herein, the second information is not a RRC message (e.g., the second information is not a RRC signaling). The second information may comprise a Physical Downlink Control Channel (PDCCH) signaling (e.g., a DCI) and/or a MAC CE.

The second information may comprise sCellToAddModList and/or sCellToReleaseList (in the cell information, for example). The second information may indicate (e.g., may comprise) one or more cell lists indicating cells (e.g., SCell) to be added/modified/released when initiating or completing the mobility procedure.

The second information may not be (and/or may not comprise) a SCell Activation/Deactivation MAC CE.

With respect to one or more embodiments herein, the L1/L2 handover procedure may be a mobility procedure. With respect to one or more embodiments herein, the L1/L2 handover (HO) may not be a reconfiguration with sync procedure. The mobility procedure may be a procedure for L1/L2-centric inter-cell mobility.

With respect to one or more embodiments herein, the mobility procedure may comprise the UE transmitting UL data and/or control information to the target cell. The UL data may comprise information associated with the UE (e.g., Cell Radio Network Temporary Identifier (C-RNTI) MAC CE). The UL data may be transmitted via PUSCH. The UL control information may be transmitted via PUCCH.

With respect to one or more embodiments herein, the one or more cells may not comprise a PCell or a target cell. The second information may indicate both a target cell and additionally the one or more cells (via the cell information, for example) to the UE, where the UE initiates a mobility procedure and consider the target cell to be PCell in response to completion (or initiation) of the mobility procedure.

With respect to one or more embodiments herein, to add a Cell (e.g., a candidate Serving Cell) associated with an identity (e.g., SCellIndex), the UE adds the cell as SCell and applies a configuration (e.g., a cell configuration) of the cell. The configuration of the cell may be indicated in the first information (e.g., the configuration of the cell may be indicated via one or more parameters in sCellConfigCommon and sCellConfigDedicated).

With respect to one or more embodiments herein, the index/identity (provided in the first information, for example) may not be ServCellIndex. In some examples, the index/identity may not be sCellIndex.

With respect to one or more embodiments herein, the Cell information (in the second information, for example) may indicate one or more cells to be added (in a MCG and/or SCG) in response to receiving the second information.

In some embodiments, in the present disclosure, one, some and/or all instances of the term “identity” may be replaced with and/or used interchangeably with the term “ID” and/or the term “id”.

In some embodiments, in the present disclosure, the term “current cell” may correspond to a cell (e.g., a SCell, a PCell, and/or other type of cell) that is currently being used by the UE, a cell that is currently activated by the UE and/or a cell that the UE is in communication with.

One, some and/or all of the foregoing examples, concepts, techniques and/or embodiments can be formed and/or combined to a new embodiment.

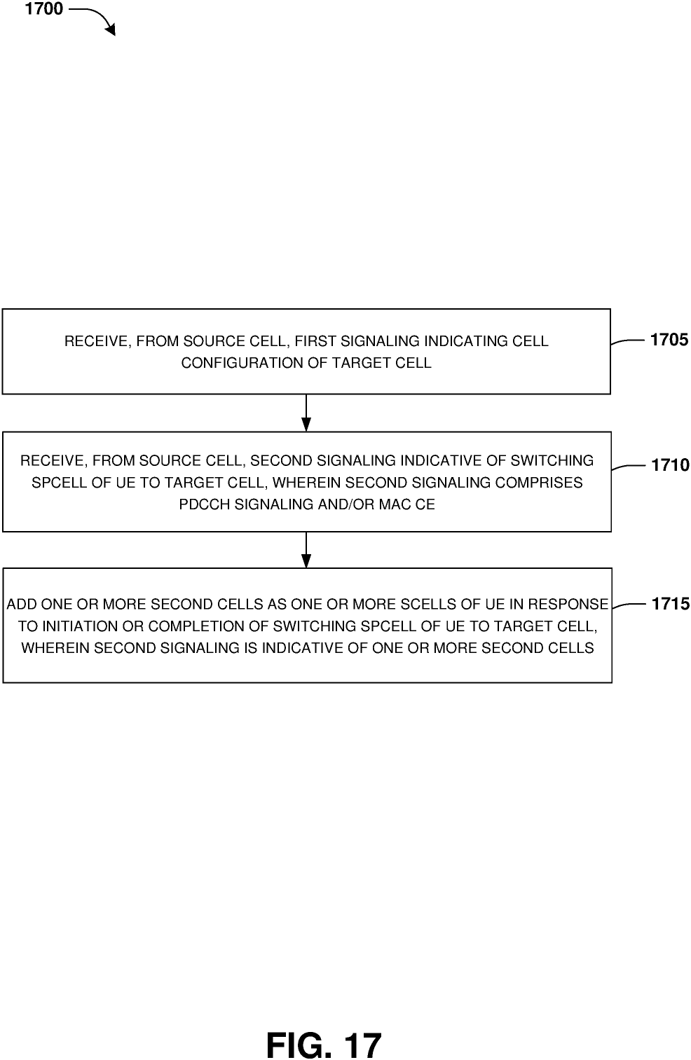

FIG. 17 is a flow chart 1700 according to one exemplary embodiment from the perspective of a UE. In step 1705, the UE receives, from a source cell, a first signaling indicating a cell configuration (e.g., ServingCellconfig and/or one or more parameters in sCellConfigCommon and/or sCellConfigDedicated) of a target cell. In step 1710, the UE receives, from the source cell, a second signaling indicative of switching a SpCell of the UE to the target cell, wherein the second signaling comprises a PDCCH signaling and/or a MAC CE (e.g., the second signaling may be the PDCCH signaling or the MAC CE). For example, the second signaling may instruct the UE to switch the SpCell of the UE to the target cell. In some examples, the UE performs switching of the SpCell of the UE to the target cell in response to the second signaling. In step 1715, the UE adds one or more second cells as one or more SCells of the UE in response to initiation or completion of the switching the SpCell of the UE to the target cell, wherein the second signaling is indicative of the one or more second cells.

In one embodiment, adding the one or more second cells as one or more SCells may comprise (i) adding the one or more second cells to a set of SCells (e.g., a set of currently used and/or activated SCells) of the UE, (ii) activating the one or more second cells, and/or (iii) considering the one or more second cells to be one or more SCells. The UE may use the one or more second cells (as SCells, for example) after adding the one or more second cells as one or more SCells.

In one embodiment, the UE removes, releases and/or deactivates one or more third cells in response to initiation or completion of the switching the SpCell of the UE to the target cell. The one or more third cells may be one or more SCells that are indicated by the second signaling.

In one embodiment, removing the one or more third cells may comprise removing the one or more third cells from a set of SCells (e.g., a set of currently used and/or activated SCells) of the UE. The UE may cease using the one or more third cells (as SCells, for example) in response to removing, releasing and/or deactivating the one or more third cells.

Referring back to FIGS. 3 and 4, in one exemplary embodiment of a UE, the device 300 includes a program code 312 stored in the memory 310. The CPU 308 may execute program code 312 to enable the UE (i) to receive, from a source cell, a first signaling indicating a cell configuration of a target cell, (ii) to receive, from the source cell, a second signaling indicative of switching a SpCell of the UE to the target cell, wherein the second signaling comprises a PDCCH signaling and/or a MAC CE, and (iii) to add one or more second cells as one or more SCells of the UE in response to initiation or completion of switching the SpCell of the UE to the target cell, wherein the second signaling is indicative of the one or more second cells. Furthermore, the CPU 308 can execute the program code 312 to perform one, some and/or all of the above-described actions and steps and/or others described herein.

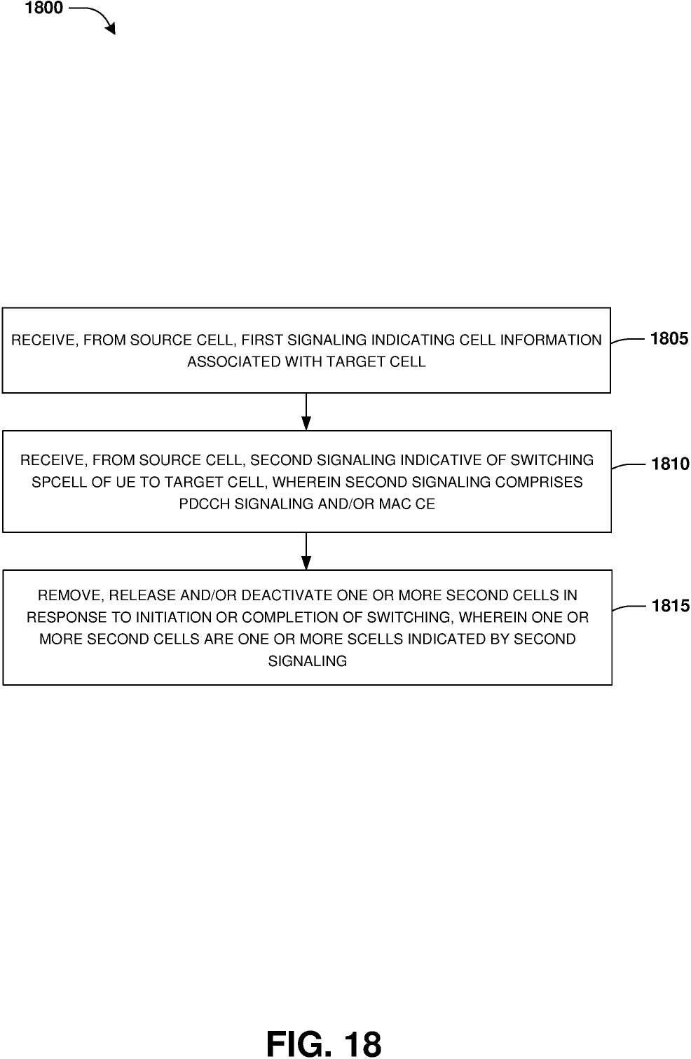

FIG. 18 is a flow chart 1800 according to one exemplary embodiment from the perspective of a UE. In step 1805, the UE receives, from a source cell, a first signaling indicating cell information associated with a target cell. The cell information may comprise a cell configuration (e.g., ServingCellconfig and/or one or more parameters in sCellConfigCommon and/or sCellConfigDedicated) of the target cell. In step 1810, the UE receives, from the source cell, a second signaling indicative of switching a SpCell of the UE to the target cell, wherein the second signaling comprises a PDCCH signaling and/or a MAC CE (e.g., the second signaling may be the PDCCH signaling or the MAC CE). For example, the second signaling may instruct the UE to switch the SpCell of the UE to the target cell. In some examples, the UE performs switching of the SpCell of the UE to the target cell in response to the second signaling. In step 1815, the UE removes, releases and/or deactivates one or more second cells in response to initiation or completion of the switching (e.g., the switching the SpCell of the UE to the target cell), wherein the one or more second cells are one or more SCells indicated by the second signaling.

In one embodiment, removing the one or more second cells may comprise removing the one or more second cells from a set of SCells (e.g., a set of currently used and/or activated SCells) of the UE. The UE may cease using the one or more second cells (as SCells, for example) in response to removing, releasing and/or deactivating the one or more second cells.

In one embodiment, the UE adds one or more third cells in response to initiation or completion of the switching (e.g., the switching the SpCell of the UE to the target cell). The one or more third cells may be indicated by the second signaling.

In one embodiment, adding the one or more third cells may comprise (i) adding the one or more third cells to a set of cells (e.g., a set of currently used and/or activated cells) of the UE, and/or (ii) activating the one or more third cells. The UE may use the one or more third cells after adding the one or more third cells.

Referring back to FIGS. 3 and 4, in one exemplary embodiment of a UE, the device 300 includes a program code 312 stored in the memory 310. The CPU 308 may execute program code 312 to enable the UE (i) to receive, from a source cell, a first signaling indicating cell information associated with a target cell, (ii) to receive, from the source cell, a second signaling indicative of switching a SpCell of the UE to the target cell, wherein the second signaling comprises a PDCCH signaling and/or a MAC CE, and (iii) to remove, release and/or deactivate one or more second cells in response to initiation or completion of the switching, wherein the one or more second cells are one or more SCells indicated by the second signaling. Furthermore, the CPU 308 can execute the program code 312 to perform one, some and/or all of the above-described actions and steps and/or others described herein.

With respect to FIGS. 17 and 18, in one embodiment, the first signaling is a RRC message.

In one embodiment, the first signaling indicates a cell configuration (e.g., ServingCellconfig and/or one or more parameters in sCellConfigCommon and/or sCellConfigDedicated) of the one or more second cells.

In one embodiment, the first signaling indicates a cell configuration (e.g., ServingCellconfig and/or one or more parameters in sCellConfigCommon and/or sCellConfigDedicated) of the one or more third cells.

In one embodiment, the second signaling indicates an identity and/or an index associated with the one or more second cells.

In one embodiment, the second signaling indicates an identity and/or an index associated with the one or more third cells.

In one embodiment, the SpCell is a PCell or a PSCell.

In one embodiment, the one or more second cells are one or more neighboring cells of the UE before the switching the SpCell of the UE to the target cell.

In one embodiment, the one or more second cells are one or more SCells of the UE before the switching the SpCell of the UE to the target cell.

In one embodiment, the one or more third cells are one or more neighboring cells of the UE before the switching the SpCell of the UE to the target cell.

In one embodiment, the one or more third cells are one or more SCells of the UE before the switching the SpCell of the UE to the target cell.

In one embodiment, the UE determines whether to add or to remove/release/deactivate the one or more second cells in response to initiation or completion of the switching based on one or more indicators, of the second signaling, associated with the one or more second cells. For example, the UE may determine to add the one or more second cells based on the one or more indicators indicating addition of the one or more second cells. Alternatively and/or additionally, the UE may determine to remove/release/deactivate the one or more second cells based on the one or more indicators comprising indicating removal/release/deactivation of the one or more second cells.

In one embodiment, the UE determines whether to add or to remove/release/deactivate the one or more third cells in response to initiation or completion of the switching based on one or more indicators, of the second signaling, associated with the one or more third cells. For example, the UE may determine to add the one or more third cells based on the one or more indicators indicating addition of the one or more third cells. Alternatively and/or additionally, the UE may determine to remove/release/deactivate the one or more third cells based on the one or more indicators comprising indicating removal/release/deactivation of the one or more third cells.

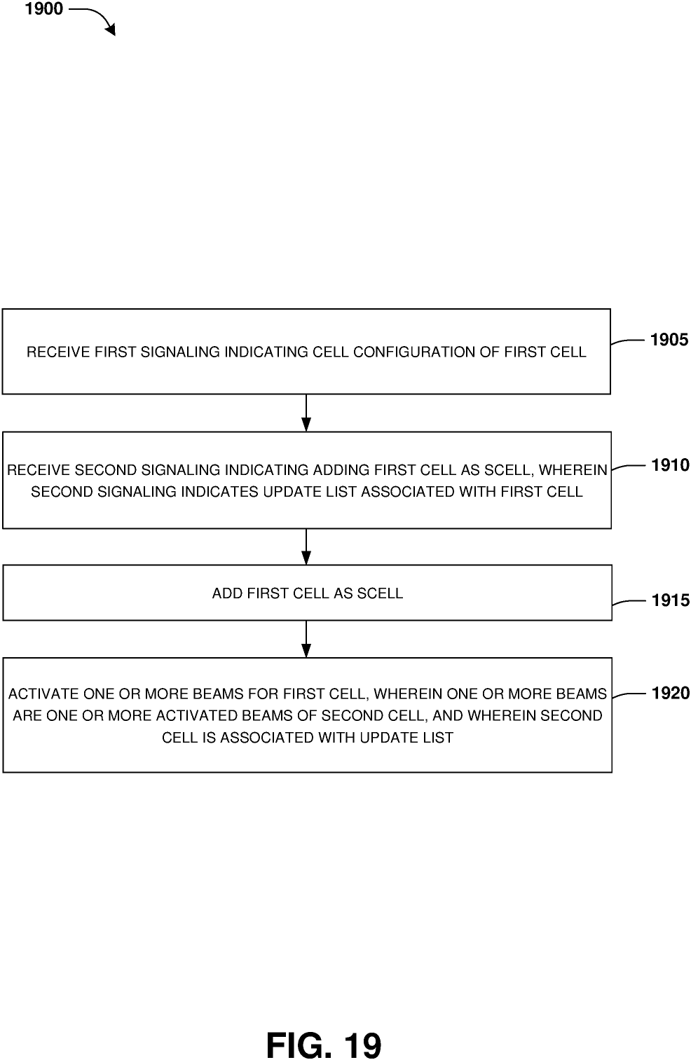

FIG. 19 is a flow chart 1900 according to one exemplary embodiment from the perspective of a UE. In step 1905, the UE receives a first signaling indicating a cell configuration (e.g., ServingCellconfig and/or one or more parameters in sCellConfigCommon and/or sCellConfigDedicated) of a first cell. In step 1910, the UE receives a second signaling indicating adding the first cell as a SCell, wherein the second signaling indicates an update list associated with the first cell. For example, the second signaling may instruct the UE to add the first cell as a SCell. In step 1915, the UE adds the first cell as a SCell. In step 1920, the UE activates one or more beams for the first cell, wherein the one or more beams are one or more activated beams of a second cell, and wherein the second cell is associated with the update list. For example, the update list may be indicative of the second cell. Alternatively and/or additionally, the UE may activate, for the first cell, the one or more beams associated with the second cell based on the update list being associated with (e.g., being indicative of) the second cell. In some examples, after activating the one or more beams (associated with the second cell) for the first cell, the UE may communicate with the first cell using the one or more beams.

In one embodiment, the indicated update list is simultaneousTCI-UpdateList1 or simultaneousTCI-UpdateList2.

In one embodiment, the indicated update list is simultaneousSpatial-UpdatedList1 or simultaneousSpatial-UpdatedList2.

Referring back to FIGS. 3 and 4, in one exemplary embodiment of a UE, the device 300 includes a program code 312 stored in the memory 310. The CPU 308 may execute program code 312 to enable the UE (i) to receive a first signaling indicating a cell configuration of a first cell, (ii) to receive a second signaling indicating adding the first cell as a SCell, wherein the second signaling indicates an update list associated with the first cell, (iii) to add the first cell as a SCell, and (iv) to activate one or more beams for the first cell, wherein the one or more beams are one or more activated beams of a second cell, and wherein the second cell is associated with the update list. Furthermore, the CPU 308 can execute the program code 312 to perform one, some and/or all of the above-described actions and steps and/or others described herein.

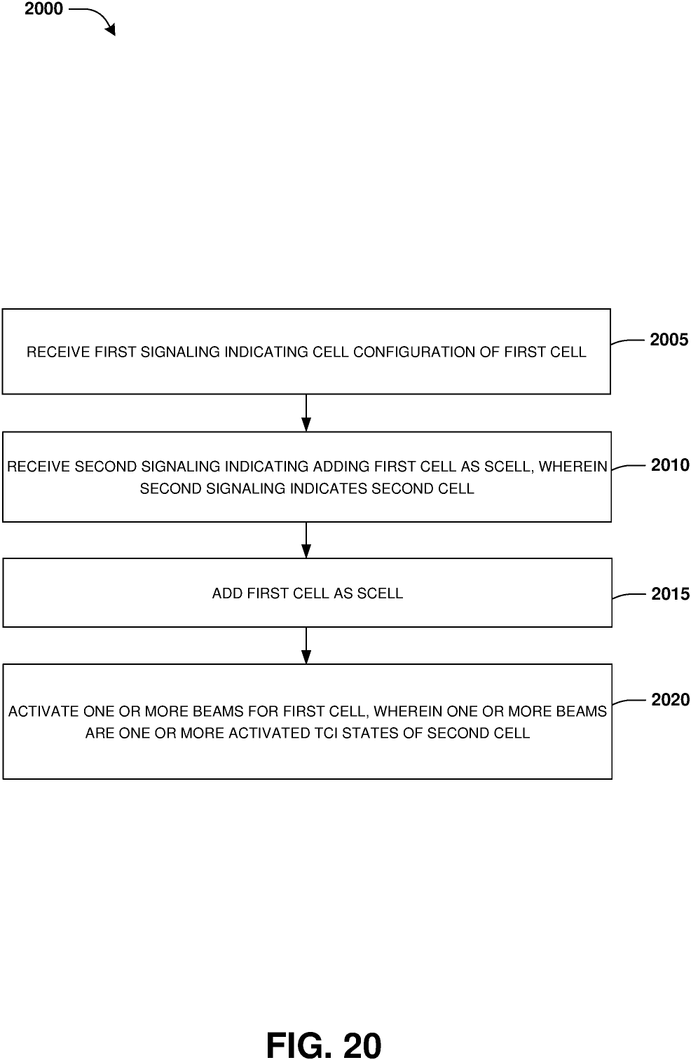

FIG. 20 is a flow chart 2000 according to one exemplary embodiment from the perspective of a UE. In step 2005, the UE receives a first signaling indicating a cell configuration (e.g., ServingCellconfig and/or one or more parameters in sCellConfigCommon and/or sCellConfigDedicated) of a first cell. In step 2010, the UE receives a second signaling indicating adding the first cell as a SCell, wherein the second signaling indicates a second cell. For example, the second signaling may instruct the UE to add the first cell as a SCell. In step 2015, the UE adds the first cell as a SCell. In step 2020, the UE activates one or more beams for the first cell, wherein the one or more beams are one or more activated TCI states of the second cell.

In one embodiment, the second signaling indicates an identity and/or a serving cell index of the second cell.

In one embodiment, the second cell is indicated (by the second signaling, for example) for beam activation and/or TCI state activation of the first cell.

Referring back to FIGS. 3 and 4, in one exemplary embodiment of a UE, the device 300 includes a program code 312 stored in the memory 310. The CPU 308 may execute program code 312 to enable the UE (i) to receive a first signaling indicating a cell configuration of a first cell, (ii) to receive a second signaling indicating adding the first cell as a SCell, wherein the second signaling indicates a second cell, (iii) to add the first cell as a SCell, and (iv) to activate one or more beams for the first cell, wherein the one or more beams are one or more activated TCI states of the second cell. Furthermore, the CPU 308 can execute the program code 312 to perform one, some and/or all of the above-described actions and steps and/or others described herein.

With respect to FIGS. 19 and 20, in one embodiment, the second cell is a SCell or a PCell of the UE before receiving the first signaling and/or before receiving the second signaling.

In one embodiment, the one or more beams are associated with one or more TCI states.

In one embodiment, the one or more beams are associated with spatial relation info.

In one embodiment, the one or more beams are associated with one or more SSBs and/or one or more CSI-RSs.

In one embodiment, the cell configuration does not indicate activating one or more TCI states for the first cell.

In one embodiment, the second signaling indicates an identity and/or index of the first cell.

In one embodiment, the second signaling comprises a PDCCH signaling and/or a MAC CE (e.g., the second signaling may be the PDCCH signaling or the MAC CE).

In one embodiment, the first signaling is a RRC message.

In one embodiment, a third cell is indicated to the UE in the second signaling (e.g., the second signaling is indicative of the third cell), wherein the UE switches SpCell of the UE to the third cell in response to the second signaling.

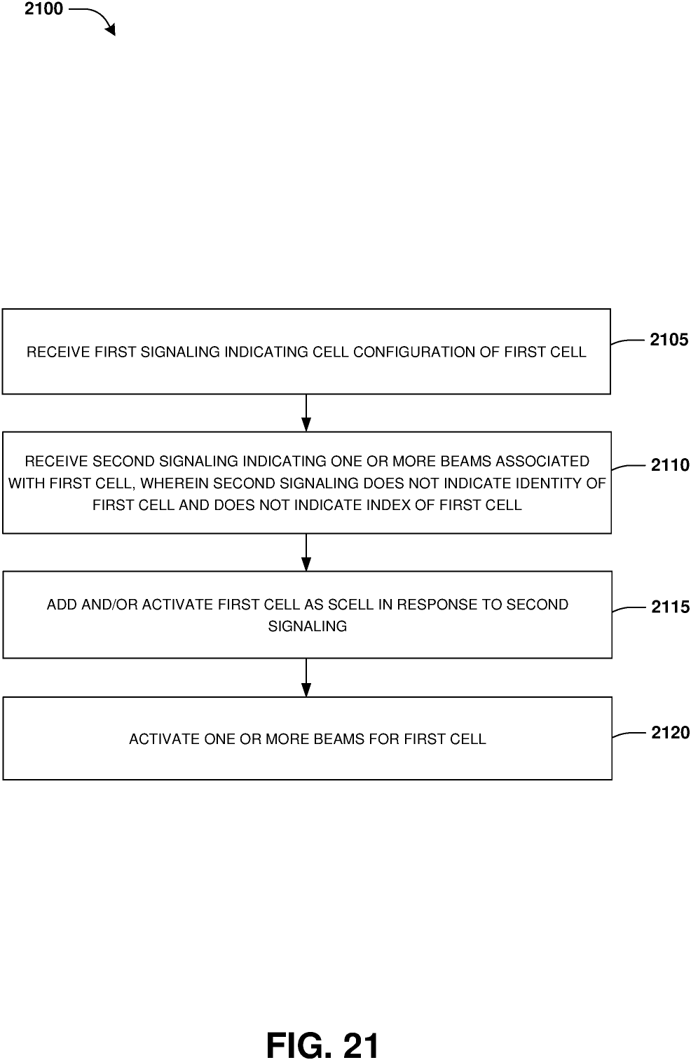

FIG. 21 is a flow chart 2100 according to one exemplary embodiment from the perspective of a UE. In step 2105, the UE receives a first signaling indicating a cell configuration (e.g., ServingCellconfig and/or one or more parameters in sCellConfigCommon and/or sCellConfigDedicated) of a first cell. In step 2110, the UE receives a second signaling indicating one or more beams associated with the first cell. In some examples, the second signaling does not indicate an identity of the first cell and does not indicate an index of the first cell. In step 2115, the UE adds and/or activates the first cell as a SCell in response to the second signaling. In step 2120, the UE activates the one or more beams for the first cell (e.g., the UE activates the one or more beams on the first cell).

In one embodiment, the UE removes, releases and/or deactivates a second cell, wherein the second cell was activated before receiving the second signaling, and wherein the UE activates and/or uses the one or more beams on the second cell. In some examples, the UE activated and/or used the one or more beams on the second cell before the UE removes, releases and/or deactivates the second cell. Alternatively and/or additionally, the UE may cease using the one or more beams on the second cell in response to removing, releasing and/or deactivating the second cell.

In one embodiment, the UE adds and/or activates the first cell as a SCell based on the one or more beams indicated by the second signaling being associated with the first cell. For example, the UE may add and/or activate the first cell as a SCell, in response to the second signaling, based on a determination that the one or more beams indicated by the second signaling are associated with the first cell.

In one embodiment, an association between the first cell and the one or more beams is indicated in the first signaling. For example, the first signaling indicates that the first cell is associated with the one or more beams. Alternatively and/or additionally, the UE determines that the first cell is associated with the one or more beams based on the first signaling.

In one embodiment, an association between the first cell and the one or more beams is indicated in a RRC message different from the first signaling. For example, the RRC message indicates that the first cell is associated with the one or more beams. Alternatively and/or additionally, the UE determines that the first cell is associated with the one or more beams based on the RRC message.

In one embodiment, the second signaling (and/or second information in the second signaling) indicates to (e.g., instructs) the UE to add the first cell as a SCell.

Referring back to FIGS. 3 and 4, in one exemplary embodiment of a UE, the device 300 includes a program code 312 stored in the memory 310. The CPU 308 may execute program code 312 to enable the UE (i) to receive a first signaling indicating a cell configuration of a first cell, (ii) to receive a second signaling indicating one or more beams associated with the first cell, wherein the second signaling does not indicate an identity of the first cell and does not indicate an index of the first cell, (iii) to add and/or activate the first cell as a SCell in response to the second signaling, and (iv) to activate the one or more beams for the first cell. Furthermore, the CPU 308 can execute the program code 312 to perform one, some and/or all of the above-described actions and steps and/or others described herein.

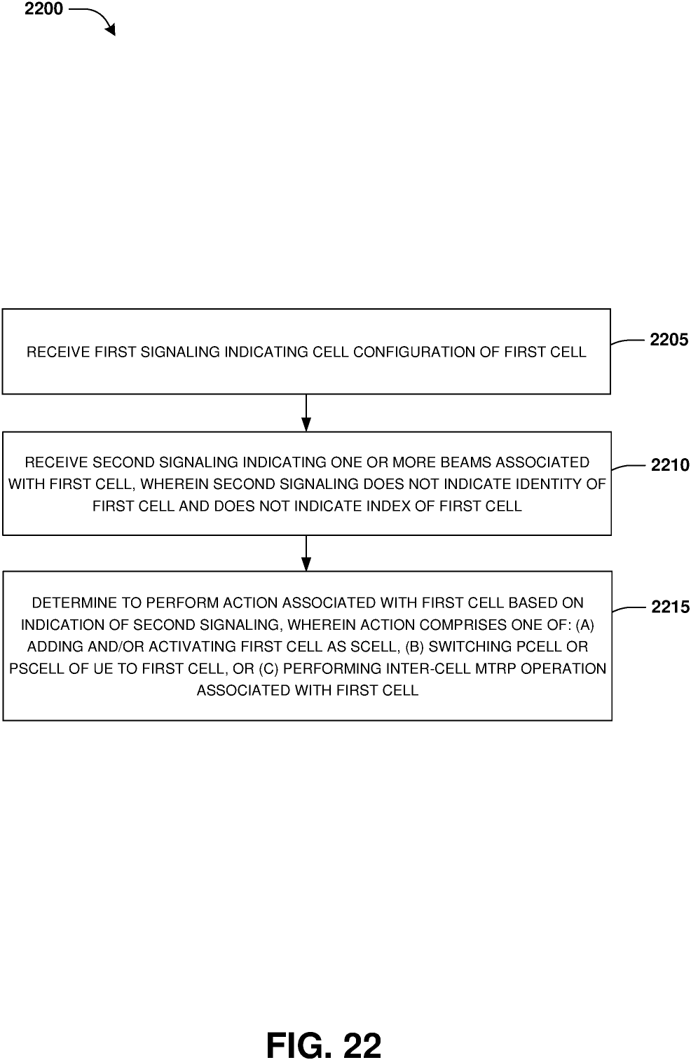

FIG. 22 is a flow chart 2200 according to one exemplary embodiment from the perspective of a UE. In step 2205, the UE receives a first signaling indicating a cell configuration (e.g., ServingCellconfig and/or one or more parameters in sCellConfigCommon and/or sCellConfigDedicated) of a first cell. In step 2210, the UE receives a second signaling indicating one or more beams associated with the first cell. In some examples, the second signaling does not indicate an identity of the first cell and does not indicate an index of the first cell. In step 2215, the UE determines to perform an action associated with the first cell based on an indication of the second signaling, wherein the action comprises one of (i) adding and/or activating the first cell as a SCell, (ii) switching a PCell or PSCell of the UE to the first cell, or (iii) performing inter-cell mTRP operation associated with the first cell.

In one embodiment, the indication comprises a bit field and/or a flag in the second signaling.

In one embodiment, the UE switches the PCell or the PSCell of the UE to the first cell if the indication indicates (e.g., instructs) switching the PCell or the PSCell and/or indicates a handover. For example, the action comprises switching the PCell or the PSCell of the UE to the first cell if the indication indicates (e.g., instructs) switching the PCell or the PSCell and/or indicates the handover.

In one embodiment, the UE adds and/or activates the first cell as a SCell and activates the one or more beams on the first cell if the indication indicates (e.g., instructs) adding and/or activating the first cell as a SCell. For example, the action comprises adding and/or activating the first cell as a SCell and activating the one or more beams if the indication indicates (e.g., instructs) adding and/or activating the first cell as a SCell.

In one embodiment, the UE performs inter-Cell mTRP operation with the first cell and considers the first cell to be a non-serving cell (and/or considers the first cell to be an assist cell and/or an additional cell) if the indication indicates (e.g., instructs) performing inter-cell mTRP operation associated with the first cell. For example, the action comprises performing inter-Cell mTRP operation with the first cell and considering the first cell to be a non-serving cell (and/or considering the first cell to be an assist cell and/or an additional cell) if the indication indicates (e.g., instructs) performing inter-cell mTRP operation associated with the first cell.

In one embodiment, the first cell is associated with a second cell for inter-Cell mTRP operation, wherein the second cell is an activated Serving Cell of the UE.

In one embodiment, the UE performs inter-Cell mTRP operation on the first cell via the one or more beams.

Referring back to FIGS. 3 and 4, in one exemplary embodiment of a UE, the device 300 includes a program code 312 stored in the memory 310. The CPU 308 may execute program code 312 to enable the UE (i) to receive a first signaling indicating a cell configuration of a first cell, (ii) to receive a second signaling indicating one or more beams associated with the first cell, wherein the second signaling does not indicate an identity of the first cell and does not indicate an index of the first cell, and (iii) to determine to perform an action associated with the first cell based on an indication of the second signaling, wherein the action comprises one of: (A) adding and/or activating the first cell as a SCell, (B) switching a PCell or PSCell of the UE to the first cell, or (C) performing inter-cell mTRP operation associated with the first cell. Furthermore, the CPU 308 can execute the program code 312 to perform one, some and/or all of the above-described actions and steps and/or others described herein.

With respect to FIGS. 21 and 22, in one embodiment, the one or more beams are associated with one or more TCI states.

In one embodiment, the one or more beams are associated with spatial relation info.

In one embodiment, the one or more beams are associated with one or more SSBs and/or one or more CSI-RSs.

In one embodiment, the cell configuration does not indicate activating one or more TCI states for the first cell.

In one embodiment, the second signaling comprises a PDCCH signaling and/or a MAC CE (e.g., the second signaling may be the PDCCH signaling or the MAC CE).

In one embodiment, the first signaling is a RRC message.

In one embodiment, the index of the first cell is a serving cell index.

In one embodiment, the identity of the first cell is a PCI.

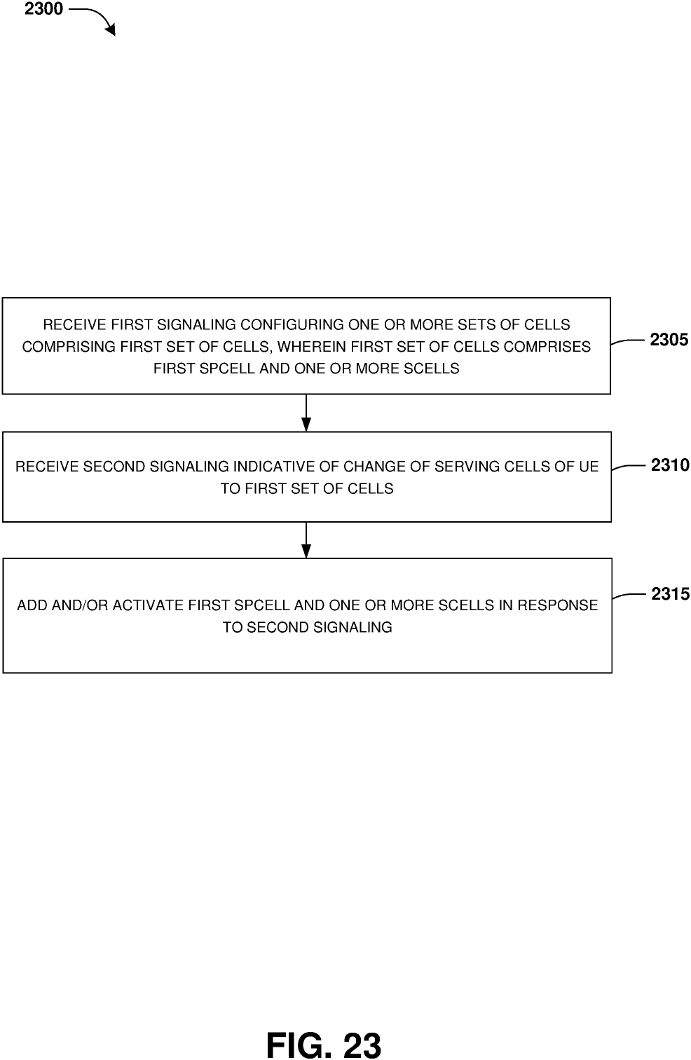

FIG. 23 is a flow chart 2300 according to one exemplary embodiment from the perspective of a UE. In step 2305, the UE receives a first signaling configuring one or more sets of cells comprising a first set of cells, wherein the first set of cells comprises a first SpCell and one or more SCells. In step 2310, the UE receives a second signaling indicative of a change of Serving Cells of the UE to the first set of cells. For example, the second signaling may instruct the UE to change the Serving Cells of the UE to the first set of cells. In some examples the second signaling implicitly indicates or explicitly indicates the change of the Serving Cells to the first set of cells. In step 2315, the UE adds and/or activates the first SpCell and the one or more SCells in response to the second signaling.

In one embodiment, the second signaling comprises a PDCCH signaling and/or a MAC CE. In some examples, the second signaling may be the PDCCH signaling or the MAC CE.

In one embodiment, the first signaling is indicative of an identity and/or an index associated with the first set of cells. The identity may comprise a PCI associated with the first set of cells. The index may comprise a serving cell index associated with the first set of cells.

In one embodiment, the UE determines to change the Serving Cells of the UE to the first set of cells based on an indication, in the second signaling, of an identity and/or an index associated with the first set of cells. For example, the UE may add and/or activate the first SpCell and the one or more SCells (in response to the second signaling) based on the second signaling being indicative of the identity and/or the index associated with the first set of cells. In an example, the second signaling indicates (e.g., instructs) changing Serving Cells of the UE to the first set of cells by indicating the identity and/or the index associated with the first set of cells. In an example, an indication (in the second signaling) of the identity and/or the index associated with the first set of cells may correspond to an indication and/or instruction to change Serving Cells of the UE to the first set of cells (e.g., the indication of the identity and/or the index may be interpreted by the UE as an indication and/or instruction to change Serving Cells of the UE to the first set of cells).

In one embodiment, the first set of cells includes one or more first cells associated with a MCG (e.g., a MCG of the UE) and one or more second cells associated with a SCG (e.g., a SCG of the UE). In an example, the one or more first cells may be added and/or activated in the MCG and/or the one or more second cells may be added and/or activated in the SCG.

In one embodiment, all cells of the first set of cells belong to a same CG (e.g., a MCG or a SCG).

In one embodiment, the first signaling configures the first set of cells via a CellGroupConfig Information Element (IE). In some examples, the UE is configured with the first set of cells via the CellGroupConfig IE provided via the first signaling.

In one embodiment, the second signaling is indicative of a CG corresponding to a MCG of the UE or a SCG of the UE. The adding and/or activating the first SpCell and the one or more SCells comprises adding and/or activating the first SpCell and the one or more SCells in the CG indicated by the second signaling. For example, the second signaling may indicate whether to add and/or activate the first SpCell and the one or more SCells in the MCG or to add and/or activate the first SpCell and the one or more SCells in the SCG.

In one embodiment, the first signaling indicates an association between one or more beams and one or more cells of the first set of cells. In some examples, the first SpCell and the one or more SCells may comprise the one or more cells. In some examples, after adding and/or activating the first SpCell and the one or more SCells, the UE may communicate with the one or more cells via the one or more beams (based on the indication of the association between the one or more beams and the one or more cells, for example).

In one embodiment, the UE determines to change the Serving Cells of the UE to the first set of cells based on an indication, in the second signaling, of an identity and/or an index of one or more beams associated with one or more cells of the first set of cells. For example, the UE may add and/or activate the first SpCell and the one or more SCells (in response to the second signaling) based on the second signaling being indicative of the identity and/or the index of the one or more beams associated with the one or more cells of the first set of cells. In an example, the second signaling indicates (e.g., instructs) changing Serving Cells of the UE to the first set of cells by indicating the identity and/or the index of the one or more beams associated with the one or more cells of the first set of cells. In some examples, the UE determines to change the Serving Cells of the UE to the first set of cells based on (i) the indication, in the second signaling, of the identity and/or the index of the one or more beams associated with the one or more cells of the first set of cells, and (ii) an indication, in the first signaling, of an association between the one or more beams and the one or more cells of the first set of cells.

In one embodiment, the one or more sets of cells comprise a second set of cells. The second signaling is indicative of changing one or more second Serving Cells of the UE to the second set of cells.

In one embodiment, in response to the second signaling, the UE adds and/or activates one or more cells of the second set of cells. For example, the UE may add and/or activate the one or more cells, of the second set of cells, in addition to adding and/or activating the first SpCell and the one or more SCells. Alternatively and/or additionally, the UE may add and/or activate the one or more cells, of the second set of cells, concurrently with adding and/or activating the first SpCell and the one or more SCells.

In one embodiment, in response to the second signaling, the UE releases and/or deactivates one or more third Serving Cells, of the UE, that are not included in the first set of cells and are not included in the second set of cells. In an example, the one or more third Serving Cells may comprise one, some and/or all Serving Cells, of the UE, that are (i) not included in the first set of cells and (ii) are not included in the second set of cells.

In one embodiment, in response to the second signaling, the UE releases and/or deactivates one or more fourth Serving Cells, of the UE, that are not included in the first set of cells. In an example, the one or more fourth Serving Cells may comprise one, some and/or all Serving Cells, of the UE, that are not included in the first set of cells.

In one embodiment, adding and/or activating the first SpCell and the one or more SCells may comprise (i) adding the first SpCell and the one or more SCells to a set of cells (e.g., a set of currently used and/or activated cells) of the UE (e.g., the set of cells may be associated with a CG indicated by the second signaling), and/or (ii) activating the first SpCell and the one or more SCells. The UE may use (and/or communicate with) the first SpCell and the one or more SCells after adding and/or activating the first SpCell and the one or more SCells.

Referring back to FIGS. 3 and 4, in one exemplary embodiment of a UE, the device 300 includes a program code 312 stored in the memory 310. The CPU 308 may execute program code 312 to enable the UE (i) to receive a first signaling configuring one or more sets of cells comprising a first set of cells, wherein the first set of cells comprises a first SpCell and one or more SCells, (ii) to receive a second signaling indicative of a change of Serving Cells of the UE to the first set of cells (e.g., the second signaling may comprise a PDCCH signaling and/or a MAC CE), and (iii) to add and/or activate the first SpCell and the one or more SCells in response to the second signaling. Furthermore, the CPU 308 can execute the program code 312 to perform one, some and/or all of the above-described actions and steps and/or others described herein.

A communication device (e.g., a UE, a base station, a network node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 17-23. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 17-23, and/or one, some and/or all of the above-described actions and steps and/or others described herein.

It may be appreciated that applying one or more of the techniques presented herein may result in one or more benefits including, but not limited to, increased efficiency of communication between devices (e.g., a UE and/or a network node). The increased efficiency may be a result of enabling the UE to perform mobility changes (e.g., L1/L2 mobility enhancing SCell/SCG changes), thereby enabling the UE to change cells (e.g., change from using one or more first cells to using one or more second cells).

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based on design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method of a User Equipment (UE), the method comprising:
receiving a first signaling configuring one or more sets of cells comprising a first set of cells, wherein the first set of cells comprises a first Special Cell (SpCell) and one or more Secondary Cells (SCells);
receiving a second signaling indicative of a change of Serving Cells of the UE to the first set of cells; and
in response to the second signaling, at least one of adding or activating the first SpCell and the one or more SCells.

2. The method of claim 1, wherein:
the first signaling is indicative of at least one of an identity or an index associated with the first set of cells.

3. The method of claim 1, comprising:
determining to change the Serving Cells of the UE to the first set of cells based on an indication, in the second signaling, of at least one of an identity or an index associated with the first set of cells.

4. The method of claim 1, wherein:
the first set of cells includes one or more cells associated with a Master Cell Group (MCG) and one or more cells associated with a Secondary Cell Group (SCG).

5. The method of claim 1, wherein:
all cells of the first set of cells belong to a same Cell Group (CG).

6. The method of claim 1, wherein:
the first signaling configures the first set of cells via a CellGroupConfig Information Element (IE).

7. The method of claim 1, wherein:
the second signaling is indicative of a Cell Group (CG) corresponding to a Master Cell Group (MCG) or a Secondary Cell Group (SCG) of the UE; and
the at least one of adding or activating the first SpCell and the one or more SCells comprises at least one of adding or activating the first SpCell and the one or more SCells in the CG indicated by the second signaling.

8. The method of claim 1, wherein:
the first signaling indicates an association between one or more beams and one or more cells of the first set of cells.

9. The method of claim 1, comprising:
determining to change the Serving Cells of the UE to the first set of cells based on an indication, in the second signaling, of at least one of an identity or an index of one or more beams associated with one or more cells of the first set of cells.

10. The method of claim 1, wherein:
the one or more sets of cells comprise a second set of cells; and
the second signaling is indicative of changing one or more second Serving Cells of the UE to the second set of cells.

11. The method of claim 10, comprising:
in response to the second signaling, at least one of adding or activating one or more cells of the second set of cells.

12. The method of claim 10, comprising:
in response to the second signaling, at least one of releasing or deactivating one or more third Serving Cells, of the UE, that are not included in the first set of cells and are not included in the second set of cells.

13. The method of claim 1, comprising:
in response to the second signaling, at least one of releasing or deactivating one or more second Serving Cells, of the UE, that are not included in the first set of cells.

14. The method of claim 1, wherein:
the second signaling comprises at least one of a Physical Downlink Control Channel (PDCCH) signaling or a Medium Access Control (MAC) Control Element (CE).

15. A User Equipment (UE), the UE comprising:
a control circuit;
a processor installed in the control circuit; and
a memory installed in the control circuit and operatively coupled to the processor, wherein the processor is configured to execute a program code stored in the memory to perform operations, the operations comprising:
receiving a first signaling configuring one or more sets of cells comprising a first set of cells, wherein the first set of cells comprises a first Special Cell (SpCell) and one or more Secondary Cells (SCells);
receiving a second signaling indicative of a change of Serving Cells of the UE to the first set of cells; and
in response to the second signaling, at least one of adding or activating the first SpCell and the one or more SCells.

16. The UE of claim 15, wherein:
the first signaling is indicative of at least one of an identity or an index associated with the first set of cells.

17. The UE of claim 15, the operations comprising:
determining to change the Serving Cells of the UE to the first set of cells based on an indication, in the second signaling, of at least one of an identity or an index associated with the first set of cells.

18. The UE of claim 15, wherein:
the second signaling is indicative of a Cell Group (CG) corresponding to a Master Cell Group (MCG) or a Secondary Cell Group (SCG) of the UE; and
the at least one of adding or activating the first SpCell and the one or more SCells comprises at least one of adding or activating the first SpCell and the one or more SCells in the CG indicated by the second signaling.

19. The UE of claim 15, the operations comprising:
determining to change the Serving Cells of the UE to the first set of cells based on an indication, in the second signaling, of at least one of an identity or an index of one or more beams associated with one or more cells of the first set of cells.

20. The UE of claim 15, wherein:
the second signaling comprises at least one of a Physical Downlink Control Channel (PDCCH) signaling or a Medium Access Control (MAC) Control Element (CE).
